(19) United States
(12) Patent Application Publication
(10) Pub. No.: US 2026/0320891 A1
(43) Pub. Date: Oct. 15, 2026

(54) RECONSTRUCTING HIGH FIDELITY THREE-DIMENSIONAL ANIMATIONS FROM TWO-DIMENSIONAL VIDEOS

(71) Applicant: Sony Interactive Entertainment Inc., Tokyo (JP)

(72) Inventor: Chockalingam Ravi Sundaram, San Mateo, CA (US)

(21) Appl. No.: 19/180,044

(22) Filed: Apr. 15, 2025

(51) Int. Cl. G06T 13/40; G06T 17/20; G06V 10/82; G06V 40/16

(52) U.S. Cl. CPC G06T 13/40; G06T 17/20; G06V 10/82; G06V 40/174

(57) ABSTRACT

Methods, systems, and apparatus, including computer programs encoded on a computer storage medium, for reconstructing high-fidelity three-dimensional (“3D”) animations from two-dimensional (“2D”) videos. Examples of an animation reconstruction system are described herein for performing high-fidelity 2D-to-3D animation reconstruction. The animation reconstruction system includes a shape reconstruction module, a feature matching module, and a deformation transfer module each configured to perform a respective shape reconstruction, feature matching, or deformation transfer task in the 2D-to-3D animation reconstruction process. Some examples of the shape reconstruction, feature matching, and deformation transfer modules utilize machine learning models for automatically performing their respective task. Examples of training systems for training such machine learning models are also described.

### TECHNICAL FIELD

This disclosure relates generally to methods, systems, and apparatus, including computer programs encoded on a computer storage medium, for reconstructing high-fidelity three-dimensional (“3D”) animations from two-dimensional (“2D”) videos.

### BACKGROUND

Animation is widely used in various fields, including entertainment, advertising, education, and user interface design. Typically, animations are created using manual techniques such as hand-drawn frame sequences or keyframe-based digital methods.

### SUMMARY

This specification describes an animation reconstruction system implemented as computer programs on one or more computers in one or more locations that can perform high-fidelity two-dimensional to three-dimensional (“2D-to-3D”) animation conversion.

2D-to-3D animation conversion refers to the process of converting a 2D video into a 3D animation. The process of converting 2D video into 3D animation has been an area of research and development for decades, motivated by the demand for increasingly more immersive and visually engaging content in several industries, such as film, television, gaming, virtual reality, motion capture, simulation, and 3D imaging. Some existing approaches to 2D-to-3D animation conversion rely on a combination of manual techniques, computational algorithms, and artistic intuition.

High-fidelity 3D mesh animation is usually accomplished using motion capture technology with artists manually tracking key landmark points and crafting the animations by hand. This process is labor intensive and time-consuming, as artists must manually remap animation from each video frame to a template mesh. In contrast, the animation reconstruction system described herein fully automates the 2D-to-3D animation reconstruction process, e.g., without involving any human intervention, saving resources and improving speed, performance, and efficiency.

This specification also describes processing image, video, mesh, and other visual and geometric data using neural networks, as well as training such neural networks. Neural networks are a class of machine learning models that employ layered architectures of nonlinear processing units to generate a network output in response to receiving a network input. Some neural networks are parametric models that generate the network output from the received network input in accordance with a set of network parameters. Some neural networks are deep models that include one or more hidden layers between an input and output layer. The output of the input layer and each hidden layer is received as input by the next layer in the neural network, i.e., the next hidden layer or the output layer. Each layer of the neural network generates an output from a received input in accordance with current values of a respective subset of the network parameters.

In some implementations, the animation reconstruction system described herein includes machine learning models (e.g., neural networks) for automatically performing various machine learning tasks involved in the high-fidelity 2D-to-3D animation conversion process, e.g., shape reconstruction and feature matching tasks, where the neural networks utilize lower-dimensional physical or latent embedding spaces for optimizing performance on the machine learning tasks. Various systems and methods for training these machine learning models are also described herein, including supervised and unsupervised learning techniques.

In some implementations, the animation reconstruction system described herein includes three modules in the processing pipeline: (i) a shape reconstruction module for reconstructing a low-resolution 3D mesh animation from a 2D video; (ii) a feature matching module for matching a set of 3D paired correspondences between the low-resolution 3D mesh and a high-resolution 3D mesh; and (iii) a deformation transfer module for deformation transferring the low-resolution 3D mesh animation onto the high-resolution 3D mesh to generate a high-fidelity 3D mesh animation.

A few aspects of the animation reconstruction system and the methods, systems, and apparatus described herein for performing high-fidelity 2D-to-3D animation conversion are summarized below.

In one aspect, a method performed by one or more computers is provided. The method includes: receiving a source video including a sequence of frames depicting a motion sequence; processing the source video to generate a source animation including a sequence of states of a three-dimensional source mesh performing the motion sequence; obtaining a set of three-dimensional paired correspondences between: (i) the three-dimensional source mesh, and (ii) a three-dimensional target mesh, where the three-dimensional target mesh has higher resolution than the three-dimensional source mesh; and processing the source animation, in accordance with the set of three-dimensional paired correspondences, to generate a target animation including a sequence of states of the three-dimensional target mesh performing the motion sequence.

In some implementations of the method, processing the source video to generate the source animation including the sequence of states of the three-dimensional source mesh performing the motion sequence includes: providing a three-dimensional parametric model; processing the source video, using a shape reconstructor neural network, to generate a source parametrization trajectory including a sequence of model parameter vectors representing the motion sequence; and parametrizing the three-dimensional parametric model, with the source parametrization trajectory, to generate the source animation including the sequence of states of the three-dimensional source mesh performing the motion sequence.

In some implementations of the method, the three-dimensional parametric model is a basis function parametric model, a morphable parametric model, a polynomial parametric model, an explicit parametric surface model, an implicit parametric surface model, a spline-based parametric model, a subdivision surfaces parametric model, an implicit function parametric model, or a skeletal parametric model.

In some implementations of the method, the shape reconstructor neural network is a convolutional neural network, a recurrent neural network, an attention neural network, a graph neural network, or a Transformer-based neural network.

In some implementations of the method, the shape reconstructor neural network is configured to process each frame in the source video individually to generate a respective model parameter vector in the source parametrization trajectory.

In some implementations of the method, the shape reconstructor neural network is configured to process the sequence of frames in the source video in parallel to generate the sequence of model parameter vectors in the source parametrization trajectory.

In some implementations of the method, each model parameter vector in the source parametrization trajectory includes: a respective set of geometry parameters representing a respective shape and structure of each object depicted in the respective frame of the source video; and a respective set of pose parameters representing a respective position, orientation, and scale of each object depicted in the respective frame of the source video.

In some implementations of the method, each model parameter vector in the source parametrization trajectory further includes: a respective set of expression parameters representing a respective expression of each face depicted in the respective frame of the source video.

In some implementations of the method, obtaining the set of three-dimensional paired correspondences between: (i) the three-dimensional source mesh, and (ii) the three-dimensional target mesh includes: receiving a base state of the three-dimensional target mesh; sampling, from the source animation, a base state of the three-dimensional source mesh; rendering the base state of the three-dimensional source mesh to generate a two-dimensional source image depicting the three-dimensional source mesh; rendering the base state of the three-dimensional target mesh to generate a two-dimensional target image depicting the three-dimensional target mesh; forwarding, to a featuring matching neural network, a network input including: (i) the two-dimensional source image, and (ii) the two-dimensional target image; processing the network input, using the featuring matching neural network, to generate a network output including a set of two-dimensional paired correspondences between: (i) the two-dimensional source image, and (ii) the two-dimensional target image; and inverse rasterizing the set of two-dimensional paired correspondences to generate the set of three-dimensional paired correspondences between: (i) the three-dimensional source mesh, and (ii) the three-dimensional target mesh.

In some implementations of the method, the feature matching neural network is a convolutional neural network, a recurrent neural network, an attention neural network, a graph neural network, or a Transformer-based neural network.

In some implementations of the method, processing the source animation, in accordance with the set of three-dimensional paired correspondences, to generate the target animation including the sequence of states of the three-dimensional target mesh performing the motion sequence includes: performing an optimal transport method between: (i) the base state of the three-dimensional source mesh, and (ii) the base state of the three-dimensional target mesh, while regularizing over the set of three-dimensional paired correspondences, to generate an optimal transport matrix between: (i) the three-dimensional source mesh, and (ii) the three-dimensional target mesh; and applying a transpose of the optimal transport matrix, to the source animation, to generate the target animation including the sequence of states of the three-dimensional target mesh performing the motion sequence.

In some implementations of the method, performing the optimal transport method between: (i) the base state of the three-dimensional source mesh, and (ii) the base state of the three-dimensional target mesh, while regularizing over the set of three-dimensional paired correspondences, to generate the optimal transport matrix between: (i) the three-dimensional source mesh, and (ii) the three-dimensional target mesh includes: initializing a transport matrix between: (i) the three-dimensional source mesh, and (ii) the three-dimensional target mesh; computing a cost matrix between: (i) the base state of the three-dimensional source mesh, and (ii) the base state of the three-dimensional target mesh; generating a Kantorovich objective term including a Frobenius inner product between: (i) the transport matrix, and (ii) the cost matrix; generating a correspondence regularization term regularizing the transport matrix over the set of three-dimensional paired correspondences; generating an objective function including the Kantorovich objective term and the correspondence regularization term; and optimizing the objective function, with respect to the transport matrix, to generate the optimal transport matrix between: (i) the three-dimensional source mesh, and (ii) the three-dimensional target mesh.

In some implementations of the method, generating the correspondence regularization term regularizing the transport matrix over the set of three-dimensional paired correspondences includes: applying the transport matrix, to the base state of the three-dimensional target mesh, to generate a transported state of the three-dimensional source mesh; computing a source deformation transformation between: (i) the transported state of the three-dimensional source mesh, and (ii) the base state of the three-dimensional source mesh; applying a transpose of the transport matrix, to the base state of the three-dimensional source mesh, to generate a transported state of the three-dimensional target mesh; computing a target deformation transformation between: (i) the transported state of the three-dimensional target mesh, and (ii) the base state of the three-dimensional target mesh; and returning, as the correspondence regularization term, a regularization term measuring an error between the source and target deformation transformations evaluated over the set of three-dimensional paired correspondences.

In some implementations of the method, the three-dimensional target mesh has a higher mesh resolution than the three-dimensional source mesh. For example, the three-dimensional target mesh can have a higher vertex count than the three-dimensional source mesh, a higher edge count than the three-dimensional source mesh, and a higher face count than the three-dimensional source mesh.

In some implementations of the method, the three-dimensional target mesh has a higher spatial resolution than the three-dimensional source mesh. For example, the three-dimensional target mesh can have a higher vertex density than the three-dimensional source mesh, a higher edge density than the three-dimensional source mesh, a higher face density than the three-dimensional source mesh, a smaller average edge length than the three-dimensional source mesh, and a smaller average face area than the three-dimensional source mesh.

In some implementations of the method, each state of the three-dimensional source and target meshes is a face-vertex representation of the three-dimensional mesh, a winged-edge representation of the three-dimensional mesh, a half-edge representation of the three-dimensional mesh, a quad-edge representation of the three-dimensional mesh, a corner-table representation of the three-dimensional mesh, or a vertex-vertex representation of the three-dimensional mesh.

In a second aspect, a system is provided. The system includes one or more computers and one or more storage devices storing instructions that, when executed by the one or more computers, cause the one or more computers to perform the method of the first aspect in any of its abovementioned implementations.

In a third aspect, a system is provided. The system includes one or more non-transitory computer storage media storing instructions that, when executed by one or more computers, cause the one or more computers to perform the method of the first aspect in any of its abovementioned implementations.

The subject matter described in this specification can be implemented in particular embodiments so as to realize one or more of the following advantages.

The animation conversion system described herein can provide several advantages over manual approaches, for example, including one or more of: (i) efficiency, as it eliminates the labor-intensive manual conversion process; (ii) scalability, as it enables bulk processing of animation libraries; or (iii) cost reduction, as full teams no longer need to redraw or map video frames to 3D templates or perform manual correspondence mapping between different digital objects.

The animation reconstruction system also has applications in several activities including one or more of: (i) amateur, recreational, or personal video production for converting videos captured from mobile devices; (ii) film and television for converting 2D animated content into 3D visuals without the time-consuming and expensive manual reanimation process, e.g., converting hand-drawn classical cartoons to 3D animations (e.g., making them compatible with stereoscopic 3D and virtual reality experiences); (iii) gaming for converting 2D cutscenes into fully realized 3D assets, e.g., allowing for dynamic camera angles, depth-based interactions, and physics-based enhancements; (iv) virtual and augmented reality for converting legacy 2D content into depth-aware experiences in immersive environments; or (v) educational and scientific visualization for converting 2D simulated videos into interactive 3D models, e.g., aiding in more intuitive learning.

Implementations of the animation reconstruction system described herein can also be configured for high-fidelity online 2D-to-3D animation conversion, where the animation reconstruction system converts a 2D video stream into a high-fidelity 3D mesh animation stream. In these cases, the animation reconstruction system can process each frame of the 2D video stream and generate a respective state of the high-fidelity 3D mesh animation stream faster than the framerate of the 2D video stream. Such implementations of the animation reconstruction system can have applications in real-time rendering, artificial intelligence (“AI”), generic video processing, and entertainment.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic diagram depicting an example of an animation reconstruction system for performing high-fidelity 2D-to-3D animation conversion.

FIG. 2 is a schematic diagram depicting an example implementation of an animation reconstruction system performing high-fidelity 2D-to-3D animation conversion.

FIGS. 3A-3D are perspective views depicting an example of a 3D source mesh of a source subject's face. FIG. 3A is an anterior view of the 3D source mesh, FIG. 3B is a right lateral view of the 3D source mesh, FIG. 3C is a posterior view of the 3D source mesh, and FIG. 3D is a left lateral view of the 3D source mesh.

FIGS. 4A-4D are perspective views depicting an example of a 3D target mesh of a target subject's face. FIG. 4A is an anterior view of the 3D target mesh, FIG. 4B is a right lateral view of the 3D target mesh, FIG. 4C is a posterior view of the 3D target mesh, and FIG. 4D is a left lateral view of the 3D target mesh.

FIG. 5A is a flow diagram of an example process for performing high-fidelity 2D-to-3D animation conversion.

FIG. 5B is a flow diagram of another example process for performing high-fidelity 2D-to-3D animation conversion.

FIG. 6A is a schematic diagram depicting an example of a shape reconstruction module for converting a source video into a source animation of a 3D source mesh.

FIG. 6B is a flow diagram of an example process for converting a source video into a source animation of a 3D source mesh.

FIG. 7A is a schematic diagram depicting an example of a feature matching module for obtaining a set of 3D paired correspondences between a 3D source mesh and a 3D target mesh.

FIG. 7B is a flow diagram of an example process for obtaining a set of 3D paired correspondences between a 3D source mesh and a 3D target mesh.

FIG. 8A is a schematic diagram depicting an example of a renderer for executing a rendering pipeline on a 3D mesh to generate a 2D image depicting the 3D mesh.

FIG. 8B is a schematic diagram depicting an example of a renderer for inverse rasterizing a 2D correspondence identifying a feature in a 2D image of a 3D mesh to generate a 3D correspondence identifying the feature in the 3D mesh.

FIG. 8C is a schematic diagram depicting an example of a renderer for performing rasterization and inverse rasterization.

FIG. 8D is a flow diagram of an example process for rendering a 3D mesh to generate a 2D image depicting the 3D mesh.

FIG. 8E is a flow diagram of an example process for inverse rasterizing a 2D correspondence identifying a feature in a 2D image of a 3D mesh to generate a 3D correspondence identifying the feature in the 3D mesh.

FIG. 9A is a front view depicting an example of a set of 2D paired correspondences between a 2D source image of a 3D source mesh and a 2D target image of a 3D target mesh.

FIG. 9B is a front view depicting an example of a set of 3D paired correspondences between a 3D source mesh and a 3D target mesh.

FIG. 10A is a schematic diagram depicting an example of a deformation transfer module for deformation transferring a source animation of a 3D source mesh onto a 3D target mesh.

FIGS. 10B-10C are parts of a flow diagram of an example process for deformation transferring a source animation of a 3D source mesh onto a 3D target mesh.

FIG. 11 is a schematic diagram depicting an example of an animation reconstruction system for performing high-fidelity online 2D-to-3D animation conversion.

FIG. 12 is a flow diagram of an example process for performing high-fidelity online 2D-to-3D animation conversion.

FIG. 13 is a schematic diagram depicting an example of a shape reconstruction training system for training a shape reconstructor neural network.

FIG. 14 is a flow diagram of an example process for training a shape reconstructor neural network.

FIG. 15 is a schematic diagram depicting another example of a shape reconstruction training system for training a shape reconstructor neural network.

FIG. 16 is a flow diagram of another example process for training a shape reconstructor neural network.

FIG. 17 is a schematic diagram depicting an example of a feature matching training system for training a feature matching neural network.

FIG. 18 is a flow diagram of an example process for training a feature matching neural network.

FIG. 19 is a schematic diagram depicting an example of a computing device and associated accessories that can be employed to execute implementations of the present disclosure.

Like reference numbers and designations in the various drawings indicate like elements.

### DETAILED DESCRIPTION

### I. Introduction

Two-dimensional to three-dimensional (“2D-to-3D”) animation conversion is the process of constructing 3D mesh animations from 2D videos. 2D-to-3D animation conversion is an important application in several industries, including film, television, gaming, virtual reality, motion capture, simulation, computer-generated imagery (“CGI”), and 3D imaging. High-fidelity 3D mesh animations are usually reconstructed using motion capture technology. However, the process of reconstructing 3D mesh animations from motion capture videos is labor intensive and time-consuming. It typically involves artists manually tracking landmark points in the motion capture videos and mapping them to a template 3D mesh at each frame (or timestamp).

To overcome these challenges, this specification introduces an animation reconstruction system for performing high-fidelity 2D-to-3D animation conversion. The animation reconstruction system automates the process of reconstructing robust, high-resolution 3D mesh animations from 2D videos, potentially without any human intervention.

In some implementations, the animation reconstruction system described herein includes three modules in the processing pipeline: (i) a shape reconstruction module that converts a 2D video into an animation of a “low-resolution” 3D mesh; (ii) a feature matching module that automatically determines a set of 3D paired correspondences between the low-resolution 3D mesh and a “high-resolution” 3D mesh; (iii) a deformation transfer module that converts the animation of the low-resolution 3D mesh into a high-fidelity animation of the high-resolution 3D mesh.

In some implementations, the animation reconstruction system described herein includes machine learning models (e.g., neural networks) for automatically, efficiently, and accurately performing various machine learning tasks involved in the high-fidelity 2D-to-3D animation conversion process, e.g., shape reconstruction and feature matching tasks, where the neural networks utilize lower-dimensional physical or latent embedding spaces for optimizing performance on the machine learning tasks.

The animation conversion system described herein can provide several advantages over manual approaches, for example, including one or more of: (i) efficiency, as it eliminates the labor-intensive manual conversion process; (ii) scalability, as it enables bulk processing of animation libraries; or (iii) cost reduction, as full teams no longer need to redraw or map video frames to 3D templates or perform manual correspondence mapping between different digital objects.

The animation reconstruction system also has applications in several activities including one or more of: (i) amateur, recreational, or personal video production for converting videos captured from mobile devices; (ii) film and television for converting 2D animated content into 3D visuals without the time-consuming and expensive manual reanimation process, e.g., converting hand-drawn classical cartoons to 3D animations (e.g., making them compatible with stereoscopic 3D and virtual reality experiences); (iii) gaming for converting 2D cutscenes into fully realized 3D assets, e.g., allowing for dynamic camera angles, depth-based interactions, and physics-based enhancements; (iv) virtual and augmented reality for converting legacy 2D content into depth-aware experiences in immersive environments; or (v) educational and scientific visualization for converting 2D simulated videos into interactive 3D models, e.g., aiding in more intuitive learning.

Implementations of the animation reconstruction system described herein can also be configured for high-fidelity online 2D-to-3D animation conversion, where the animation reconstruction system converts a 2D video stream into a high-fidelity 3D mesh animation stream. In these cases, the animation reconstruction system can process each frame of the 2D video stream and generate a respective state of the high-fidelity 3D mesh animation stream faster than the framerate of the 2D video stream. Such implementations of the animation reconstruction system can have applications in real-time rendering, artificial intelligence (“AI”), generic video processing, and entertainment.

These and other features relating to the animation reconstruction system, machine learning approaches, and online reconstruction for high-fidelity 2D-to-3D conversion are described in more detail below.

### II. Examples of Animation Reconstruction Systems

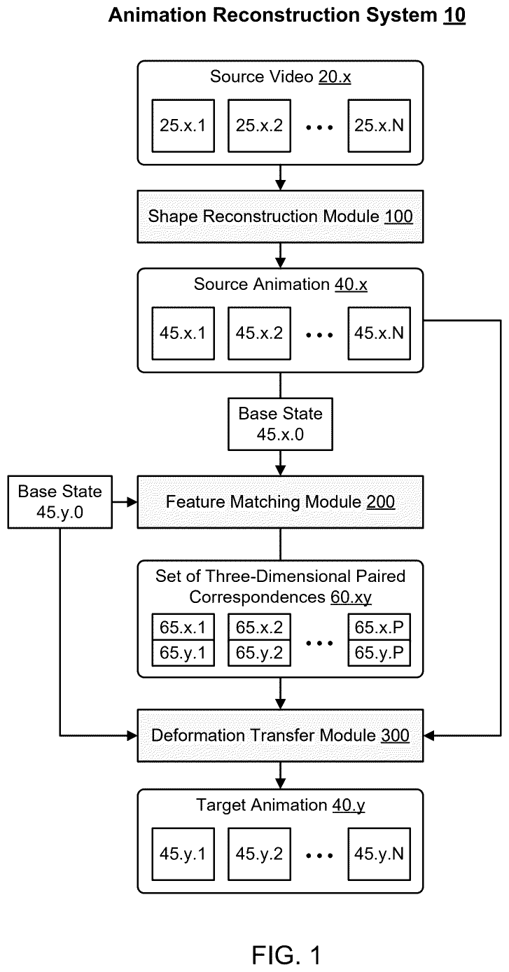

FIG. 1 is a schematic diagram depicting an example of an animation reconstruction system 10 for performing high-fidelity 2D-to-3D animation conversion. The system 10 includes a shape reconstruction module 100, a feature matching module 200, and a deformation transfer module 300. The animation reconstruction system 10 is an example of a system implemented as computer programs on one or more computers in one or more locations in which the systems, components, and techniques described below are implemented.

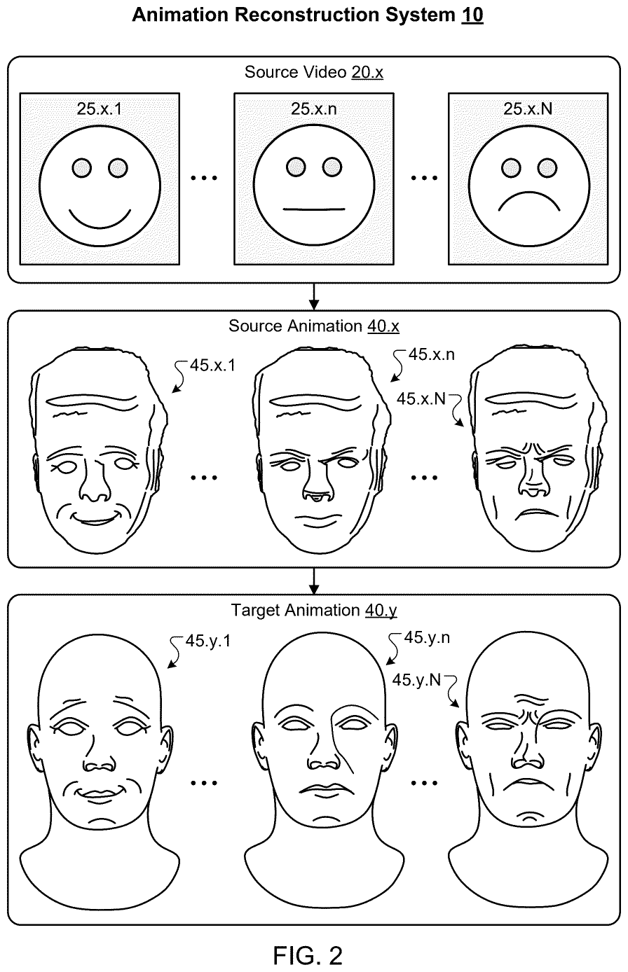

In this example, the shape reconstruction module 100, feature matching module 200, and deformation transfer module 300 are implemented as a processing pipeline. Each module 100, 200, and 300 performs a respective task in the high-fidelity 2D-to-3D animation conversion process. The detailed operations of each of the modules 100, 200, and 300 are described in Sections II.A-II.D. First, an overview of the system 10 is provided below to help implement the 2D-to-3D animation conversion pipeline and the design philosophy thereof. An example implementation of the system 10 performing high-fidelity 2D-to-3D animation conversion for facial geometry, pose, and expression reconstruction is shown in FIG. 2 and described in the following.

At a high-level, the system 10 is configured to: (i) receive a source video 20.x depicting a motion sequence; (ii) shape reconstruct the source video 20.x to generate a source animation 40.x of a 3D source mesh 45.x performing the motion sequence; (iii) obtain a set 60.xy of 3D paired correspondences 65.xy between the 3D source mesh 45.x and a 3D target mesh 45.y of higher resolution; and (iv) deformation transfer the source animation 40.x onto the 3D target mesh 45.y, while constrained by the set 60.xy of 3D paired correspondences 65.xy, to generate a target animation 40.y of the 3D target mesh 45.y performing the motion sequence.

The system 10 can perform this process automatically, efficiently, and accurately, without human intervention, enabling applications such as online animation conversion and streaming. However, the techniques involved for this process are relatively complex, e.g., involving machine learning approaches, nonlinear projections between 2D and 3D vector spaces, and regularized optimal transport methods. Hence, a review of some of the relevant concepts are provided below.

A state of a 3D mesh 45 (or the 3D mesh 45 itself) can refer to any appropriate mesh representation of the 3D mesh 45, e.g., specified in the form of an ordered list of vertices, vertex positions, edges, edge connectivity, faces, and/or face topology. For example, a state of a 3D mesh 45 can be a face-vertex representation of the 3D mesh 45, a winged-edge representation of the 3D mesh 45, a half-edge representation of the 3D mesh 45, a quad-edge representation of the 3D mesh 45, a corner-table representation of the 3D mesh 45, a vertex-vertex representation of the 3D mesh 45, or other appropriate 3D mesh representation.

Typically, the state of a 3D mesh 45 specifies the vertex positions within a local coordinate system (aka an object space) attached to the 3D mesh 45, where the local coordinate system has an origin at a given reference point. The state of the 3D mesh 45 can be transformed from the object space of the 3D mesh 45 to a global coordinate system (aka a world space) by applying a model matrix (M) to each vertex position of the state. The model matrix, given as M=TRS, includes a matrix product of a translation matrix (T), a rotation matrix (R), and a scaling matrix(S) that each define a translation, rotation, and scaling, respectively, of a position in the 3D mesh 45's object space that maps to a position within the world space. The inverse (M⁻¹) of the model matrix transforms a position within the world space to the 3D mesh 45's object space, performing the above operations in reverse M⁻¹=S⁻¹R⁻¹T⁻¹.

The resolution of a 3D mesh 45 can refer to the mesh resolution of the 3D mesh 45, as well as the spatial resolution of the 3D mesh 45. The mesh resolution can refer to the vertex count, the edge count, and/or the face count of the 3D mesh 45. The spatial resolution can refer to the vertex density (e.g., vertex count divided by total face area), the edge density (e.g., edge count divided by total face area), the face density (e.g., face count divided by total face area), the average edge length (e.g., mean edge length or root mean square edge length), and/or the average face area (e.g., mean face area or root mean square face area)

Note, the mesh resolution is a structural attribute that describes how finely the computational domain is divided into discrete elements. The spatial resolution, on the other hand, is a functional attribute that describes the smallest distinguishable feature in the computational domain and, therefore, is a property of the physical or numerical system being modeled. This is because 3D meshes 45 can be arbitrarily scaled, meaning their absolute element sizes do not have meaning unless referenced against the physical or numerical system being modeled. Generally, the physical or numerical system being modeled defines a characteristic length scale that prescribes dimensions to the lengths of the edges 47 and the areas of the faces 48 of a 3D mesh 45. Thus, when comparing spatial resolution between two or more 3D meshes 45, it is assumed the 3D meshes 45 are normalized to a common, characteristic length scale. This can be done, for example, by transforming the 3D meshes 45 into the world space and setting a common scale of the world space to the characteristic length scale.

A motion sequence is a temporally ordered series of spatial configurations (or states) of a scene, representing how the scene evolves over a period of time. Formally, the motion sequence captures changes in shape, position, orientation, and/or deformation of the scene, indexed over time. For example, if the scene includes a human body, the motion sequence can include a sequence of poses of the human body. More generally, a scene can include any set of one or more objects in an environment or in isolation. For example, a scene can include a single object without a background or backdrop, or with a single-color background or backdrop, e.g., a polished metallic sphere suspended against a solid black background. A scene can include multiple objects in an environment, e.g., two robotic arms in a brightly lit workshop.

Examples of objects include: (i) living beings, including real-life beings and imaginary beings; (ii) vehicles and transportation, including land vehicles, water vehicles, air vehicles, and space vehicles; (iii) everyday objects, including electronics, furniture, clothing, household items, food and beverages, and tools and equipment; (iii) natural objects, including geological features, water bodies, sky and space objects, and weather elements; (iv) abstract and conceptual objects, including symbols and signs, digital and virtual objects, and scientific and mathematical objects; and (v) fictional and pop culture objects, including science fiction and fantasy technology, magical artifacts, and weapons and combat items.

Examples of environments include: (i) indoor environments, including living rooms, kitchens, bedrooms, bathrooms, and restaurants; (ii) outdoor environments, including streets, parking lots, forests, parks, and beaches; and (iii) specialized and abstract environments, including space environments, fantasy landscapes, and dreamlike environments.

Implementations of the system 10 can be used for high-fidelity 2D-to-3D conversion of motion sequences involving animation of one or more living beings, including real-life and/or imaginary beings. Such implementations of the system 10 can be particularly useful for industries such as entertainment and media, robotics and AI, healthcare and medical research, forensics and law enforcement, education and training, e-commerce and fashion, and archaeology and cultural heritage.

Examples of real-life beings include humans and animals. Examples of humans include men, women, children, babies, and elderly persons. Examples of animals include mammals, birds, reptiles, amphibians, fish, and insects.

Examples of imaginary beings include human-like beings, mythical creatures, fantasy entities, monsters, anthropomorphic beings, extraterrestrial and supernatural beings, abstract and conceptual beings, and absurd beings. Examples of human-like beings include cyborgs, androids, humanoids, humanoid robots, clones, superhumans, and mutants. Examples of mythical creatures include unicorns, griffins, phoenixes, krakens, dragons, chimeras, werewolves, yetis, basilisks, centaurs, hydras, and sphinxes. Examples of monsters include folklore monsters, horror monsters, and Kaiju. Examples of fantasy entities include wizards, elves, fairies, dwarves, orcs, trolls, and goblins. Examples of anthropomorphic beings include talking animals, sentient objects, living plants, gods and deities, and elemental beings. Examples of extraterrestrial and supernatural beings include aliens, cosmic entities, living celestial bodies, angels, demons, djinn, and genies. Examples of abstract and conceptual beings include virtual avatars, AI entities, holograms, living data constructs, and dream beings. Examples of absurd beings include living food, personified emotions, and living numbers and letters.

A motion sequence can involve live (e.g., full-body) animation of one or more living beings, facial animation of one or more living beings, or a combination of both live and facial animation of one or more living beings.

Examples of live animation include: (i) basic movements, including walking, running, jumping, hopping, skipping, and crawling; (ii) gestural movements, including waving, pointing, shrugging, clapping, snapping fingers, and giving a thumbs-up; (iii) expressive movements, including shivering, trembling, flinching, fidgeting, and swaying; (iv) combat and aggressive movements, including punching, kicking, dodging, blocking, and lunging; and (vi) animal- or creature-specific movements, including galloping, slithering, fluttering, pouncing, and skittering.

Examples of facial animation include: (i) eye movements, including blinking, squinting, widening eyes, rolling eyes, and darting eyes; (ii) mouth and lip movements, including smiling, frowning, pouting, trembling limps, and pursing lips; (iii) eyebrow movements, including raising eyebrows, furrowing eyebrows, and arching one eyebrow; (iv) nose and cheek movements, including wrinkling nose, flaring nostrils, and cheek puffing; and (v) jaw and chin movements, including clenching jaw, grinding teeth, and tilting head.

Examples of combinations of live and facial animation include: (i) laughing with facial animation and upper body movement; (ii) yawning with mouth movement and a slight stretch or arm lift; (iii) crying with facial animation and shaking shoulders; (iv) sighing with a deep breath and visible body relaxation; (v) shuddering with a quick shake and a facial grimace; and (vi) performance dancing with expressive facial animation and fully-body movement.

Referring to FIG. 1, the system 10 is configured to receive a source video 20.x depicting a motion sequence. For example, the system 10 can receive the source video 20.x as input from a motion capture setup, a camera, a mobile phone, or generic client or computing device.

The source video 20.x, given as

$${I}^{x} ( \cdot ) = [ {I}_{1}^{x} , {I}_{2}^{x} , … , {I}_{N}^{x} ] ,$$

includes a sequence of frames

$$( {I}_{n}^{x} )$$

25.x.1 to 25.x.N each depicting a respective configuration of the motion sequence. Here, n indexes each frame 25.x.n in the source video 20.x, and N is the total number of frames in the source video 20.x. For example, n can index a respective timestamp of each frame 25.x.n in the source video 20.x. In general, the source video 20.x is a 2D video of the motion sequence, and each frame 25.x.n is a respective 2D image of the respective configuration of the motion sequence. The source video 20.x can have one or more color channels. For example, the source video 20.x can have one color channel (e.g., a monochromatic or grayscale channel) or multiple color channels (e.g., a red, green, and blue color channel).

The total number of frames in the source video 20.x may be given as N=fT, where f is the framerate of the source video 20.x, and T is the total duration of the source video 20.x. For example, the source video 20.x can have a framerate of at least about 1, 5, 10, 15, 20, 24, 25, 30, 35, 40, 45, 48, 50, 55, 60, 90, 120, 150, 180, 210, 240, 480, 960 frames per second (“fps”), or more, or any range between any of two these values. The source video 20.x can have a framerate of at most about 960, 480, 240, 210, 180, 150, 120, 90, 60, 55, 40, 48, 45, 40, 35, 30, 25, 24, 20, 15, 10, 5, 1 fps, or less, or any range between any of two these values. The source video 20.x can have a total duration of at least about 1 second (“sec”), 5 sec, 10 sec, 15 sec, 20 sec, 25 sec, 30 sec, 35 sec, 40 sec, 45 sec, 50 sec, 55 sec, 1 minute (“min”), 2 min, 3 min, 4 min, 5 min, 6 min, 7 min, 8 min, 9 min, 10 min, 15 min, or more, or any range between any of two these values. The source video 20.x can have a total duration of at most about 15 min, 10 min, 9 min, 8 min, 7 min, 6 min, 5 min, 4 min, 3 min, 2 min, 1 min, 55 sec, 45 sec, 40 sec, 35 sec, 30 sec, 25 sec, 20 sec, 15 sec, 10 sec, 5 sec, 1 sec, or less, or any range between any of two these values.

The source video 20.x has a pixel resolution corresponding to the pixel count of each frame 25.x.n. For example, the source video 20.x can have a pixel resolution of at least about 0.1, 0.2, 0.3, 0.4, 0.5, 0.6. 0.7, 0.8, 0.9, 1.0, 2.0, 3.0, 4.0, 5.0, 6.0, 7.0, 8.0, 9.0, 10.0, 11.0, 12.0, 13.0, 14.0, 15.0 megapixels (“MP”), or more, or any range between any two of these values. The source video 20.x can have a pixel resolution of at most about 15.0, 14.0, 13.0, 12.0, 11.0, 10.0. 9.0, 8.0, 7.0, 6.0, 5.0, 4.0, 3.0, 2.0, 1.0, 0.9, 0.8, 0.7, 0.6, 0.5, 0.4, 0.3, 0.2, 0.1 MP, or less, or any range between any two of these values.

The system 10 is configured to forward a shape reconstruction input to the shape reconstruction module 100, where the shape reconstruction input includes the source video 20.x depicting the motion sequence. The system 10 is configured to process the shape reconstruction input, using the shape reconstruction module 100, to generate a shape reconstruction output including a source animation 40.x of a 3D source mesh 45.x performing the motion sequence.

The source animation 40.x, given as

$${\text{?}}^{x} ( \cdot ) = [ {\text{?}}_{1}^{x} , {\text{?}}_{2}^{x} , … , {\text{?}}_{N}^{x} ] ,$$

includes a sequence of states

$$( {\text{?}}_{n}^{x} )$$

45.x.1 to 45.x.N of the 3D source mesh 45.x. Here, n indexes each state 45.x.n in the source animation 40.x, and N is the total number of states in the source animation 40.x. Each state 45.x.n of the 3D source mesh 45.x is configured in the respective configuration of the motion sequence depicted in the respective frame 25.x.n of the source video 20.x.

The system 10 uses a base state

$$( {\text{?}}_{0}^{x} )$$

45.x.0 of the 3D source mesh 45.x as an initial and/or reference state of the 3D source mesh 45.x. That is, each state 45.x.n in the source animation 40.x can be defined relative to the base state 45.x.0. For example, the base state 45.x.0 can define the 3D source mesh 45.x in a rest, neutral, or preferred configuration. Alternatively, or in addition, the base state 45.x.0 can be one of the states 45.x.n in the source animation 40.x, e.g., the first state 45.x.1. For example, the system 10 can sample, e.g., randomly sample, the base state 45.x.0 from the source animation 40.x upon processing of the source video 20.x. Alternatively, or in addition, the base state 45.x.0 can be an average of the states 45.x.n in the source animation 40.x.

In general, a state 45.x.n of the 3D source mesh 45.x includes (or otherwise references) a set of source vertices ( [symbol] ) 46.x, a set of source edges (ε^{x}) 47.x, and a set of source faces ( [symbol] ) 48.x, which define the underlying resolution, connectivity, and topology of the 3D source mesh 45.x. Each state 45.x.n also includes a respective source vertex field

$$( {V}_{n}^{x} )$$

which defines the structure and geometry of the state 45.x.n within the object space of the 3D source mesh 45.x. The source vertex field includes a respective position

$$( {v}_{i , n}^{x} )$$

for each source vertex 46.x.i of the 3D source mesh 45.x. The state 45.x.n of the 3D source mesh 45.x can thus be written succinctly as:

$${\text{?}}_{n}^{x} = ( {𝒱}^{x} , {ℰ}^{x} , {ℱ}^{x} , {V}_{n}^{x} ) , \qquad ( 1 a )$$

with,

$${V}_{n}^{x} = \{ {v}_{i , n}^{x} \vert i ∈ {𝒱}^{x} \} , \qquad ( 1 b )$$

and,

ε^{x}={(i,j)|i,j∈ [symbol] }, (1c)

and,

[symbol]

={(i,j,k)|(i,j),(j,k),(i,k)∈ε^{x}}, (1d)

where i indexes each source vertex 46.x.i in the set of source vertices 46.x, (i, j) indexes each source edge 47.x.ij in the set of source edges 47.x, and (i, j, k) indexes each source face 48.x.ijk in the set of source faces 48.x. Each source edge 47.x.ij connects a respective pair of source vertices 46.x.i and 46.x.j, and each source face 48.x.ijk is bounded by a respective triplet of source edges 47.x.ij, 47.x.jk, and 47.x.ik.

In some implementations, each state 45.x.n of the 3D source mesh 45.x further includes a respective source forward direction

$$( {f}_{n}^{x} ) ,$$

which defines the direction the state 45.x.n is pointing to within the object space of the 3D source mesh 45.x.

In some implementations, each state 45.x.n of the 3D source mesh 45.x further includes a respective source vertex normal field

$$( {N}_{n}^{x} ) ,$$

which defines the local surface orientation of the state 45.x.n within the object space of the 3D source mesh 45.x. The source vertex normal field, given as

$${N}_{n}^{x} = \{ {n}_{i , n}^{x} \vert i ∈ {𝒱}^{x} \} ,$$

includes a respective vertex normal

$$( {n}_{i , n}^{x} )$$

for each source vertex 46.x.i of the 3D source mesh 45.x. For example, the system 10 can compute the vertex normal of the source vertex 46.x.i as a normalized average of the respective surface normals of each of the source faces 48.x.ijk that contain the source vertex 46.x.i. The average can be a weighted average, e.g., weighted by the respective area of each source face 48.x.ijk. The average can also be an unweighted average.

While the source faces 48.x of the 3D source mesh 45.x are described herein as triangle faces, any face type may be used, such as quadrilateral faces, both triangle and quadrilateral faces, generic polygonal faces, mixed types of polygonal faces, or curved faces in some cases.

The 3D source mesh 45.x may be considered a “low-resolution mesh”, e.g., having a low mesh resolution and a low spatial resolution for the physical or numerical system being modeled. For example, the 3D source mesh 45.x can have a vertex count of at most about 1,000,000, 100,000, 10,000, 1,000, or less, or any range between any two of these values. The 3D source mesh 45.x can have an edge count of at most about 1,000,000, 100,000, 10,000, 1,000, or less, or any range between any two of these values. The 3D source mesh 45.x can have a face count of at most about 1,000,000, 100,000, 10,000, 1,000, or less, or any range between any two of these values.

The system 10 is configured to receive a base state 45.y.0

$$( {\text{?}}_{0}^{y} )$$

of a 3D target mesn 45.y. The system 10 uses the base state 45.y.0 of the 3D target mesh 45.y as an initial and/or reference state of the 3D target mesh 45.y. That is, each new state 45.y.n of the 3D target mesh 45.y generated by the system 10 can be defined relative to the base state 45.y.0. For example, the base state 45.y.0 can define the 3D target mesh 45.y in a rest, neutral, or preferred configuration.

In general, a state 45.y.n of the 3D target mesh 45.y includes (or otherwise references) a set of target vertices ( [symbol] ) 46.y, a set of target edges (ε^{y}) 47.y, and a set of target faces ( [symbol] ) 48.y, which define the underlying resolution, connectivity, and topology of the 3D target mesh 45.y. Each state 45.y.n also includes a respective target vertex field

$$( {V}_{n}^{y} )$$

when defines the structure and geometry of the state 45.y.n with the object space of the 3D target mesh 45.y. The target vertex field includes a respective position

$$( {v}_{i , n}^{y} )$$

for each target vertex 46.y.i in the set of target vertices 46.y. The state 45.y.n of the 3D target mesh 45.y can thus be written succinctly as:

$${\text{?}}_{n}^{y} = ( {𝒱}^{y} , {ℰ}^{y} , {ℱ}^{y} , {V}_{n}^{y} ) , \qquad ( 2 a )$$

with,

$${V}_{n}^{y} = \{ {v}_{i , n}^{y} \vert i ∈ {𝒱}^{y} \} , \qquad ( 2 b )$$

and,

ε^{y}={(i,j)|i,j∈ [symbol] }, (2c)

and,

[symbol]

={(i,j,k)|(i,j),(j,k),(i,k)∈ε^{y}}, (2d)

where i indexes each target vertex 46.y.i in the set of target vertices 46.y, (i, j) indexes each target edge 47.y.ij in the set of target edges 47.y, and (i, j, k) indexes each target face 48.y.ijk in the set of target faces 48.y. Each target edge 47.y.ij connects a respective pair of target vertices 46.y.i and 46.y.j, and each target face 48.y.ijk is bounded by a respective triplet of target edges 47.y.ij, 47.y.jk, and 47.y.ik.

In some implementations, each state 45.y.n of the 3D target mesh 45.y further includes a respective target forward direction

$$( {f}_{n}^{y} ) ,$$

which defines the direction the state 45.y.n is pointing to within the object space of the 3D target mesh 45.y.

In some implementations, each state 45.x.n of the 3D target mesh 45.y further includes a respective target vertex normal field

$$( {N}_{n}^{y} ) ,$$

which defines the local surface orientation of the state 45.y.n within the object space of the 3D target mesh 45.y. The target vertex normal field, given as

$${N}_{n}^{y} = \{ {n}_{i , n}^{y} \vert i ∈ {𝒱}^{y} \} ,$$

includes a respective vertex normal

$$( {n}_{i , n}^{y} )$$

for each target vertex 46.y.i of the 3D target mesh 45.y. For example, the system 10 can compute the vertex normal of the target vertex 46.y.i as a normalized average of the respective surface normals of each of the target faces 48.y.ijk that contain the target vertex 46.y.i. The average can be a weighted average, e.g., weighted by the respective area of each target face 48.y.ijk. The average can also be an unweighted average.

While the target faces 48.y of the 3D target mesh 45.y are described herein as triangle faces, any face type may be used, such as quadrilateral faces, both triangle and quadrilateral faces, generic polygonal faces, mixed types of polygonal faces, or curved faces in some cases.

In some implementations, the 3D target mesh 45.y has a different face type and/or a different type of tessellation than the 3D source mesh 45.x.

In some implementations, the 3D target mesh 45.y has a different topology than the 3D source mesh 45.x. In this case, the 3D target mesh 45.y cannot be continuously deformed into the 3D source mesh 45.x. For example, the 3D target mesh 45.y can have a different Euler characteristic (aka Euler number, or Euler-Poincare characteristic) than the 3D source mesh 45.x.

The 3D target mesh 45.y may be considered a “high-resolution mesh”, e.g., having a high mesh resolution and a high spatial resolution for the physical or numerical system being modeled. For example, the 3D target mesh 45.y can have a vertex count of at least about 10,000, 100,000, 1,000,000, 10,000,000, 100,000,000 vertices 46.y, or more, or any range between any two of these values. The 3D target mesh 45.y can have an edge count of at least about 10,000, 100,000, 1,000,000, 10,000,000, 100,000,000, or more, or any range between any two of these values. The 3D target mesh 45.y can have a face count of at least about 10,000, 100,000, 1,000,000, 10,000,000, 100,000,000, or more, or any range between any two of these values.

Notably, the 3D target mesh 45.y has higher resolution than the 3D source mesh 45.x. That is, the 3D target mesh 45.y has a higher mesh resolution than the 3D source mesh 45.x and, typically, also has a higher spatial resolution than the 3D source mesh 45, e.g., as measured within the world space. For example, the 3D target mesh 45.y can have a higher vertex count, a higher edge count, and a higher face count than the 3D source mesh 45.x. The 3D target mesh 45.y may also have a higher vertex density, a higher edge density, a higher face density, a smaller average edge length, and a smaller average face area than the 3D source mesh 45.x.

The system 10 is configured to forward a feature matching input to the feature matching module 200, where the feature matching input includes: (i) the base state 45.x.0 of the 3D source mesh 45.x, and (ii) the base state 45.y.0 of the 3D target mesh 45.y. The system 10 is configured to process the feature matching input, using the featuring matching module 200, to generate a feature matching output including a set ( [symbol] ) 60.xy of 3D paired correspondences 65.xy between: (i) the 3D source mesh 45.x, and (ii) the 3D target mesh 45.y.

In some implementations, the feature matching output further includes a set ( [symbol] ) 56.xy of confidence matrices 58 between the 3D source 45.x and target 45.y meshes.

The set 60.xy of 3D paired correspondences 65.xy establishes a correspondence mapping between the 3D source mesh 45.x and the 3D target mesh 45.y, e.g., allowing deformations to be transferred from the 3D source mesh 45.x to the 3D target mesh 45.y consistently. The set 56.xy of confidence matrices 58 provides the confidence in the correspondence mapping, e.g., allowing deformations to be probabilistically weighted when transferring from the 3D source mesh 45.x to the 3D target mesh 45.y. For example, if the 3D meshes 45.x and 45.y are 3D meshes of faces, the set 60.xy of 3D paired correspondences 65.xy can identify eyes, mouth, lips, neck, brow, chin, ears, etc. of the faces. If the 3D meshes 45.x and 45.y are 3D meshes of animals, the set 60.xy of 3D paired correspondences 65.xy can identify head, legs, tail, fins, etc., of the animals.

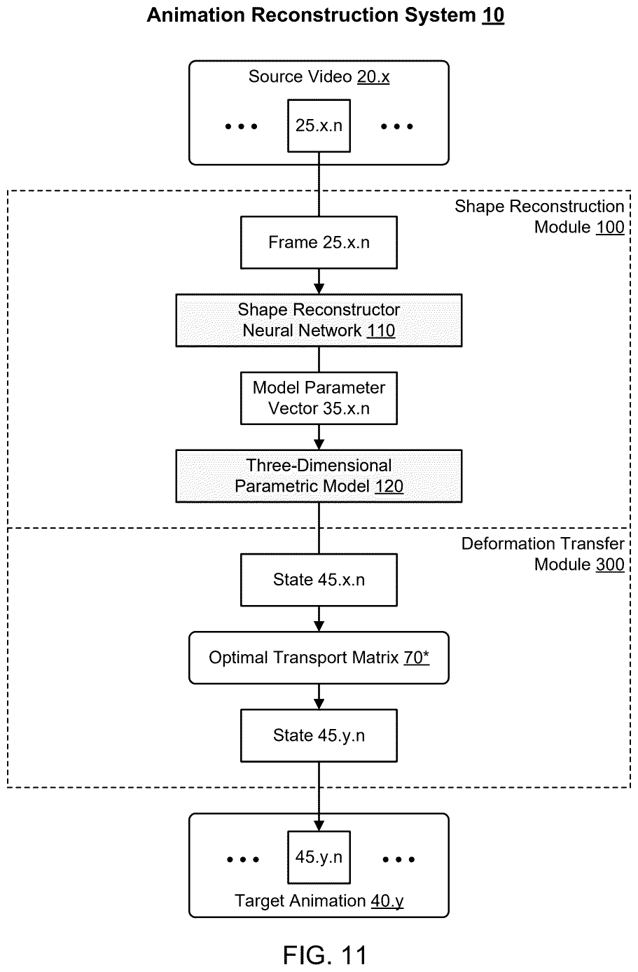

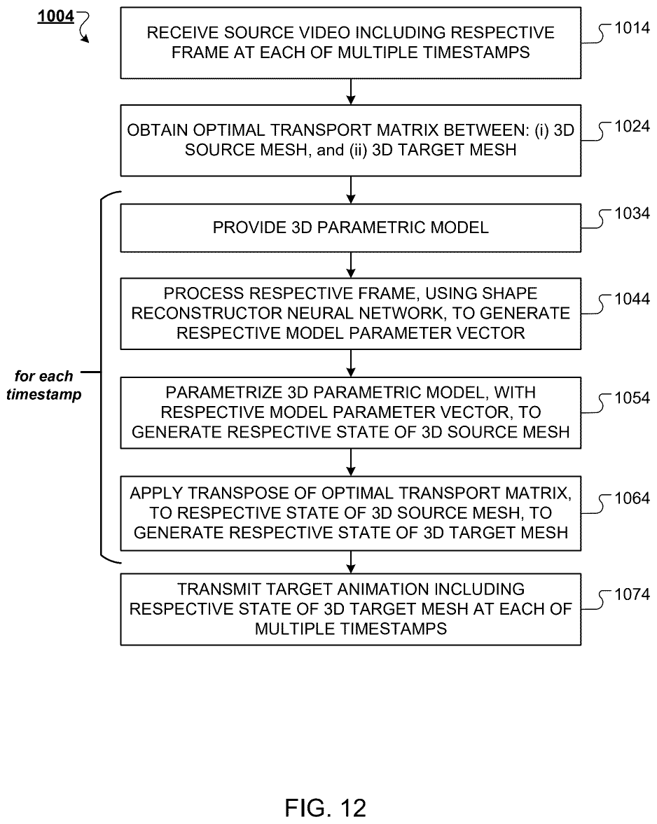

The featuring matching module 200 is typically a one-time process for a given 3D (source 45.x, target 45.y) mesh pair. The featuring matching module 200 can automatically determine the set 60.xy of 3D paired correspondences 65.xy between the 3D meshes 45.x and 45.y without any human intervention (and with a single state of the 3D meshes 45.x and 45.y). This generally saves computational cost and time during the high-fidelity 2D-to-3D animation conversion process, while also allowing for (e.g., continuous) video streams to be converted online without repeatedly performing feature matching, see FIGS. 11-12 for example.

The set 60.xy of 3D paired correspondences 65.xy, given as

$${𝒞}^{xy} = {\{ ( {f}_{p}^{x} , {f}_{p}^{y} ) \}}_{p = 1}^{P} ,$$

includes a respective 3D paired correspondenc

$$( {f}_{p}^{x} , {f}_{p}^{y} )$$

65.xy.p identifying each common feature in the 3D source 45.x and target 45.y meshes. The set 56.xy of confidence matrices 58, given as

$${\text{?}}^{xy} = {\{ {S}^{p} \}}_{p = 1}^{P} ,$$

includes a respective confidence matrix (SP) 58.p for each common feature identified in the 3D source 45.x and target 45.y meshes. The confidence matrix 58.p measures the confidence that the 3D paired correspondence 65.xy.p accurately identifies the common feature in the 3D source 45.x and target 45.y meshes. Here, p indexes each common feature, and P is the total number of common features identified in the 3D meshes 45.x and target 45.y. For example, the total number of common features can be at least about 1, 2, 3, 4, 5, 6, 7, 8, 9, 10, 15, 20, 25, 50, 100, or more common features, or any range between any two of these values. The total number of common features can be at most about 100, 50, 25, 20, 15, 10, 9, 8, 7, 6, 5, 4, 3, 2, 1, or less common features, or any range between any two of these values.

For each common feature, the respective 3D paired correspondence 65.xy.p includes: (i) a respective 3D source correspondence

$$( {f}_{p}^{x} )$$

65.x.p identifying the common feature in the 3D source mesh 45.x, and (ii) a respective 3D target correspondence

$$( {f}_{p}^{y} )$$

65.y.p identifying the feature in the 3D target mesh 45.y. In other words, the 3D paired correspondence 65.xy.p is a pairing of

$${f}_{p}^{y} ⊂ {𝒱}^{x} and {f}_{p}^{y} ⊂ {𝒱}^{y} ,$$

that indicates a respective correspondence mapping exists between them

$${f}_{p}^{x} ↔ {f}_{p}^{y} .$$

The correspondence mapping can be defined by the confidence matrix 58.p for the common feature. The confidence matrix 58.p includes a respective confidence score

$$( {s}_{ij}^{p} )$$

between: (i) each source vertex 46.x.i in the 3D source correspondence 65.x.p, and (ii) each target vertex 46.x.j in the 3D target correspondence 65.y.p. The confidence score (or matching score) measures the confidence that the source 46.x.i and target 46.y.j vertices are matched with each other, and provides a probabilistic weighting that can be used for deformation transfer (and other tasks).

Note, as the 3D meshes 45.x and 45.y have differing resolutions, the 3D source 65.x and target 65.y correspondences are not necessarily of equal size, nor one-to-one between vertices 46.x and 46.y. There are, in general, no restrictions on the set 60.xy of 3D paired correspondences 65.xy. For example, each 3D paired correspondence 65.xy.p can be a one-to-one mapping, a one-to-many mapping, a many-to-one mapping, a many-to-many mapping, a bijective (one-to-one and onto) mapping, a surjective (onto) mapping, or a not-onto mapping. The confidence matrix 58.p can assign the confidence scores to handle any of these correspondence mappings. This generality enables, for example, deformation transfer between 3D source 45.x and target 45.y meshes of not only different resolutions, but also different face types, tessellations, and/or topologies.

The system 10 is configured to forward a deformation transfer input to the deformation transfer module 300, where the deformation transfer input includes: (i) the source animation 40.x of the 3D source mesh 45.x performing the motion sequence, (ii) the base state 45.y.0 of the 3D target mesh 45.y, and (iii) the set 60.xy of 3D paired correspondences 65.xy between the 3D source 45.x and target 45.y meshes. In some implementations, the deformation transfer input further includes the set 56.xy of confidence matrices 58 between the 3D source 45.x and target 45.y meshes. The system 10 is configured to process the deformation transfer input, using the deformation transfer module 300, to generate a deformation transfer output including a target animation 40.y of the 3D target mesh 45.y performing the motion sequence.

The target animation 40.y, given as

$${\text{?}}^{y} ( \cdot ) = [ {\text{?}}_{1}^{y} , {\text{?}}_{2}^{y} , … , {\text{?}}_{N}^{y} ] ,$$

includes a sequence of states

$$( {\text{?}}_{n}^{x} )$$

45.x.1 to 45.x.N of the 3D target mesh 45.y. Here, n indexes each state 45.y.n in the target animation 40.y, and N is the total number of states in the target animation 40.y. Each state 45.y.n of the 3D target mesh 45.y is configured in the respective configuration of the motion sequence depicted in the respective frame 25.x.n of the source video 20.x.

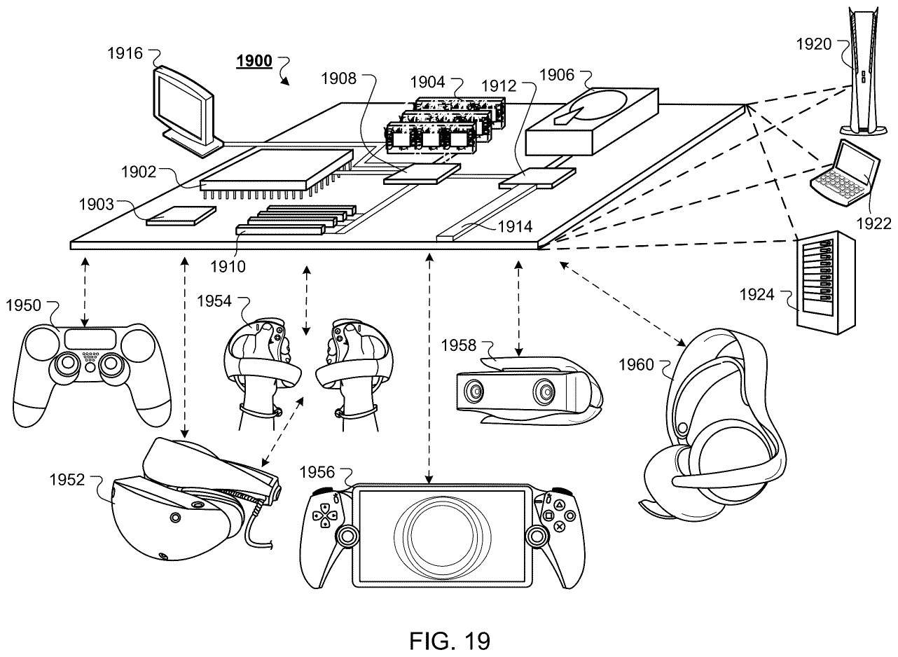

The system 10 can be implemented on various computing devices, e.g., on a user device (e.g., a mobile device), or on one or more computers in a data center, etc. Examples of a computing device 1900 that some, or all, of the system 10 can be implemented on are described in Sec. V with reference to FIG. 19. For example, the system 10 including each of the modules 100, 200, and 300 can be implemented on one computing device 1900. The system 10 can be implemented on multiple computing devices 1900 in communication with one another, e.g., where each of the modules 100, 200, and 300 is implemented on a respective computing device 1900, two of the modules 100, 200, and 300 are implemented on a first computing device 1900 and one of the modules 100, 200, and 300 is implemented on a second computing device 1900, and so on.

In some implementations, users can interact with the system 10, e.g., by providing a query by way of a user interface, e.g., a graphical user interface (“GUI”), or an application programming interface (“API”). In particular, a user can provide a query including: (i) a request to process a source video 20.x, and (ii) the source video 20.x. The system 10 can then process the source video 20.x, responsive to the request, and provide the target animation 40.y resulting from the request to the user, e.g., for implementation on a user device of the user, or for storage in a data storage device. In some cases, the system 10 can transmit the target animation 40.y to a user device of the user, e.g., by way of a data communication network (e.g., the Internet).

While the system 10 is described herein as a processing pipeline including the shape reconstruction module 100, feature matching module 200, and deformation transfer module 300, other implementations of the system 10 are also feasible without deviating from the scope of the disclosure. Functionalities of some, or all, of the modules 100, 200, and 300 can be intermingled or separated into more or fewer modules. For example, the system 10 can be implemented as a single system or module to perform all the functionalities of the modules 100, 200, and 300. As another example, the system 10 can implemented with: (i) a first module that performs a first portion of the functionalities of the modules 100, 200, and 300, and (ii) a second module that performs a second portion of the functionalities of the modules 100, 200, and 300. In other words, the segmentation of the system 10 into the three modules 100, 200, and 300 is not germane to implementing the system 10 and the methods of high-fidelity 2D-to-3D animation conversion described herein, but provided as a convenient modular framework for separating and describing different tasks in the high-fidelity 2D-to-3D animation conversion process.

FIG. 2 is a schematic diagram depicting an example implementation of the animation reconstruction system 10 performing high-fidelity 2D-to-3D animation conversion. FIG. 2 shows an example of a source video 20.x performing a motion sequence, an example of a source animation 40.x of a 3D source mesh 45.x performing the motion sequence, and an example of a target animation 40.y of a 3D target mesh 45.y performing the motion sequence.

In this example, the motion sequence is a temporally ordered series of facial expressions (e.g., smiling to frowning), and the scene is a face. The source video 20.x depicts a cartoon face performing the series of facial expressions. The 3D source mesh 45.x is a 3D mesh of a source subject's face, and the source animation 40.x depicts the source subject's face performing the series of facial expressions. The 3D target mesh 45.y is a 3D mesh of a target subject's face, and the target animation 40.y depicts the target subject's face performing the series of facial expressions.

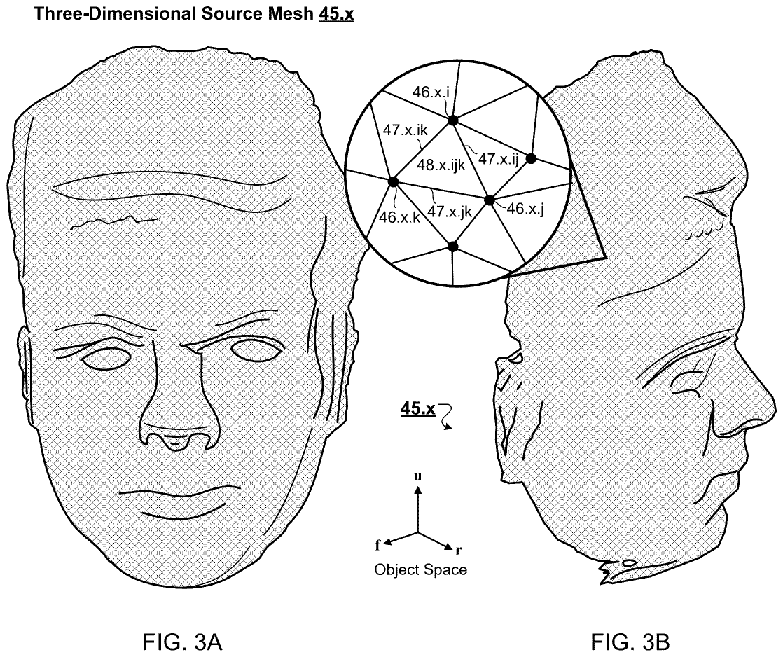

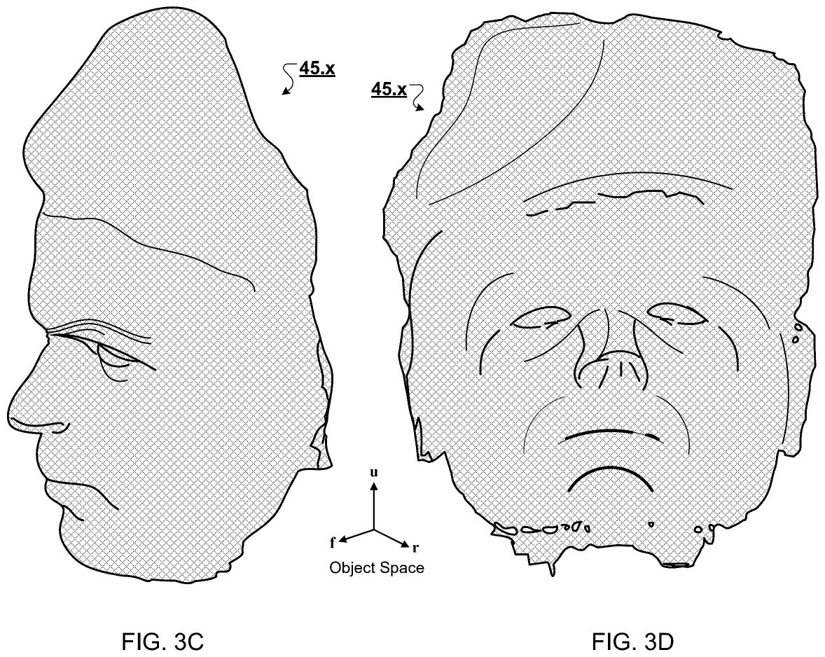

FIGS. 3A-3D are perspective views depicting an example of the 3D source mesh 45.x of the source subject's face. FIG. 3A is an anterior view of the 3D source mesh 45.x, FIG. 3B is a right lateral view of the 3D source mesh 45.x, FIG. 3C is a posterior view of the 3D source mesh 45.x, and FIG. 3D is a left lateral view of the 3D source mesh 45.x.

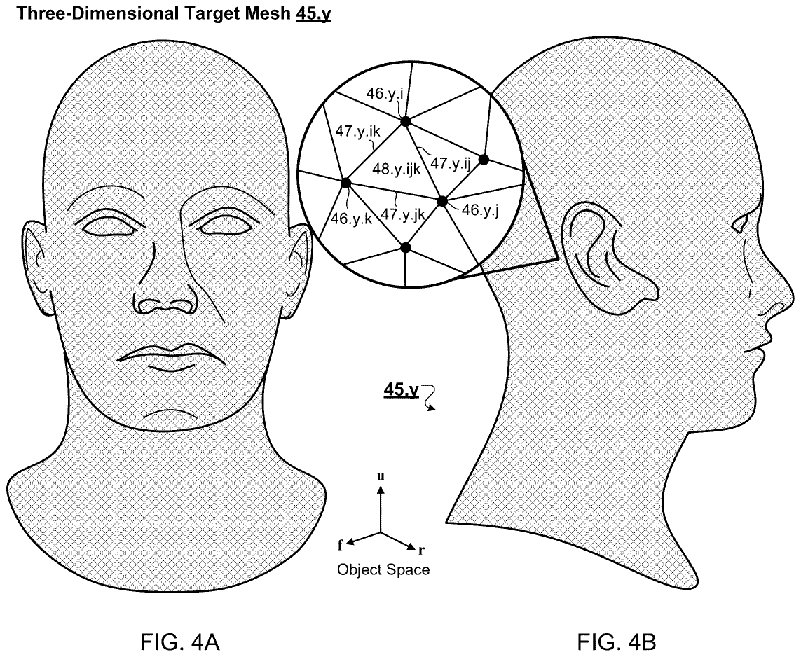

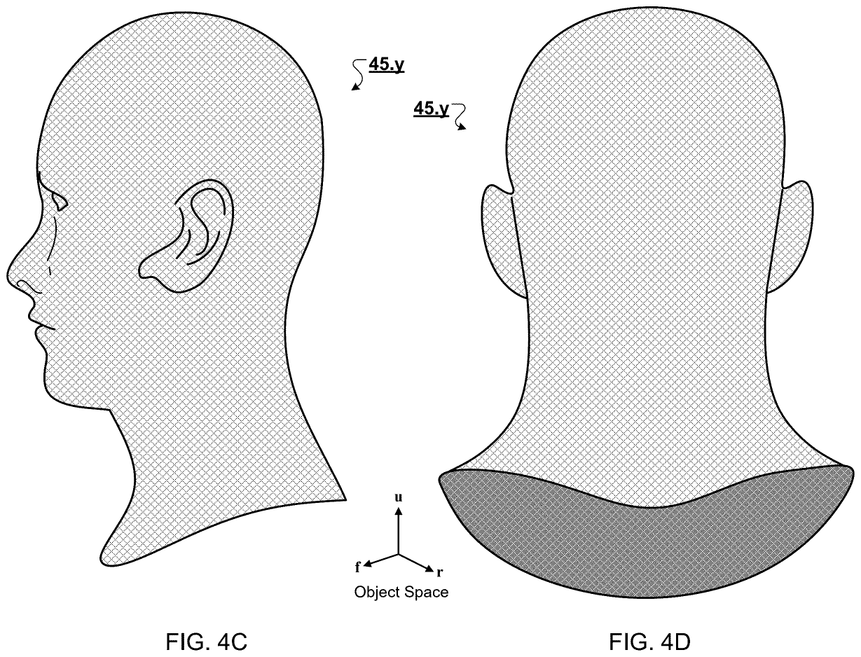

FIGS. 4A-4D are perspective views depicting an example of the 3D target mesh 45.y of the target subject's face. FIG. 4A is an anterior view of the 3D target mesh 45.y, FIG. 4B is a right lateral view of the 3D target mesh 45.y, FIG. 4C is a posterior view of the 3D target mesh 45.y, and FIG. 4D is a left lateral view of the 3D target mesh 45.y.

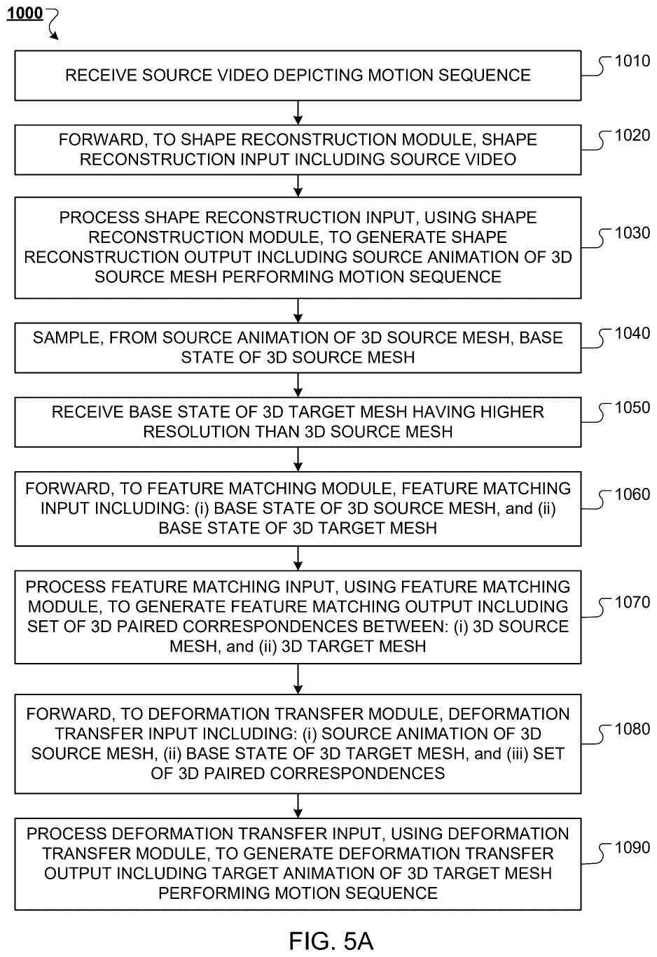

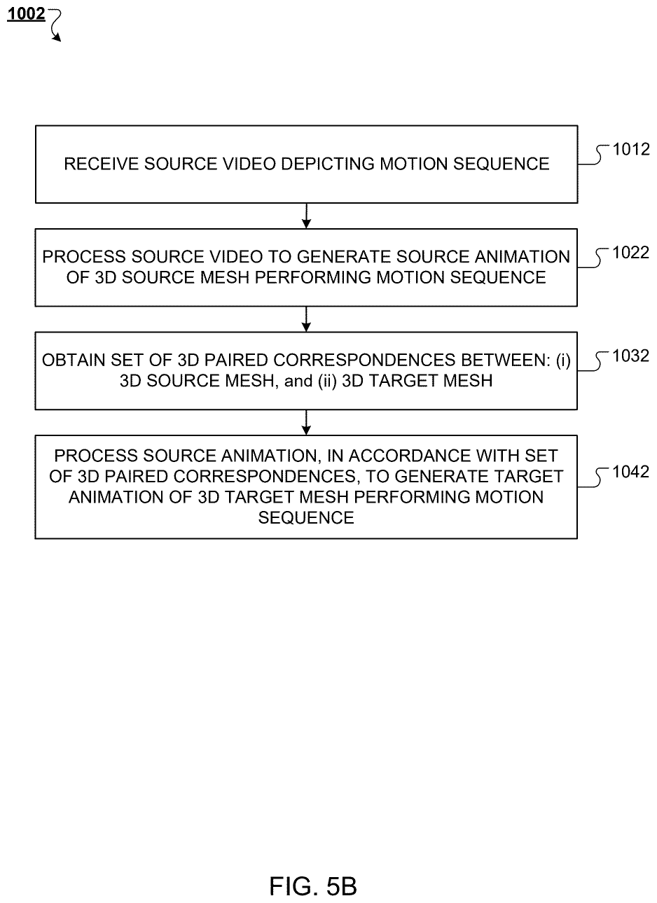

FIG. 5A is a flow diagram of an example process 1000 for performing high-fidelity 2D-to-3D animation conversion. For convenience, the process 1000 will be described as being performed by a system of one or more computers located in one or more locations. For example, a system, e.g., the animation reconstruction system 10 of FIG. 1, appropriately programmed in accordance with this specification, can perform the process 1000.

The system 10 receives a source video 20.x including a sequence of frames 25.x.1 to 25.x.N depicting a motion sequence (1010).

The system 10 forwards, to the shape reconstruction module 100, a shape reconstruction input including the source video 20.x depicting the motion sequence (1020).

The system 10 processes the shape reconstruction input, using the shape reconstruction module 100, to generate a shape reconstruction output including a source animation 40.x of a 3D source mesh 45.x performing the motion sequence (1030).

The system 10 samples, from the source animation 40.x, a base state 45.x.0 of the 3D source mesh 45.x (1040).

The system 10 receives a base state 45.y.0 of a 3D target mesh 45.y having higher resolution than the 3D source mesh 45.x (1050).

The system 10 forwards, to the feature matching module 200, a feature matching input including: (i) the base state 45.x.0 of the 3D source mesh 45.x, and (ii) the base state 45.y.0 of the 3D target mesh 45.y (1060).

The system 10 processes the feature matching input, using the feature matching module 200, to generate a feature matching output including a set 60.xy of 3D paired correspondences 65.xy between: (i) the 3D source mesh 45.x, and (ii) the 3D target mesh 45.y (1070). In some implementations of the process 1000, the feature matching output further includes a set 56.xy of confidence matrices 58 between the 3D source 45.x and target 45.y meshes.

The system 10 forwards, to the deformation transfer module 300, a deformation transfer input including: (i) the source animation 40.x of the 3D source mesh 45.x, (ii) the base state 45.y.0 of the 3D target mesh 45.y, and (iii) the set 60.xy of 3D paired correspondences 65.xy (1080). In some implementations of the process 1000, the deformation transfer input further includes the set 56.xy of confidence matrices 58.

The system 10 processes the deformation transfer input, using the deformation transfer module 300, to generate a deformation transfer output including a target animation 40.y of the 3D target mesh 45.y performing the motion sequence (1090).

FIG. 5B is a flow diagram of another example process 1002 for performing high-fidelity 2D-to-3D animation conversion. For convenience, the process 1002 will be described as being performed by a system of one or more computers located in one or more locations. For example, a system, e.g., the animation reconstruction system 10 of FIG. 1, appropriately programmed in accordance with this specification, can perform the process 1002.

The system 10 receives a source video 20.x including a sequence of frames 25.x.1 to 25.x.N depicting a motion sequence (1012).

The system 10 processes the source video 20.x to generate a source animation 40.x including a sequence of states 45.x.1 to 45.x.N of a 3D source mesh 45.x performing the motion sequence (1022).

The system 10 obtains a set 60.xy of 3D paired correspondences 65.xy between: (i) the 3D source mesh 45.x, and (ii) a 3D target mesh 45.y (1032), where the 3D target mesh 45.y has higher resolution than the 3D source mesh 45.x.

The system 10 processes the source animation 40.x, in accordance with the set 60.xy of 3D paired correspondences 65.xy, to generate a target animation 40.y including a sequence of states 45.y.1 to 45.y.N of the 3D target mesh 45.y performing the motion sequence (1042).

### A. Examples of Shape Reconstruction Modules

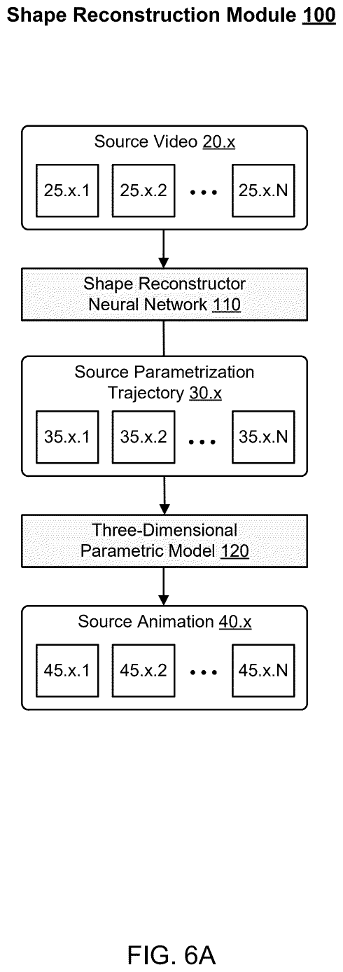

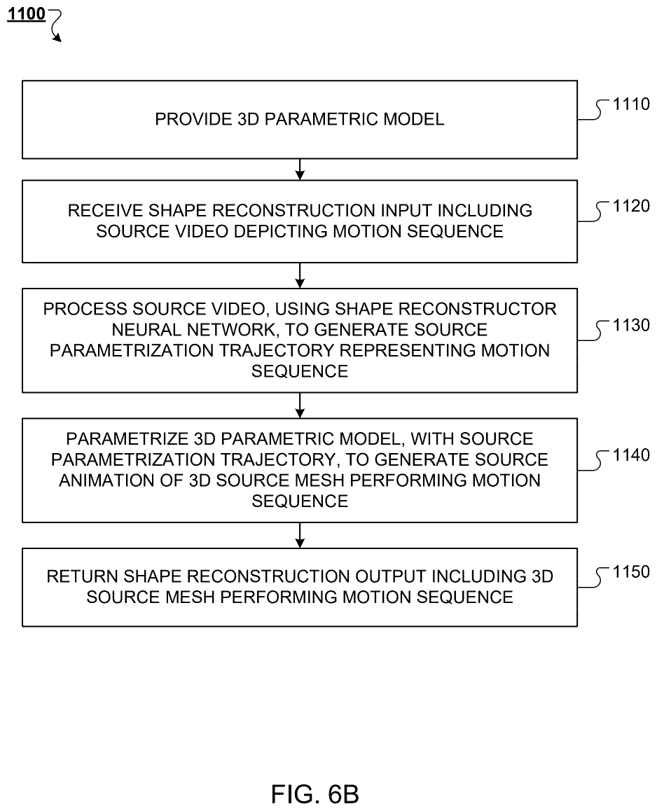

FIG. 6A is a schematic diagram depicting an example of the shape reconstruction module 100 for converting the source video 20.x into the source animation 40.x of the 3D source mesh 45.x. The shape reconstruction module 100 includes a shape reconstructor neural network 110 and a 3D parametric model 120. The shape reconstruction module 100 is an example of a system implemented as computer programs on one or more computers in one or more locations in which the systems, components, and techniques described below are implemented.

The shape reconstruction module 100 is configured to receive the shape reconstruction input including the source video 20.x depicting the motion sequence. The shape reconstruction module 100 is configured to process the shape reconstruction input to generate the source animation 40.x of the 3D source mesh 45.x performing the motion sequence. The shape reconstruction module 100 is configured to return the shape reconstruction output including the source animation 40.x of the 3D source mesh 45.x.

In more detail, the shape reconstruction module 100 is configured to process the source video 20.x, using the shape reconstructor neural network 110, to generate a source parametrization trajectory 30.x representing the motion sequence.

The source parametrization trajectory 30.x, given as

$${θ}^{x} ( \cdot ) = [ {θ}_{1}^{x} , {θ}_{2}^{x} , … , {θ}_{N}^{x} ] ,$$

includes a sequence of model parameter vectors

$$( {θ}_{N}^{x} )$$

35.x.1 to 35.x.N for the 3D parametric model 120. Here, n indexes each model parameter vector 35.x.n in the source parametrization trajectory 30.x, and N is the total number of model parameter vectors in the source parametrization trajectory 30.x. Each model parameter vector 35.x.n represents the respective configuration of the motion sequence depicted in the respective frame 25.x.n of the source video 20.x.

The shape reconstructor neural network 110, given as S_{α}, is a parametric machine learning model (e.g., a parametric function) parametrized by a set of network parameters (a). The set of network parameters include the respective learnable parameters, e.g., weights and biases, of each neural network layer of the shape reconstructor neural network 110. In general, the shape reconstructor neural network 110 has been trained to perform the shape reconstruction task via a machine learning technique, e.g., a supervised, semi-supervised, or unsupervised learning technique. Examples of training systems 101 for training the shape reconstructor neural network 110 via unsupervised learning techniques are described in Sec. IV.A.

The shape reconstructor neural network 110 is configured to process the source video 20.x, in accordance with current (e.g., trained and/or optimized) values of its set of network parameters, to generate the source parametrization trajectory 30.x. The operations of the shape reconstructor neural network 110 can be represented concisely as θ^{x}(·)=S_{α}[I^{x}(·)], where the source parametrization trajectory 30.x depends on the current values of the set of network parameters.

In some implementations, the shape reconstructor neural network 110 is configured to process each frame 25.x.n in the source video 20.x individually, e.g., via element-by-element (or frame-by-frame) processing, to generate the respective model parameter vector 35.x.n in the source parametrization trajectory 30.x. In this case, the shape reconstructor neural network 110 generates the source parametrization trajectory 30.x as

$${θ}^{x} ( \cdot ) = [ {S}_{α} [ {I}_{1}^{x} ] , {S}_{α} [ {I}_{2}^{x} ] , … , {S}_{α} [ {I}_{N}^{x} ] ] ,$$

and the shape reconstructor neural network 110 treats each frame 25.x.n as an individual, 2D image. However, the shape reconstructor neural network 110 can store information and retain knowledge of one or more previous frames 25.x of the source video 20.x, e.g., via a recurrent or hidden state that carries information causally across time, so that the current model parameter vector 35.x.n is conditioned on the previous frame(s) 25.x. This provides temporal awareness of the motion sequence even if the frames 25.x are processed individually. Moreover, element-by-element (or frame-by-frame) processing can enable applications such as high-fidelity streaming and online 2D-to-3D animation conversion, see FIGS. 11-12 for example.

In some implementations, the shape reconstructor neural network 110 is configured to process each frame 25.x.n in the source video 20.x in parallel, e.g., via sequence-to-sequence processing, to generate each model parameter vector 35.x.n in the source parametrization trajectory 30.x in parallel. Since the frames 25.x of the source video 20.x are typically temporally coherent, these implementations of the shape reconstructor neural network 110 may improve predictions of the model parameter vectors 35.x across the entire length of the source parametrization trajectory 30.x and, in turn, the shape reconstruction of the source animation 40.x resulting therefrom. For example, sequence-to-sequence processing may improve predictions of occluded objects (or occluded regions of objects) depicted in the source animation 20.x that are only visible for a subset of the frames 25.x. Although generally more computationally expensive than element-by-element (or frame-by-frame) processing, sequence-to-sequence processing may be preferred for improved temporal awareness of the motion sequence.

In some implementations, the shape reconstructor neural network 110 is configured to process a 2D image 24 or frame 25 (or a video 20 including a sequence thereof) of a fixed, input pixel resolution. In these cases, the shape reconstruction module 100 can resize each frame 25.x.n in the source video 20.x to the input pixel resolution of the shape reconstructor neural network 110 to generate a resized version of the frame 25.x.n having the input pixel resolution. The shape reconstruction module 100 can resize a 2D image 24 or frame 25 using any appropriate down-scaling or up-scaling method, such as interpolation or resampling method (e.g., nearest neighbor, bilinear, bicubic, Lanczos, or spline interpolation), an aspect ratio handling method (e.g., fixed aspect ratio scaling, letterboxing, cropping, or content-aware resizing), or an algorithmic scaling method (e.g., Fourier transform resizing, wavelet-based scaling, or AI-based super-resolution for up-scaling). The shape reconstruction module 100 then processes a resized version of the source video 20.x including a sequence of the resized versions of the frames 25.x.1 to 25.x.N, using the shape reconstructor neural network 110, to generate the source parametrization trajectory 30.x.

The shape reconstructor neural network 110 can have any appropriate neural network architecture that enables it to perform its described function, i.e., processing a 2D image 24 or frame 25 (or a video 20 including a sequence thereof) to generate a model parameter vector 35 (or a parametrization trajectory 30 including a sequence thereof). That is, the shape reconstructor neural network 110 can include any appropriate types of neural network layers (e.g., fully-connected layers, convolutional layers, recurrent layers, attention layers, etc.) in any appropriate numbers (e.g., 5 layers, 25 layers, or 100 layers) and connected in any appropriate configuration (e.g., as a linear sequence of layers, a residual configuration, etc.). For example, the shape reconstructor neural network 110 can be a convolutional neural network (“CNN”) such as a 2D or 3D CNN, a recurrent neural network (“RNN”), a hybrid CNN-RNN, an attention neural network (“ANN”), a graph neural network (“GNN”), or a Transformer-based neural network such as a Vision Transformer (“ViT”) neural network or a Video Vision Transformer (“ViViT”) neural network.

The 3D parametric model 120 provides a “low-resolution” base topology for the 3D source mesh 45.x that is deformable according to values of a model parameter vector 35.x.n. In some cases, the 3D parametric model 120 may also model the appearance of the 3D source mesh 45.x upon rendering, e.g., by generating a respective set of vertex attributes

$$( {a}_{i}^{x} )$$

for each of the source vertices 48.x.i of the 3D source mesh 45.x. The model parameter vector 35.x.n, in turn, characterizes the shape, appearance, and/or behavior of the configuration of the motion sequence depicted in the source video 20.x. Hence, the shape reconstructor neural network 110 is configured to manipulate the 3D parametric model 120.

The 3D parametric model 120 can be a structured parametric model or a generalized parametric model depending on the implementation. A structured parametric model is typically optimized for a specific type of scene or object, such as deformable surfaces, faces, human bodies, animals, or other types of living beings, while a generalized parametric model can capture relatively arbitrary objects. In either case, the 3D parametric model 120 can be implemented with any desired parametric representation. For example, the 3D parametric model 120 can be a basis function parametric model, a morphable parametric model, a polynomial parametric model, an explicit parametric surface model, an implicit parametric surface model, a spline-based parametric model, a subdivision surfaces parametric model, an implicit function parametric model (e.g., a neural implicit parametric model), or a skeletal parametric model.

In some implementations, the model parameter vector 35.x.n includes specific types of model parameters that affect the 3D parametric model 120 in distinct ways, e.g., for deformable shape models, morphable models, and character models. A few examples are provided below.

To model objects, each model parameter vector 35.x.n can include: (i) a respective set of geometry parameters representing a respective shape and structure of each object depicted in the respective frame 25.x.n of the source video 20.x; and (ii) a respective set of pose parameters representing a respective position, orientation, and/or scale of each object depicted in the respective frame 25.x.n of the source video 20.x.

To model faces, each model parameter vector 35.x.n can further include a respective set of expression parameters representing a respective expression of each face depicted in the respective frame 25.x.n of the source video 20.x.

To model appearances, each model parameter vector 35.x.n can further include a respective set of appearance parameters representing a respective color, texture, and/or material of each object depicted in the respective frame 25.x.n of the source video 20.x.

The shape reconstruction module 100 is configured to parametrize the 3D parametric model 120, with the source parametrization trajectory 30.x representing the motion sequence, to generate the source animation 40.x of the 3D source mesh 45.x performing the motion sequence. Particularly, the shape reconstruction module 100 parametrizes the 3D parametric model 120, with each model parameter vector 35.x.n representing the respective configuration of the motion sequence, to generate the respective state 45.x.n of the 3D source mesh 45.x in the respective configuration of the motion sequence.

In general, the 3D parametric model ( [symbol] ) 120 defines a mapping from each model parameter vector 35.x.n in the source parametrization trajectory 30.x to the respective state 45.x.n of the 3D source mesh 45.x. This mapping may be linear or nonlinear depending on the representation of the 3D parametric model 120. In any case, the shape reconstruction module 100 provides the source animation 20.x as

$${M}^{x} ( \cdot ) = M [ {θ}^{x} ( \cdot ) ] = [ M [ {θ}_{1}^{x} ] , M [ {θ}_{2}^{x} ] , … , M [ {θ}_{N}^{x} ] ] ,$$

such that the source vertex field of each state 45.x.n is a function of the respective model parameter vector 35.x.n, which defines the structure and geometry of the state 45.x.n, given as:

$${M}_{n}^{x} = M [ {θ}_{n}^{x} ] = ( {V}^{x} , {ε}^{x} , {ℱ}^{x} , {V}_{n}^{x} ) , \qquad ( 3 a )$$

with,

$${V}_{n}^{x} = V [ {θ}_{n}^{x} ] = \{ {v}_{i , n}^{x} \vert i ∈ {V}^{x} \} , {v}_{i , n}^{x} = {v}_{i} [ {θ}_{n}^{x} ] . \qquad ( 3 b )$$

The indices of the source vertices 46.x, connectivity of the source edges 47.x, and topology of the source faces 48.x of each state 45.x.n are typically fixed by the 3D parametric model 120, e.g., to maintain uniformity across the source animation 40.x, but the positions of the source vertices 46.x are state-dependent through the dependance of the source vertex field on the model parameter vector 35.x.n. Typically, the 3D parametric model 120 also defines the source forward direction of the state 45.x.n, given as

$${f}_{n}^{x} = f [ {θ}_{n}^{x} ] .$$

As one example, for a basis function representation of the 3D parametric model 120, the shape reconstruction module 100 can provide a canonical representation of the 3D parametric model 120, where the canonical representation includes: (i) a mean function (V) of the 3D parametric model 120, and (ii) a set of basis functions (B) of the 3D parametric model 120. The mean function represents a mean geometry of the 3D parametric model 120 in terms of a mean vertex field. Each basis function by E B in the set of basis functions represents a respective perturbation (or deformation mode) to the mean geometry. For example, the canonical representation of the 3D parametric model 120 may be derived from dimensionality reduction techniques, such as Principal Component Analysis (“PCA”), Fourier decomposition, or physically-informed basis functions.

In this case, the shape reconstruction module 100 computes a respective basis function term

$$( {U}_{n , l}^{x} )$$

for each model parameter

$${ϑ}_{n , l}^{x} ∈ {θ}_{n}^{x}$$

in the model parameter vector 35.x.n. Each basis function term, given as

$${U}_{n}^{x} = {ϑ}_{n , l}^{x} {b}_{l} ,$$

includes a respective product between: (i) the respective model parameter

$$( {ϑ}_{n , l}^{x} ) ,$$

and (ii) the respective basis function (bₗ). Each basis function term corresponds to a respective deformation to the mean vertex field. The shape reconstruction module 100 then returns the source vertex field for the state 45.x.n as:

$${V}_{n}^{x} = \hat{V} + {\sum }_{l} {U}_{n , l}^{x} . \qquad ( 4 )$$

That is, the source vertex field is a summation including: (i) the mean function (V) of the 3D parametric model 120, and (ii) the respective basis function term

$$( {U}_{n , l}^{x} )$$

for each model parameter in the model parameter vector 35.x.n.

FIG. 6B is a flow diagram of an example process 1100 for converting a source video 20.x into a source animation 40.x of a 3D source mesh 45.x. For convenience, the process 1100 will be described as being performed by a module of a system of one or more computers located in one or more locations. For example, a module, e.g., the shape reconstruction module 100 of FIG. 6A, appropriately programmed in accordance with this specification, can perform the process 1100.

The module 100 provides a 3D parametric model 120 (1110).

The module 100 receives a shape reconstruction input including the source video 20.x including a sequence of frames 25.x.1 to 25.x.N depicting a motion sequence (1120).

The module 100 processes the source video 20.x, using a shape reconstructor neural network 110, to generate a source parametrization trajectory 30.x including a sequence of model parameter vectors 35.x.1 to 35.x.N representing the motion sequence (1130).

The module 100 parametrizes the 3D parametric model 120, with the source parametrization trajectory 30.x, to generate the source animation 40.x including a sequence of states 45.x.1 to 45.x.N of the 3D source mesh 45.x performing the motion sequence (1140).

The module 100 returns a shape reconstruction output including the source animation 40.x of the 3D source mesh 45.x performing the motion sequence (1150).

### B. Examples of Feature Matching Modules

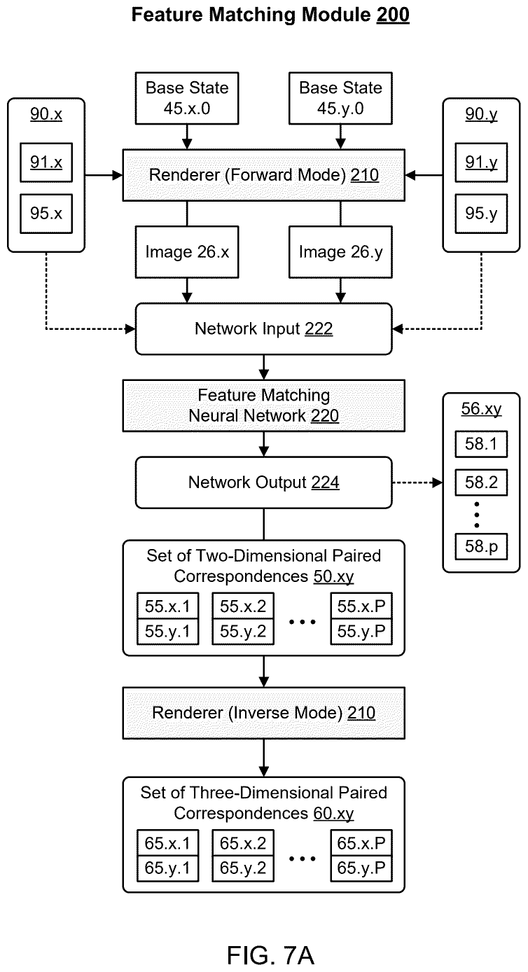

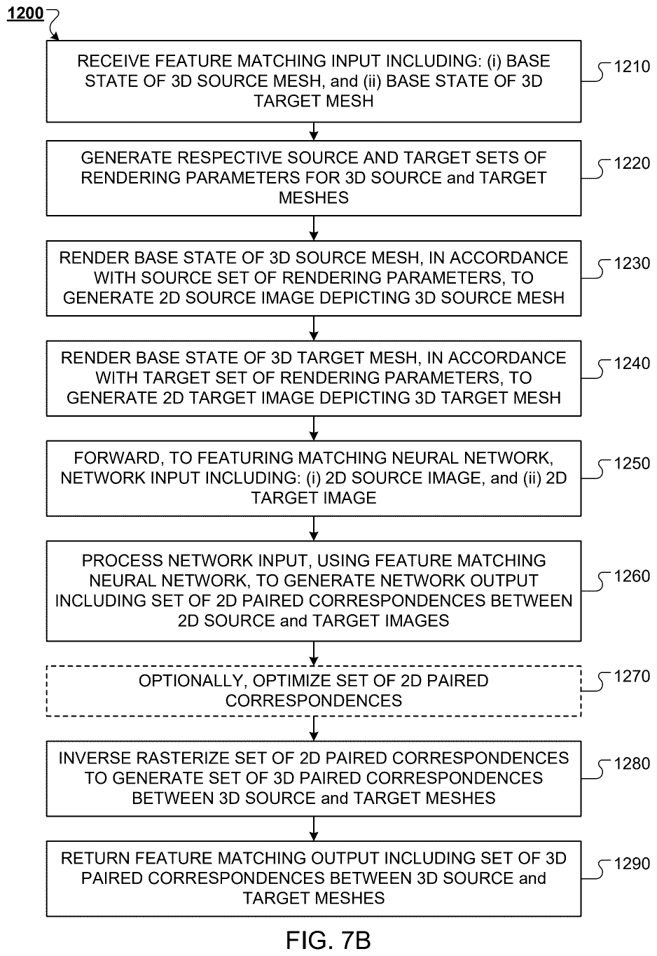

FIG. 7A is a schematic diagram depicting an example of the feature matching module 200 for obtaining the set 60.xy of 3D paired correspondences 65.xy between the 3D source 45.x and target 45.y meshes. The feature matching module 200 includes a renderer 210 and a feature matching neural network 220. The feature matching module 200 is an example of a system implemented as computer programs on one or more computers in one or more locations in which the systems, components, and techniques described below are implemented.

The feature matching module 200 is configured to receive the feature matching input including: (i) the base state 45.x.0 of the 3D source mesh 45.x, and (ii) the base state 45.y.0 of the 3D target mesh 45.y. The feature matching module 200 is configured to process the feature matching input to generate the set 60.xy of 3D paired correspondences 65.xy between the 3D source 45.x and target 45.y meshes. The feature matching module 200 is configured to return the feature matching output including the set 60.xy of 3D paired correspondences 65.xy.

In more detail, the feature matching module 200 implements a 3D-to-2D-to-3D cycle by projecting the base states 45.x.0 and 45.y.0 of the 3D meshes 45.x and 45.y to 2D representations, matching features between the 2D representations, and then inverse-projecting the matched 2D features back to 3D representations. Broadly speaking, the reason for this procedure is because 3D feature matching is more difficult and computationally expensive than 2D feature matching, and training data for 3D feature matching is either limited or unavailable all together. However, training data for 2D feature matching is plentiful comparatively, so the feature matching neural network 220 can be trained to near optimal performance on the feature matching task.

The feature matching module 200 is configured to generate a source set of rendering parameters (σ^{x}) 90.x for the base state 45.x.0 of the 3D source mesh 45.x. The feature matching module 200 is configured to render the base state 45.x.0 of the 3D source mesh 45.x, using the renderer 210 in accordance with the source set of rendering parameters 90.x, to generate a 2D source image (O^{x}) 26.x depicting the 3D source mesh 45.x. The forward operations of the renderer 210 can be represented concisely as

$${O}^{x} = R [ {M}_{0}^{x} ; {σ}^{x} ] ,$$

where the renderer 210 executes a rendering pipeline (R) on the base state 45.x.0 of the 3D source mesh 45.x, in accordance with the source set of rendering parameters 90.x, to generate the 2D source image 26.x of the 3D source mesh 45.x.

In general, the 2D source image 26.x is a perspective projection of the 3D source mesh 45.x parametrized by the source set of rendering parameters 90.x. The 2D source image 26.x includes a 2D array of source pixels 28.x. Each source pixel 28.x.q has one or more respective intensity values

$$( {I}_{q}^{x} ) ,$$

a respective pixel position

$$( {p}_{q}^{x} ) ,$$

in the 2D array, and a respective z-depth value

$$( {z}_{q}^{x} ) ,$$

e.g., recorded as metadata. Here, q indexes each source pixel 28.x.q in the 2D source image 26.x. The pixel position is an integer coordinate, and the z-depth value takes values in a range from zero to one. The combination of which provides a discrete pseudo-3D position

$${\tilde{v}}_{q}^{x} = ( {p}_{q}^{x} , {z}_{q}^{x} )$$

for the source pixel 28.x.q.

The feature matching module 200 is configured to generate a target set of rendering parameters (σ^{y}) 90.x for the base state 45.y.0 of the 3D target mesh 45.y. The feature matching module 200 is configured to render the base state 45.y.0 of the 3D target mesh 45.y, using the renderer 210 in accordance with the target set of rendering parameters 90.y, to generate a 2D target image (O^{y}) 26.y depicting the 3D target mesh 45.y. The forward operations of the renderer 210 can be represented concisely as

$${O}^{y} = R [ {\text{?}}_{0}^{y} ; {σ}^{y} ] ,$$

where the renderer 210 executes the rendering pipeline (R) on the base state 45.y.0 of the 3D target mesh 45.y, in accordance with the target set of rendering parameters 90.y, to generate the 2D target image 26.y of the 3D target mesh 45.y.

In general, the 2D target image 26.y is a perspective projection of the 3D target mesh 45.y parametrized by the target set of rendering parameters 90.y. The 2D target image 26.y includes a 2D array of target pixels 28.y. Each target pixel 28.y.q has one or more respective intensity values

$$( {I}_{q}^{y} ) ,$$

a respective pixel position

$$( {p}_{q}^{y} )$$

in the 2D array, and a respective z-depth value

$$( {z}_{q}^{y} ) ,$$

e.g., recorded as metadata. Here, q indexes each target pixel 28.y.q in the 2D target image 26.y. The pixel position is an integer coordinate, and the z-depth value takes values in a range from zero to one. The combination of which provides a discrete pseudo-3D position

$${\tilde{v}}_{q}^{y} = ( {p}_{q}^{y} , {z}_{q}^{y} )$$

target pixel 28.y.q.

How the intensity and z-depth values of a pixel 28.q in a 2D image 26 of a 3D mesh 45 are related to the rendering parameters 90 and the 3D mesh 45 is described in more detail in Sec. II.C. For now, it suffices to say that a z-depth value of Z_{q}=0 or Z_{q}=1 corresponds to the near-field or far-field clipping plane of the perspective projection, respectively. Hence, a pixel 28.q having a z-depth value equal to one is generally a background pixel of the 2D image 26, that is, the pixel 28.q is not associated with a face 48.ijk of the 3D mesh 45. On the other hand, a pixel 28.q having a z-depth value of less than one is generally a foreground pixel of the 2D image 26, that is, the pixel 28.q is associated with a face 48.ijk of the 3D mesh 45, e.g., derived from a fragment of a primitive 48.i′j′k′ representing the face 48.ijk under the perspective projection.

The feature matching module 200 is configured to forward a network input 222 to the feature matching neural network 220, where the network input 222 includes: (i) the 2D source image 26.x of the 3D source mesh 45.x, and (ii) the 2D target image 26.y of the 3D target mesh 45.y. The feature matching module 200 is configured to process the network input 222, using the feature matching neural network 220, to generate a network output 224 including a set (B^{xy}) 50.xy of 2D paired correspondences 55.xy between: (i) the 2D source image 26.x of the 3D source mesh 45.x, and (ii) the 2D target image 26.y of the 3D target mesh 45.y.

In some implementations, the network input 222 further includes the source 90.x and/or target 90.y sets of rendering parameters. In these cases, the feature matching neural network 220 is conditioned on the source 90.x and/or target 90.y sets of rendering parameters when processing the 2D source 26.x and target 26.y images. This allows the feature matching neural network 220 to process information relating to the rendering pipeline that is not available directly from the 2D images 26.x and 26.y. For example, when provided with the sets of rendering parameters 90.x and 90.y, the feature matching neural network 220 may compensate for different views, perspectives, lighting, positions, orientations, and/or scaling of the 3D meshes 45.x and 45.y.

In some implementations, the network output 224 further includes the set 56.xy of confidence matrices 58 between the 3D source 45.x and target 45.y meshes. In these cases, the feature matching neural network 220 also computes the confidence in the set 50.xy of 2D paired correspondences 55.xy it generates.

The featuring matching neural network 220, given as F_{β}, is a parametric machine learning model (e.g., a parametric function) parametrized by a set of network parameters (B). The set of network parameters include the respective learnable parameters, e.g., weights and biases, of each neural network layer of the featuring matching neural network 220. In general, the featuring matching neural network 220 has been trained to perform the featuring matching task via a machine learning technique, e.g., a supervised, semi-supervised, or unsupervised learning technique. Examples of training systems 201 for training the featuring matching neural network 220 via supervised learning techniques are described in Sec. IV.B.

The featuring matching neural network 220 is configured to process the network input 222, in accordance with current (e.g., trained and/or optimized) values of its set of network parameters, to generate the network output 224. The operations of the featuring matching neural network 220 can be represented concisely as (B^{xy}, [symbol] )=F_{β}[O^{x}, O^{y}; σ^{x}, σ^{y}], where the set 50.xy of 2D paired correspondences 55.xy (and the set 56.xy of confidence matrices 58 if present in the network input 224) depends on the current values of the set of network parameters (and may be conditioned the source 90.x and/or target 90.y sets of rendering parameters if present in the network input 222).

The feature matching neural network 220 can have any appropriate neural network architecture that enables it to perform its described function, i.e., processing a network input 222 to generate a network output 224 as described above. That is, the feature matching neural network 220 can include any appropriate types of neural network layers (e.g., fully-connected layers, convolutional layers, recurrent layers, attention layers, etc.) in any appropriate numbers (e.g., 5 layers, 25 layers, or 100 layers) and connected in any appropriate configuration (e.g., as a linear sequence of layers, a residual configuration, etc.). For example, the feature matching neural network 220 can be a CNN, a RNN, a hybrid CNN-RNN, an ANN, a GNN, or a Transformer-based neural network such as a ViT neural network.

The set 50.xy of 2D paired correspondences 55.xy establishes a correspondence mapping between the 2D source image 26.x of the 3D source mesh 45.x and the 2D target image 26.x of the 3D target mesh 45.y. For example, if the 2D images 26.x and 26.y depict faces, the set 50.xy of 2D paired correspondences 55.xy can identify eyes, mouth, lips, neck, brow, chin, ears, etc., of the faces. If the 2D images 26.x and 26.y depict animals, the set 50.xy of 2D paired correspondences 55.xy can identify head, legs, tail, fins, etc., of the animals.

The set 50.xy of 2D paired correspondences 55.xy, given as

$${B}^{xy} = {\{ ( {g}_{p}^{x} , {g}_{p}^{y} ) \}}_{p = 1}^{P} ,$$

includes a respective 2D paired correspondence

$$( {g}_{p}^{x} , {g}_{p}^{y} )$$

55.xy.p for each common feature identified in the 2D source 26.x and target 26.y images. Here, p indexes each common feature, and P is the total number of common features identified in the 2D images 26.x and 26.y. For example, the total number of common features can be at least about 1, 2, 3, 4, 5, 6, 7, 8, 9, 10, 15, 20, 25, 50, 100, or more common features, or any range between any two of these values. The total number of common features can be at most about 100, 50, 25, 20, 15, 10, 9, 8, 7, 6, 5, 4, 3, 2, 1, or less common features, or any range between any two of these values.

In general, for each common feature, the respective 2D paired correspondence 55.xy.p includes: (i) a respective 2D source correspondence

$$( {g}_{p}^{x} )$$

55.x.p identifying the common feature in the 2D source image 26.x of the 3D source mesh 45.x, and (ii) a respective 2D target correspondence

$$( {g}_{p}^{y} )$$

55.y.p quenulyng wie common feature in the 2D target image 26.y of the 3D target mesh 45.y. In other words, the 2D paired correspondence 55.xy.p is a pairing of

$${g}_{p}^{y} ⊂ {O}^{y} and {g}_{p}^{y} ⊂ {O}^{y} ,$$

that indicates a respective correspondence mapping exists between them

$${g}_{p}^{x} ↔ {g}_{p}^{y} .$$

Thus, a 2D paired correspondence 55.xy.p and a 3D paired correspondence 65.xy.p are analogous for a common feature but defined between pixels 28.x and 28.y in the 2D paired correspondence 55.xy.p and between vertices 46.x and 46.y in the 3D paired correspondence 65.xy.p.

In some implementations, the feature matching module 200 is configured to optimize the set 50.xy of 2D paired correspondences 55.xy by correcting for errors in the set 50.xy of 2D paired correspondences 55.xy and/or refining the set 50.xy of 2D paired correspondences 55.xy.

To correct for errors in the set 50.xy of 2D paired correspondences 55.xy, the feature matching module 200 (e.g., the renderer 210) can determine whether a source 28.x or target 28.y pixel in a 2D paired correspondence 55.xy has a valid vertex position for a source 46.x or target 46.y vertex in the 3D meshes 45.x and 46.y. If not, the feature matching module 200 removes the source 28.x or target 28.y pixel from the 2D paired correspondence 55.xy. For example, a pixel 28 in the background of a 2D image 26 of a 3D mesh 45 is invalid for a 2D correspondence 55 because the pixel 28 is not associated with a face 48 of the 3D mesh 45.

To refine the set 50.xy of 2D paired correspondences 55.xy, the feature matching module 200 can perform one or more correspondence refinement methods on the set 50.xy of 2D paired correspondences 55.xy. For example, the feature matching module 200 can perform random sample consensus (“RANSAC”) filtering on the set 50.xy of 2D paired correspondences 55.xy which removes outlier (e.g., mismatched) 2D paired correspondences 55.xy.p from the set 50.xy. As another example, the feature matching module 200 can perform a mutual nearest neighbor check (“MNNC”) on the set 50.xy of 2D paired correspondences 55.xy to ensure each 2D paired correspondence 55.xy.p in the set 50.xy is a mutually closest match. As another example, the feature matching module 200 can apply thin-plane spline (“TPS”) warping on the set 50.xy of 2D paired correspondences 55.xy to adjust each 2D paired correspondence 55.xy.p in the set 50.xy for consistency. As another example, the feature matching module 200 can apply an affine transformation optimization on the set 50.xy of 2D paired correspondences 55.xy to ensure each 2D paired correspondence 55.xy.p in the set 50.xy fits a respective affine transformation.

The feature matching module 200 is configured to inverse rasterize the set 50.xy of 2D paired correspondences 55.xy, using the renderer 210, to generate the set 60.xy of 3D paired correspondences 65.xy. The inverse operations of the renderer 210 can be represented concisely as [symbol] =R⁻¹[B^{xy}], where the renderer 210 executes an inverse rasterization operation (R⁻¹) on the set 50.xy of 2D paired correspondences 55.xy to generate the set 60.xy of 3D paired correspondences 65.xy.

In general, for each common feature, the respective 3D paired correspondence 65.xy.p identifying the common feature in the 3D source 45.x and target 45.y meshes is the inverse rasterization of the respective 2D paired correspondence 55.xy.p identifying the common feature in the 2D source 26.x and target 26.y images. That is, the renderer 210 generates the 3D paired correspondence 65.xy.p as:

$$( {f}_{p}^{x} , {f}_{p}^{y} ) = ( {R}^{- 1} [ {g}_{p}^{x} ] , {R}^{- 1} [ {g}_{p}^{y} ] ) , \qquad ( 5 a )$$

where the 3D source correspondence 65.x.p identifying the common feature in the 3D source mesh 45.x is the inverse rasterization of the 2D source correspondence 55.x.p identifying the common feature in the 2D source image 26.x, and the 3D target correspondence 65.y.p identifying the common feature in the 3D target mesh 45.y is the inverse rasterization of the 2D target correspondence 55.y.p identifying the common feature in the 2D target image 26.y.

In some implementations, each source vertex 46.x.i in the 3D source correspondence 65.x.p is mapped from a respective source pixel 28.x.q in the 2D source correspondence 55.x.p, and each target vertex 46.y.i′ in the 3D target correspondence 65.y.p is mapped from a respective target pixel 28.y.q′ in the 2D target correspondence 55.y.p as:

$${f}_{p}^{x} = \{ i ↤ q \vert i ∈ {V}^{x} , q ∈ {g}_{p}^{x} \} , {f}_{p}^{y} = \{ {i}^{′} ↤ {q}^{′} \vert {i}^{′} ∈ {V}^{y} , {q}^{′} ∈ {g}_{p}^{y} \} . \qquad ( 5 b )$$

However, one-to-many mappings from a pixel 28.q in a 2D correspondence 55.p to multiple vertices 46.i, 46.j, or 46.k in a 3D correspondence 65.p are also feasible. In general, when executing the rendering pipeline on a 3D mesh 45 to generate a 2D image 26 of the 3D mesh 45, the renderer 210 associates a pixel 28.q in the 2D image 26 with a face 48.ijk of the 3D mesh 45. The renderer 210 then performs a vertex assignment step upon inverse rasterizing the pixel 28.q to assign the pixel 28.q to one or more of the face 48.ijk's vertices 46.i, 46.j, or 46.k.

Note, the feature matching neural network 220 can compute each confidence score

$$( {s}_{{qq}^{′}}^{p} )$$

in the confidence matrix 58.p as a respective similarity metric between: (i) a feature vector for the respective source pixel 28.x.q in the 2D source correspondence 55.x.p, and (ii) a feature vector for the respective target pixel 28.y.q′ in the 2D target correspondence 55.y.p. For example, the similarity metric can be a cosine similarity, a dot product similarity, an attention-based cross-similarity, or any appropriate similarity metric. The feature vectors for the 2D paired correspondence 55.xy.p can be output from intermediate activations between the neural network layers of the feature matching neural network 220.

For the one-to-one mapping from the 2D paired correspondence 55.xy.p to the 3D paired correspondence 65.xy.p as in Eq. (5b), that is, with i [symbol] q and i′ [symbol] q′, the confidence matrix 58.p for the 2D paired correspondence 55.xy.p can be used directly with the 3D paired correspondence 65.xy.p since the confidence scores transform into each other

$${s}_{qq ′}^{p} = {s}_{{ii}^{′}}^{p} .$$

However, for a one-to-many mapping from the 2D paired correspondence 55.xy.p to the 3D paired correspondence 65.xy.p, that is, with (i, j, k) [symbol] q and (i′, j′, k′) [symbol] q′, each pixel 28.q in a 2D correspondence 55.p is assigned to each vertex 46.i, 46.j, and 46.k of the face 48.ijk associated with the pixel 28.q. Here, the renderer 210 also outputs a respective Barycentric weight

$$\{ {Λ}_{q}^{i} , {Λ}_{q}^{j} , {Λ}_{q}^{k} \}$$

between each vertex 46.i, 46.j, and 46.k and the pixel 28.q as defined in the object space of the 3D mesh 45. In this case, the feature matching neural network 220 can relate the confidence matrix 58.p for the 2D paired correspondence 55.xy.p to one appropriate for the 3D paired correspondence 65.xy.p under a transformation such as

$${s}_{qq ′}^{p} = {\sum }_{{ii}^{′}} {Λ}_{q}^{i} {s}_{{ii}^{′}}^{p} {Λ}_{{q}^{′}}^{{i}^{′}} ,$$

where the Barycentric weights provide the soft assignments for the vertices 46.i, 46.j, and 46.k of the face 48.ijk associated with the pixel 28.q.

In some implementations, the feature matching module 200 performs this above procedure multiple times to generate multiple sets 60.xy of 3D paired correspondences 65.xy (and respective sets 56.xy of confidence matrices 58) and then combines them in the feature matching output. Among other aspects, the sets of rendering parameters 90.x and 90.y define the positions, orientations, and scaling of the base states 45.x.0 and 45.y.0 within the field-of-view 214 of a camera 212. Thus, the feature matching module 200 can specify multiple sets of rendering parameters 90.x and 90.y that each define a respective view of the base states 45.x.0 and 45.y.0 relative to the camera 212, e.g., a front view, back view, top view, bottom view, right view, and/or a left view, to capture the 3D paired correspondences 65.xy about each side of the 3D meshes 45.x and 45.y. For example, this allows the feature matching module 200 to collect 3D paired correspondences 65.xy that may be occluded in the 2D images 26.x and 26.y for a single view of the 3D meshes 45.x and 45.y.

FIG. 7B is a flow diagram of an example process 1200 for obtaining a set 60.xy of 3D paired correspondences 65.y between: (i) a 3D source mesh 45.x, and (ii) a 3D target mesh 45.y. For convenience, the process 1200 will be described as being performed by a module of a system of one or more computers located in one or more locations. For example, a module, e.g., the featuring matching module 200 of FIG. 7A, appropriately programmed in accordance with this specification, can perform the process 1200.

The module 200 receives a feature matching input including: (i) a base state 45.x.0 of the 3D source mesh 45.x, and (ii) a base state 45.y.0 of the 3D target mesh 45.y (1210).

The module 200 generates a source set of rendering parameters 90.x for the base state 45.x.0 of the 3D source mesh 45.x, and a target set of rendering parameters 90.y for the base state 45.y.0 of the 3D target mesh 45.y (1220).

The module 200 renders the base state 45.x.0 of the 3D source mesh 45.x, using the renderer 210 in accordance with the source set of rendering parameters 90.x, to generate a 2D source image 26.x depicting the 3D source mesh 45.x (1230).

The module 200 renders the base state 45.y.0 of the 3D target mesh 45.y, using the renderer 210 in accordance with the target set of rendering parameters 90.y, to generate a 2D target image 26.y depicting the 3D target mesh 45.y (1240).

The module 200 forwards, to the feature matching neural network 220, a network input 222 including: (i) the 2D source image 26.x of the 3D source mesh 45.x, and (ii) the 2D target image 26.y of the 3D target mesh 45.y (1250). In some implementations of the process 1200, the network input 222 further includes the source 90.x and target 90.y sets of rendering parameters.

The module 200 processes the network input 222, using a feature matching neural network 220, to generate a network output 224 including a set 50.xy of 2D paired correspondences 55.xy between: (i) the 2D source image 26.x of the 3D source mesh 45.x, and (ii) the 2D target image 26.x of the 3D target mesh 45.y (1260). In some implementations of the process 1200, the network output 224 further includes a set 56.xy of confidence matrices 58 between the 3D source 45.x and target 45.y meshes.

The module 200, optionally, optimizes the set 50.xy of 2D paired correspondences 55.xy by correcting for errors in the set 50.xy of 2D paired correspondences 55.xy and/or refining the set 50.xy of 2D paired correspondences 55.xy (1270).

The module 200 inverse rasterizes the set 50.xy of 2D paired correspondences 55.xy to generate the set 60.xy of 3D paired correspondences 65.y between the 3D source 45.x and target 45.y meshes (1280).

The module 200 returns a feature matching output including the set 60.xy of 3D paired correspondences 65.y between the 3D source 45.x and target 45.y meshes (1290). In some implementations of the process 1200, the feature matching output further includes the set 56.xy of confidence matrices 58 between the 3D source 45.x and target 45.y meshes.

### C. Examples of Renderers

This section provides examples of the renderer 210 for executing the rendering pipeline on a 3D mesh ( [symbol] ) 45, in accordance with a set of rendering parameters (σ) 90 for the 3D mesh 45. The 3D mesh 45 can be any 3D mesh or any state thereof. For example, the 3D mesh 45 can be the base state

$$( {\text{?}}_{0}^{x} )$$

45.x.0 of the 3D source mesh 45.x or the base state

$$( {\text{?}}_{0}^{y} )$$

45.y.0 or the 3D target mesh 45.y, and the set of rendering parameters 90 can the source set of rendering parameters (σ^{x}) 90.x or the target set of rendering parameters (σ^{y}) 90.y. For brevity, the examples of the renderer 210 will be described with respect to the generic 3D mesh 45.

### 1. Examples of Rendering Parameters

In general, the set of rendering parameters 90 for the 3D mesh 45, given as σ={K, L}, includes: (i) a set of transformation matrices (K) 91 for the 3D mesh 45, and (ii) a lighting model (L) 95 for the 3D mesh 45.

The set of transformation matrices 91 defines a mapping from the object space of the 3D mesh 45 to a screen space. The screen space is a 2D space augmented with a z-depth value, e.g., providing a pseudo-3D space in combination. The set of transformation matrices 91, given as K={M, V, P, G}, includes a model matrix 92.M for the 3D mesh 45, a view matrix 92.V for a camera 212, a projection matrix 92.P for the camera 212's field-of-view (“FoV”) 214, and a viewport matrix 92.G for the screen space.

Each of the model matrix 92.M, view matrix 92.V, projection matrix 92.P, and viewport matrix 92.G can be defined in terms of four-dimensional (“4D”) homogenous coordinates v=[v, w], such that each matrix 92.M, 92.V, 92.P, and 92.G is a respective 4-by-4 matrix. Here, v is a 3D or puesdo-3D position of a vertex 46, and w is the homogenous component of the position. The homogeneous component is w=1 for normal coordinates (e.g., positions in the object and world spaces), and w≠1 allows for perspective transformations (e.g., positions in the clip space). The world space is a global coordinate system defined by three mutually orthogonal world directions, including a world right direction r^{w}=(1,0,0), a world up direction u^{w}=(0,1,0), and a world forward direction f^{w}=(0,0,1).

The model matrix 92.M defines a linear transformation from the object space of the 3D mesh 45 to the world space. The model matrix 92.M, given as M=TRS, includes a matrix product between a translation matrix (T), a rotation matrix (R), and a scaling matrix(S), which each define a translation, rotation, and scaling, respectively, between the object space of the 3D mesh 45 and the world space. Examples of the translation, rotation, and scaling matrices of the model matrix 92.M for mapping from the object space of the 3D mesh 45 to the world space are described below.

The translation matrix, given as T=T (t), is parametrized by a translation vector (t) for the 3D mesh 45. The feature matching module 200 can compute the translation vector as a negative of a centroid of the 3D mesh 45, that is, t=−v̅. The centroid of the 3D mesh 45, given as

$$\overline{v} = {N}_{v}^{- 1} {\sum }_{i} {v}_{i} ,$$

is a summation including the respective position (vᵢ) of each vertex 46.i, divided by the vertex count (Nᵥ) of the 3D mesh 45. Application of the translation matrix to the 3D mesh 45 translates the position of each vertex 46.i by the translation vector, which places the centroid of the 3D mesh 45 at the origin of the world space.

The rotation matrix, given as R=R(θ, k), is parametrized by a rotation angle (θ) and a rotation axis (k) for the 3D mesh 45. Here, the rotation matrix is defined in terms of a Rodrigues' rotation, but Euler angles, e.g., yaw, pitch, and roll angles, can also be used. The rotation angle, given as θ=cos⁻¹(f·f^{w}), can be computed by the feature matching module 200 as an angle between: (i) the forward direction (f) of the 3D mesh 45, and (ii) the world forward direction (f). The rotation axis, given as k=f×f^{w}, is defined as a vector cross product between the forward direction of the 3D mesh 45 and the world forward direction. Application of the rotation matrix to the 3D mesh 45 rotates the position of each vertex 46 about the rotation axis by the rotation angle, which points the 3D mesh 45 in the world forward direction.

The scaling matrix, given as S=S(s), is parametrized by a (uniform) scaling factor(s) for the 3D mesh 45. The feature matching module 200 can compute the scaling factor as a common scaling factor (s₀) over a maximum dimension of a (e.g., axis-aligned) bounding box of the 3D mesh 45, that is, s=s₀/max(dᵣ, dᵤ, d_{f}), where dᵣ, dᵤ, and d_{f} are respective dimensions of the bounding box along each world direction of the world space. Application of the scaling matrix to the 3D mesh 45 scales the position of each vertex 46 by the scaling factor, which scales the 3D mesh 45 to fit within a normalized bounding box (e.g., a unit bounding box if s₀=1). The scaling factor is a uniform scaling factor along each world direction of the world space so the 3D mesh 45 is scaled proportionally.

In sum, the model matrix 92.M positions the centroid of the 3D mesh 45 at the origin of the world space, aligns the 3D mesh 45 along the world forward direction, and normalizes the 3D mesh 45 to the common scaling factor within a bounding box aligned with the world space.

The view matrix 92.V defines a linear transformation from the world space to a camera space of the camera 212. The camera space is a coordinate system within the world space with the camera 212 at its origin. The view matrix 92.V, given as V=V [r^{c}, u^{c}, f^{c}, v^{c}], is parametrized by a world space position (v^{c}) of the camera 212 within the world space, and three mutually orthogonal camera directions of the camera 212, including a camera right direction (r^{c}), a camera up direction (u^{c}), and a camera forward direction (f^{c}).

The feature matching module 200 can specify the camera forward direction as parallel or anti-parallel to one of the three world directions, which enables six different views of the normalized bounding box at the origin of the world space. Particularly, the feature matching module 200 can initialize the camera forward direction as: (i) the world backward direction f^{c}=−f^{w} for a front view; (ii) the world forward direction f^{c}=f^{w} for a back view; (iii) the world down direction f^{c}=−u^{w} for a top view; (iv) the world up direction f_{c}=u^{w} for a bottom view; (v) the world left direction f_{c}=−r^{w} for a right view; or (vi) the world right direction f^{c}=r^{w} for a left view. Hence, the feature matching module 200 can cycle through each of the six views to image each face of the normalized bounding box around the 3D mesh 45.

The feature matching module 200 can specify the camera right and up directions relative to the camera forward direction. The camera right direction, given as r^{c}=u^{w}×f^{c}, is defined as a vector cross product between: (i) the world up direction, and (ii) the camera forward direction. The camera up direction, given as u^{c}=r^{c}×f^{c}, is defined as a vector cross product between: (i) the camera right direction, and (ii) the camera forward direction. If the camera forward direction is parallel or antiparallel to the world up direction, then the opposite definition can be used u^{c}=r^{w}×f^{c}, and r^{c}=u^{c}×f^{c}.

The feature matching module 200 can specify the world space position of the camera 212 as an offset from the origin of the world space as v^{c}=−d^{c}f^{c}, where de is an optimal camera distance from the origin. In this example, the optimal camera distance is given as d^{c}=s₀p_{v,h}/2, where pᵥ and pₕ are the vertical and horizontal perspective scaling factors of the FoV 214, respectively. Here, the perspective scaling factor is multiplied by half the common scaling factor (s₀), corresponding to half a dimension of the normalized bounding box. In this case, the feature matching module 200 places all of the normalized bounding box within the FoV 214.

The perspective scaling factors are given as p_{v,h}=[tan(θ_{v,h}/2)]⁻¹, where θᵥ and θₕ are the vertical and horizontal angles of the FoV 214, respectively. The aspect ratio (A) of the FoV 214 is given as A=pᵥ/pₕ, which is typically A≥1 for standard (e.g., wide) formats and A<1 for nonstandard (e.g., tall) formats. For example, the feature matching module 200 can initialize the vertical and/or horizontal angles of the FoV 214 in a range from about 15 degrees to 60 degrees, e.g., an angle of about 45 degrees for a balanced perspective that prevents distortion. The feature matching module 200 can initialize the aspect ratio of the FoV 214 as a standard aspect ratio, such as a 16:9, 16:10, 14:9, 1.85:1, 2.40:1, 4:3, 3:2, 5:4, 1:1, or 2.00:1 aspect ratio. For example, the feature matching module 200 can initialize the aspect ratio of the FoV 214 as a 16:9 aspect ratio for high-definition standard format.

The projection matrix 92.P is a perspective projection matrix that defines a linear transformation from the camera space to a clip space. The projection matrix 92.P, given as P=P[pᵥ, pₕ, n, f], is parametrized by the vertical perspective scaling factor (pᵥ) of the FoV 214, the horizontal perspective scaling factor (pₕ) of the FoV 214, a near-field clipping plane (n) of the FoV 214, and a far-field clipping plane (f) of the FoV 214. The near-field clipping plane defines the minimum visible distance from the camera 212, and the far-field clipping plane defines the maximum visible distance from the camera 212. The volume defined within the FoV 214 and the near-field and far-field clipping planes establishes the clip space, e.g., the view frustrum of the camera 212. The feature matching module 200 can initialize the near-field clipping plane in a range from about 0.01 to 1, e.g., a near-field clipping plane of about 0.1 for preventing precision loss while avoiding clipping close objects. The feature matching module 200 can initialize the far-field clipping plane in a range from about 100 to 10,000, e.g., a far-field clipping plane of about 1,000 for covering a large range without reducing depth accuracy. The feature matching module 200 can initialize a ratio (f/n) between the far-field and near-field clippings planes to be less than about 1,000, e.g., to prevent z-depth buffer precision issues.

During rendering, the renderer 210 performs a perspective division transformation from the clip space to a Normalized Device Coordinate (“NDC”) space. The perspective division transformation is a nonlinear transformation corresponding to a division of the clip space position by the homogeneous clip space component. The perspective division transformation is an aspect of the feature matching module 200 that allows the 3D correspondences 65.xy in the 3D meshes 45.x and 45.y to be represented as the 2D correspondences 65.xy in the 2D images 26.x and 26.y of the 3D meshes the 45.x and 45.y, while retaining information relating to depth, perspective, and occlusion the feature matching neural network 220 has been trained to detect.

The viewport matrix 92.G defines a linear transformation from the NDC space to the screen space. The viewport matrix 92.G, given as G=G [n, f, W, H], is parametrized by the near-field clipping plane (n) of the FoV 214, the near-field clipping plane (f) of the FoV 214, a width (W) of a pixel grid 216 positioned within the screen space, and a height (H) of the pixel grid 216. For example, the feature matching module 200 can initialize a ratio (W/H) between the width and height of the pixel grid 216 to the aspect ratio of the FoV 214. The feature matching module 200 can initialize the width and/or height of the pixel grid 216 in a range from about 100 pixels to 5,000 pixels. For example, the feature matching module 200 can initialize the width of the pixel grid 216 as 1,280 pixels and the height of the pixel grid 216 as 720 pixels for high-definition standard format. The width and height of the pixel grid 216 define the total number of pixels on the pixel grid 216 as Q=WH.

The lighting model 95 defines an appearance of the 3D mesh 45 within the world space. The lighting model 95, given as L={v^{l}, f^{l}, J}, includes a world space position (v^{l}) of a light source 218 within the world space, a light forward direction (f^{l}) of the light source 218, and a set of lighting parameters (J) for the light source 218. The set of lighting parameters determine the visual characteristics of illumination, such as shading, reflections, and overall appearance of rendered objects in the 3D mesh 45. The lighting model 95 can be any appropriate lighting model but an empirical lightening model can be particularly fast, efficient, and effective. Examples of empirical lighting models include ambient lighting models, Lambertian (e.g., diffuse) lighting models, specular lighting models, Phong lighting models, Blinn-Phong lighting models, toon (or cell) shading models, and hemispheric lighting models.

In this example, the feature matching module 200 uses a single light source 218 but a multi-light source setup can also be implemented, e.g., including a key light source at 45 degrees from the camera 212, a fill light source opposite the key light source, and a back light source opposite the camera 212. The feature matching module 200 can establish suitable illumination by positioning the light source 218 similarly to the camera 212, but offset to avoid flat lighting. For example, the feature matching module 200 can specify the world space position of the light source 218 in terms of the world space position of the camera 212 as v^{l}=v^{c}+d^{c}[λ_{f}f^{c}+λᵣr^{c}+λᵤu^{c}], where λ_{f}, λᵣ, and λᵤ are respective lighting weights along the camera forward, camera right, and camera up directions, respectively, and de is the optimal camera distance. The light forward direction is given as f^{l}=−v^{l}/|v^{l}|, which points to the origin of the world space. As one example, the feature matching module 200 can initialize the lighting weights as λ_{f}>λᵤ≥λᵣ. As another example, the feature matching module 200 can initialize the lighting weights as λ_{f}=2, λᵤ=1, and λᵣ=0.5 or 0, which is a general use case for soft fill lighting.

As a particular example, the lighting model 95 can be a Phong (or Blinn-Phong) lighting model which includes an ambient lighting model, a Lambertian (e.g., diffuse) lighting model, and a specular lighting model. In this case, the set of lighting parameters, given as J={I, kₐ, k_{d}, kₛ, γ}, includes an intensity (I) of the light source 218, an ambient reflectivity (kₐ), a diffuse reflectivity (k_{d}), a specular reflectivity (kₛ), and a shininess (e.g., glossiness) factor (—y). The feature matching module 200 can initialize the lighting model 95 to enhance feature detection performed by the featuring matching neural network 220. For example, the feature matching module 200 can initialize the intensity of the light source 218 in a range from about 3.0 to 5.0 to boost overall brightness, the ambient reflectivity in a range from about 0.2 to 0.3 to ensure visibility in shadows, the diffuse reflectivity of about 1.0 to maximize surface contrast, the specular reflectivity in a range from about 0.8 to 1.0 to enhance edges and depth cues, and the shininess factor in a range from about 64 to 128 to create sharp highlights.

In some implementations, the set of rendering parameters 90 further includes a respective set of vertex attributes (aᵢ) for each vertex 46.i of the 3D mesh 45. The set of vertex attributes defines the appearance of the vertex 46.i within the world space under the lighting model 95. The set of vertex attributes, given as

$${a}_{i} = \{ {v}_{i p}^{w} {n}_{i}^{w} \} ,$$

includes a respective world space position

$$( {v}_{i}^{w} )$$

of the vertex 46.i within the world space, and a respective world space vertex normal

$$( {n}_{i}^{w} )$$

of the vertex 46.i within the world space. The set of vertex attributes can also include one or more of a respective texture coordinate, vertex color, world space tangent, or world space bitangent of the vertex 46.i, or other vertex attributes. However, for the examples described herein, the renderer 210 implements the lighting model 95 as a geometric lighting model that only depends on the world space position and world space vertex normal of the vertex 46.i. In these cases, the set of vertex attributes can be provided to the renderer 210 or derived by the renderer 210 from the 3D mesh 45 itself (see Sec. II.C.2), allowing the set of rendering parameters 90 to be minimally specified for the 3D mesh 45.

### 2. Examples of Rendering Pipelines

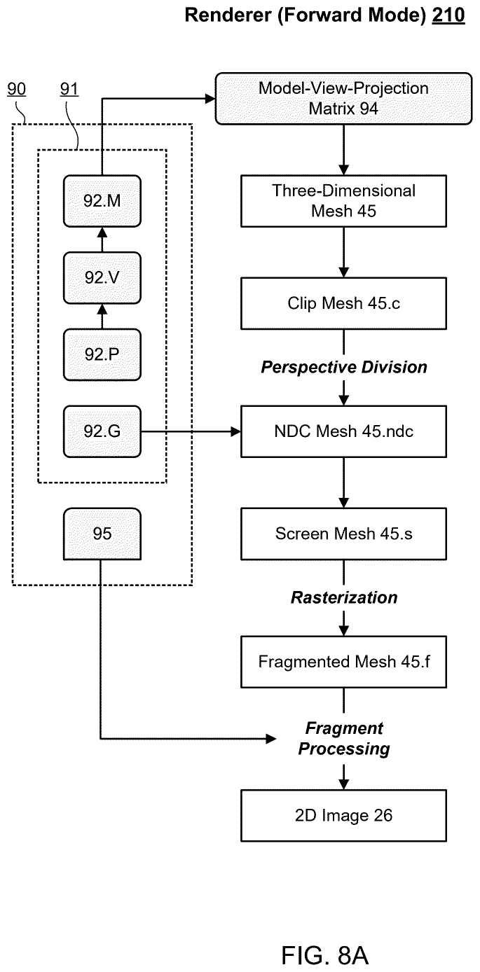

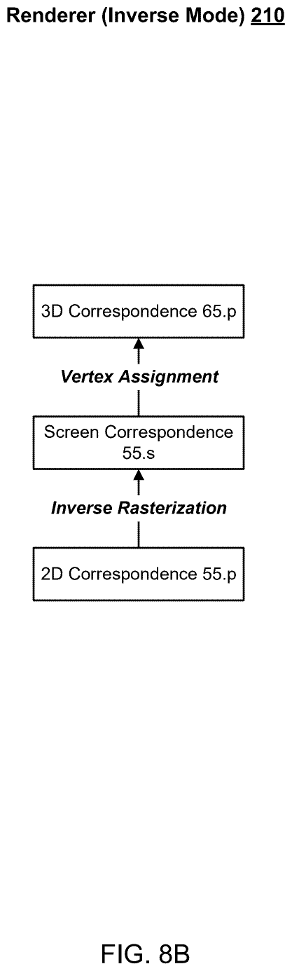

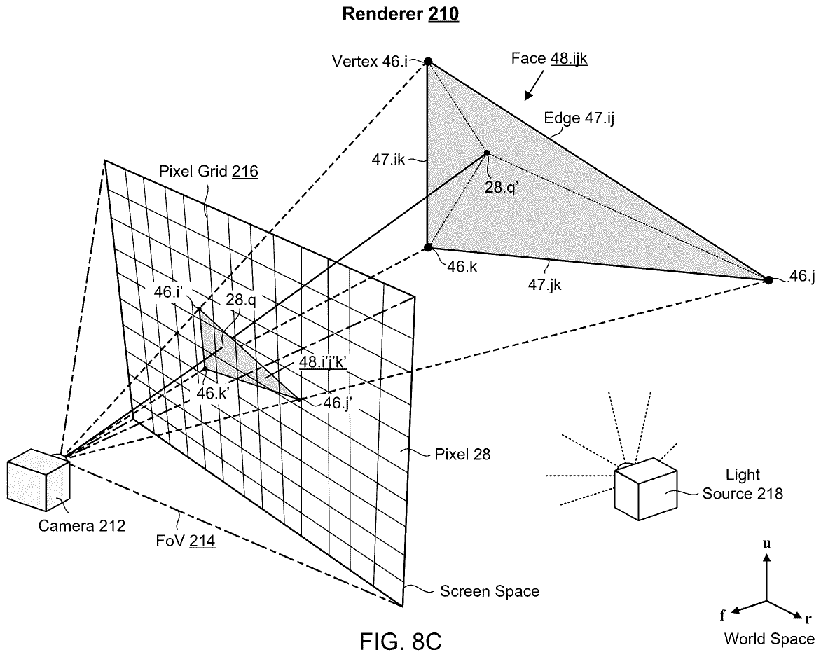

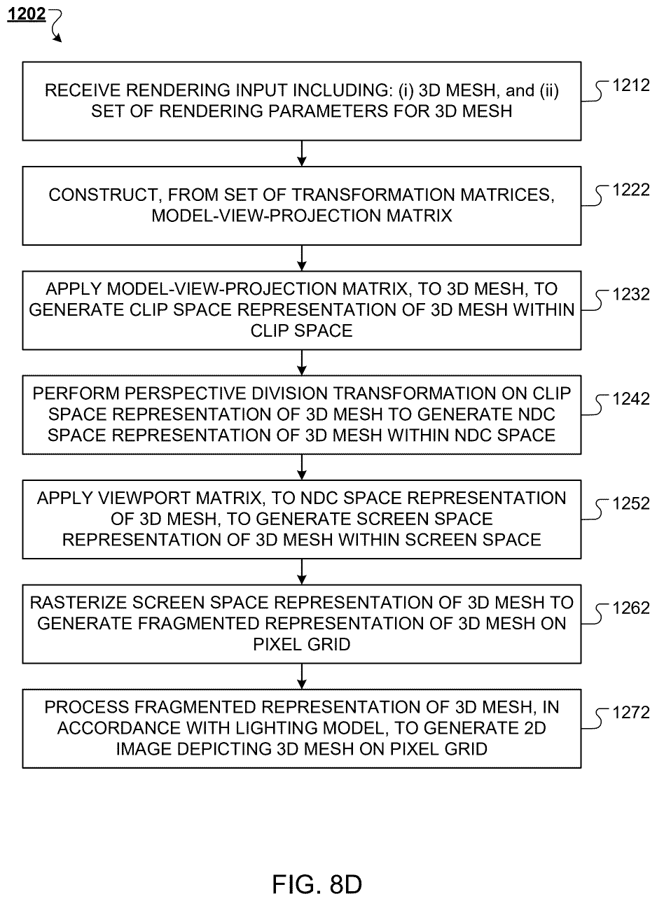

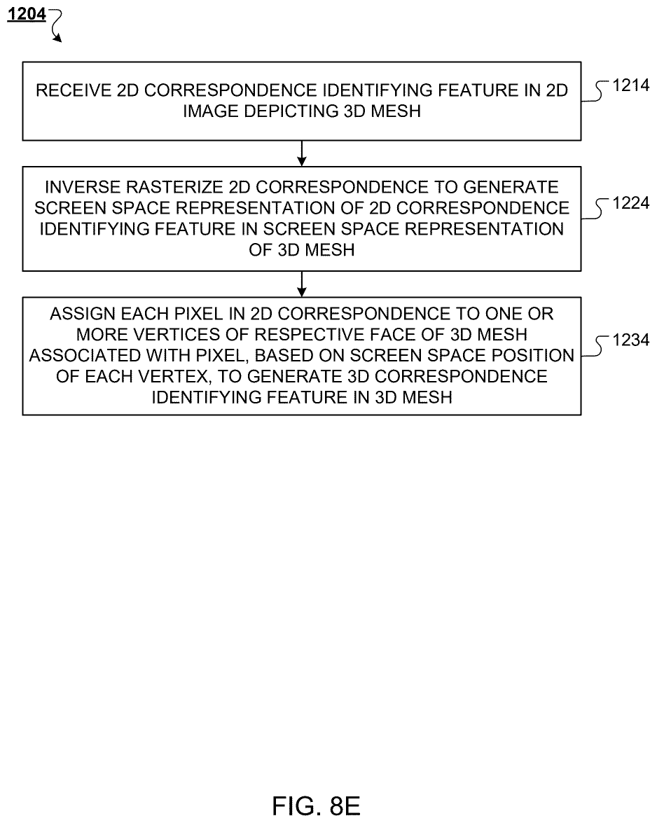

FIG. 8A is a schematic diagram depicting an example of the renderer 210 for executing the rendering pipeline on the 3D mesh 45 to generate a 2D image 26 depicting the 3D mesh 45. The vertex field of the 3D mesh 45 includes a respective object space position (vᵢ) for each vertex 46.i of the 3D mesh 45, defined here in homogenous coordinates as vᵢ=[vᵢ, 1].

The renderer 210 is configured to receive a rendering input including: (i) the 3D mesh 45, and (ii) the set of rendering parameters 90 for the 3D mesh 45. The set of rendering parameters 90 includes the set of transformation matrices 91 for the 3D mesh 45, and the lighting model 95 for the 3D mesh 45. In some implementations, the set of rendering parameters 90 further includes the respective set of vertex attributes for each vertex 46.i of the 3D mesh 45. In other implementations, the renderer 210 derives the set of vertex attributes for the vertex 46.i.

The renderer 210 is configured to construct, from the set of transformation matrices 91, a model-view-projection matrix 94 including a matrix product between the model matrix 92.M, the view matrix 92.V, and the projection matrix 92.P. The model-view-projection matrix 94, given as PVM, defines a mapping from the object space of the 3D mesh 45 to the clip space.

The renderer 210 is configured to apply the model-view-projection matrix 94, to the 3D mesh 45, to generate a clip space representation 45.c of the 3D mesh 45 within the clip space. The vertex field of the clip space representation 45.c includes a respective clip space position

$$( {v}_{i}^{c} )$$

the each vertex 46.i of the 3D mesh 45. The clip space position of the vertex 46.i, given as

$${v}_{i}^{c} = {PVMv}_{i} = [ {v}_{i}^{c} , {w}_{i}^{c} ] ,$$

is defined as a matrix-vector product between: (i) the model-view-projection matrix 94, and (ii) the object space position of the vertex 46.i.

Alternatively, or in addition, the renderer 210 can be configured to apply the model matrix 92.M, the view matrix 92.V, and the projection matrix 92.P sequentially to the 3D mesh 45 to generate the clip space representation 45.c of the 3D mesh 45.

First, the renderer 210 applies the model matrix 92.M, to the 3D mesh 45, to generate a world space representation 45.w of the 3D mesh 45 within the world space. The vertex field of the world space representation 45.w includes a respective world space position

$$( {v}_{i}^{w} )$$

for each vertex 46.i of the 3D mesh 45. The world space position of the vertex 46.i, given as

$${v}_{i}^{w} = {Mv}_{i} = [ {v}_{i}^{w} , 1 ] ,$$

is defined as a matrix-vector product between: (i) the model matrix 92.M, and (ii) the object space position of the vertex 46.i.

In some implementations, the renderer 210 also applies an inverse transpose of the model matrix 92.M's rotation matrix, to the vertex normal field of the 3D mesh 45, to generate the vertex normal field of the world space representation 45.w. The vertex normal field of the world space representation 45.w includes a respective world space vertex normal

$$( {n}_{i}^{w} )$$

for each vertex 46.i of the 3D mesh 45. The world space vertex normal of the vertex 46.i, given as

$${n}_{i}^{w} = {( {R}^{- 1} )}^{T} {n}_{i} = [ {n}_{i}^{w} , 1 ] ,$$

is defined as a matrix-vector product between: (i) the inverse transpose of the rotation matrix, and (ii) the object space vertex normal of the vertex 46.i.

In some implementations, the renderer 210 generates the respective set of vertex attributes for each vertex 46.i of the 3D mesh 45 as

$${a}_{i} = \{ {v}_{i}^{w} , {n}_{i}^{w} \} ,$$

which includes the respective world space position and world space vertex normal for the vertex 46.i derived by the renderer 210.

Next, the renderer 210 applies the view matrix 92.V, to the world space representation 45.w of the 3D mesh 45, to generate a camera space representation 45.cam of the 3D mesh 45 within the camera space. The vertex field of the camera space representation 45.cam includes a respective camera space position

$$( {v}_{i}^{cam} )$$

for each vertex 46.i of the 3D mesh 45. The camera space position of the vertex 46.i, given as

$${v}_{i}^{cam} = {Vv}_{i}^{w} = [ {v}_{i}^{cam} , 1 ] ,$$

is defined as a matrix-vector product between: (i) the view matrix 92.V, and (ii) the world space position of the vertex 46.i.

Last, the renderer 210 applies the projection matrix 92.P, to the camera space representation 45.cam of the 3D mesh 45, to generate the clip space representation 45.c of the 3D mesh 45 within the clip space. Then, the clip space position of each vertex 46.i, given as

$${v}_{i}^{c} = {Pv}_{i}^{cam} ,$$

is defined as a matrix-vector product between: (i) the projection matrix 92.P, and (ii) the camera space position of the vertex 46.i.

The renderer 210 is configured to perform a perspective division transformation on the clip space representation 45.c of the 3D mesh 45 to generate a NDC space representation 45.ndc of the 3D mesh 45 within the NDC space. The vertex field of the NDC space representation 45.ndc includes a respective NDC space position

$$( {v}_{i}^{ndc} )$$

for each vertex 46.i of the 3D mesh 45. The NDC space position of the vertex 46.i, given as

$${v}_{i}^{ndc} = {v}_{i}^{c} / {w}_{i}^{c} = [ {v}_{i}^{ndc} , 1 ] ,$$

is defined as the clip space position of the vertex 46.i divided by the homogeneous component of the clip space position.

The renderer 210 is configured to apply the viewport matrix 92.G, to the NDC space representation 45.ndc of the 3D mesh 45, to generate a screen space representation 45.s of the 3D mesh 45 within the screen space. The vertex field of the screen space representation 45.s includes a respective pseudo-3D position

$$( {v}_{i}^{s} )$$

for each vertex 46.1 of the 3D mesh 45. The pseudo-3D position of the vertex 46.i, given as

$${v}_{i}^{s} = {Gv}_{i}^{ndc} = [ {v}_{i}^{s} , 1 ] ,$$

is defined as a matrix-vector product between: (i) the viewport matrix 92.G, and (ii) the NDC space position of the vertex 46.i. The pseudo-3D position

$${v}_{i}^{s} = ( {\tilde{p}}_{i} , {z}_{i} )$$

includes a screen space position (\tilde{p}ᵢ) for the vertex 46.i within the screen space, and a respective z-depth value (zᵢ) for the vertex 46.i. The z-depth value quantifies where the vertex 46.i is positioned between the near-field and far-field clipping planes.

The renderer 210 is configured to rasterize the screen space representation 45.s of the 3D mesh 45 to generate a fragmented representation 45.f of the 3D mesh 45 on the pixel grid 216. The pixel grid 216 defines a 2D array of pixel positions within the screen space, on which the 3D mesh 45 is projected and discretized. The fragmented representation 45.f includes, for each pixel position on the pixel grid 216, a respective fragment list at the pixel position. The fragment list includes a respective fragment of each primitive 48.i′j′k′ covering the pixel position, where the primitive 48.i′j′k′ represents a respective face 48.ijk of the 3D mesh 45 within the screen space. Note, the fragment list can be empty (e.g., zero) if no primitive 48.i′j′k′ covers the pixel position.

In general, each fragment at the pixel position (Pa) includes a respective z-depth value

$$( {z}_{q}^{f} ) ,$$

and a respective set of fragment attributes

$$( {a}_{q}^{f} ) .$$

Here, the fragments is indexed by (q, f), where q indexes the pixel position on the pixel grid 216, and f=(i, j, k) indexes the respective face 48.ijk of the 3D mesh 45 the fragment is derived from. The z-depth value quantifies where the fragment is positioned between the near-field and far-field clipping planes and is used by the renderer 210 for depth checking. The set of fragment attributes defines an appearance of the fragment within the world space under the lighting model 95. The set of fragment attributes, given as

$${a}_{q}^{f} = \{ {v}_{q}^{f} , {n}_{q}^{f} \} ,$$

includes a respective world space position

$$( {v}_{q}^{f} )$$

for the fragment, and a respective world space vertex normal

$$( {n}_{q}^{f} )$$

for the fragment. The set of fragment attributes can also include one or more of a respective texture coordinate, fragment color, world space tangent, or world space bitangent for the fragment, or other fragment attributes.

An example rasterization and interpolation method that can be performed by the renderer 210 to generate the fragmented representation 45.f of the 3D mesh 45 is described below.

For each face 48.ijk of the 3D mesh 45, the render 210 assembles, from the screen space representation 45.s of the 3D mesh 45, the respective primitive 48.i′j′k′ representing the face 48.ijk within the screen space. The primitive 48.i′j′k′ includes the respective pseudo-3D position

$$\{ {v}_{i}^{s} , {v}_{j}^{s} , {v}_{k}^{s} \}$$

of each of the face 48.ijk's vertices 46.1, 46.j, and 46.k.

Then, at each pixel position on the pixel grid 216, the renderer 210 determines whether the primitive 48.i′j′k′ representing the face 48.ijk covers the pixel position. If the primitive 48.i′j′k′ covers the pixel position, the renderer 210 generates the respective fragment of the primitive 48.i′j′k′ at the pixel position. Particularly, the renderer 210 determines whether the pixel position lies within a respective area of the primitive 48.i′j′k′. The area of the primitive 48.i′j′k′ is defined as the respective area bounded between the respective screen space positions of each of the face 48.ijk's vertices 46.i, 46.j, and 46.k.

For example, to determine whether the pixel position lies within the area of the primitive 48.i′j′k′, the renderer 210 can compute a respective Barycentric weight between the

$$\{ {λ}_{q}^{i} , {λ}_{q}^{j} , {λ}_{q}^{k} \}$$

between the pixel position and the respective screen space position of each of the face 48.ijk's vertices 46.i, 46.j, and 46.k. The renderer 210 computes the Barycentric weights as those satisfying the interpolation equation

$${p}_{q} = {λ}_{q}^{i} {\tilde{p}}_{i} + {λ}_{q}^{j} {\tilde{p}}_{j} + {λ}_{q}^{k} {\tilde{p}}_{k} ,$$

with unit summation

$${λ}_{q}^{i} + {λ}_{q}^{j} + {λ}_{q}^{k} = 1 ,$$

such that the pixel position is equal to a weighted linear combination of the respective screen space positions of each of the face 48.ijk's vertices 46.i, 46.j, and 46.k scaled by their respective Barycentric weights. The renderer 210 then determines whether the respective Barycentric weight of each vertex 46.i, 46.j, and 46.k of the face 48.ijk is between zero and one, such that the weighted linear combination of the screen space positions is a convex combination. If so, the renderer 210 determines that the pixel position lies within the area of the primitive 48.i′j′k′.

Using the Barycentric weights, the renderer 210 can then interpolate the z-depth values and sets of vertex attributes of the face 48.ijk's vertices 46.i, 46.j, and 46.k to generate the respective z-depth value and set of fragment attributes for the fragment of the primitive 48.i′j′k′ at the pixel position. The z-depth value for the fragment, given as

$${z}_{q}^{f} = {λ}_{q}^{i} {z}_{i} + {λ}_{q}^{j} {z}_{j} + {λ}_{q}^{k} {z}_{k} ,$$

includes a weighted linear combination of the respective z-depth values of each of the face 48.ijk's vertices 46.i, 46.j, and 46.k scaled by their respective Barycentric weights. The renderer 210 can perform a perspective-correct interpolation on the sets of vertex attributes to obtain the set of fragment attributes, which normalized for the nonlinear perspective division transformation on the clip space coordinates of the 3D mesh 45. In this case, the set of fragment attributes for the fragment, given as

$${a}_{q}^{f} = {w}_{q}^{f} ( {λ}_{q}^{i} {a}_{i} / {w}_{i} + {λ}_{q}^{j} {a}_{j} / {w}_{j} + {λ}_{q}^{k} {a}_{k} / {w}_{k} ) ,$$

includes a weighted linear combination of the respective set of vertex attributes of each of the face 48.ijk's vertices 46.i, 46.j, and 46.k scaled by their respective Barycentric weights and divided by the homogeneous component of their respective clip space positions. The weighted linear combination is multiplied by an effective homogenous clip space component

$$( {w}_{q}^{f} )$$

for the fragment at the pixel position. An inverse of the effective homogenous clip space component, given as

$$1 / {w}_{q}^{f} = {λ}_{q}^{i} / {w}_{i} + {λ}_{q}^{j} / {w}_{j} + {λ}_{q}^{k} / {w}_{k} ,$$

includes a summation of the respective Barycentric weights of each of the face 48.ijk's vertices 46.i, 46.j, and 46.k divided by the homogeneous component of their respective clip space positions.

Finally, the renderer 210 returns, as the fragmented representation 45.f of the 3D mesh 45 on the pixel grid 216, the respective fragment list at each pixel position on the pixel grid 216.

The renderer 210 is configured to process the fragmented representation 45.f of the 3D mesh 45, in accordance with the lighting model 95, to generate the 2D image 26 depicting the 3D mesh 45 on the pixel grid 216. The 2D image 26 of the 3D mesh 45 includes a 2D array of pixels 28 defined on the pixel grid 216. Each pixel 28.q in the 2D image 26 has one or more respective intensity values (Ia), a respective pixel position (p_{q}) on the pixel grid 216, and a respective z-depth value (Za). The combination of the pixel position and z-depth value provides a discrete pseudo-3D position \tilde{v}_{q}=(p_{q}, z_{q}) for the pixel 28.q. Generally, if the z-depth value is between zero and one, the pixel 28.q is a foreground pixel of the 2D image 26 associated with a face 48.ijk of the 3D mesh 45. If the z-depth value is equal to zero or one, the pixel 28.q is a background pixel of the 2D image 26 unassociated with a face 48 of the 3D mesh 45.

An example fragment shading and z-depth testing method that can be performed by the renderer 210 to generate the 2D image 26 of the 3D mesh 45 is described below.

To begin, the renderer 210 initializes each pixel 28.q on the pixel grid 216 as a background pixel of the 2D image 26. For example, the renderer 210 can initialize the respective intensity value(s) of each pixel 28.q as a default value, e.g., a default value of zero (e.g., black) or a default value of one (e.g., white). The renderer 210 initializes the respective z-depth value of each pixel 28.q as a default value of one, corresponding to the far-field clipping plane.

Then, at each pixel position on the pixel grid 216, the renderer 210 receives the respective fragment list including the respective fragment of each primitive 48.i′j′k′ covering the pixel position. For each primitive 48.i′j′k′ covering the pixel position, the renderer 210 processes the respective fragment of the primitive 48.i′j′k′ at the pixel position, in accordance with the lighting model 95, to generate a respective candidate pixel 28.q.ijk for the primitive 48.i′j′k′ at the pixel position. That is, the renderer 210 generates the intensity value(s)

$$( {I}_{q}^{f} )$$

of the candidate pixel 28.q.ijk by evaluating the lighting model 95 on the set of fragment attributes for the fragment as

$${I}_{q}^{f} = L ( {a}_{q}^{f} ) .$$

The renderer 210 then initializes the z-depth value of the candidate pixel 28.q.ijk as the z-depth value for the fragment.

Assuming the lighting model 95 is a geometric lighting model, the renderer 210 can compute the intensity value(s) of the candidate pixel 28.q.ijk based on the world space position and world space normal for the fragment, the world space positions of the camera 212 and the light source 218, and the set of lighting parameters for the light source 218.

For example, if the lighting model 95 is the Phong (or Blinn-Phong) lighting model mentioned above, with the set of light parameters for the light source 218 given as J={I, kₐ, k_{d}, kₛ, γ}, the renderer 210 can compute the intensity value(s) of the candidate pixel 28.q.ijk according to the Phong reflection model as

$${I}_{q}^{f} = {k}_{a} I + {k}_{d} ( {I}_{q}^{f} \cdot {n}_{q}^{f} ) I + {{k}_{s} ( {r}_{q}^{f} \cdot {c}_{q}^{f} )}^{γ} I ,$$

where

$${I}_{q}^{f} = - {v}_{q}^{f l} / \vert {v}_{q}^{f l} \vert$$

is a light vector for the fragment in the world space,

$${c}_{q}^{f} = - {v}_{q}^{f c} / \vert {v}_{q}^{f c} \vert$$

is a camera vector for the fragment in the world space, and

$${r}_{q}^{f} = 2 ( {1}_{q}^{f} \cdot {n}_{q}^{f} ) {n}_{q}^{f} - {1}_{q}^{f}$$

is a reflection vector for the fragment in the world space. Here,

$${v}_{q}^{fl} = {v}_{q}^{f} - {v}^{l}$$

is a relative position between the world space positions of the fragment and the light source 218, and

$${v}_{q}^{fc} = {v}_{q}^{f} - {v}^{c}$$

is a relative position between the world space positions of the fragment and the camera 212.

The renderer 210 then determines whether the respective candidate pixel 28.q.ijk for the primitive 48.i′j′k′ at the pixel position has a smaller z-depth value than the current pixel 28.q at the pixel position. If so, the renderer 210 updates the current pixel 28.q at the pixel position with the respective candidate pixel 28.q.ijk for the primitive 48.i′j′k′ at the pixel position. The renderer 210 then associates the current pixel 28.q at the pixel position with the respective face 48.ijk of the 3D mesh 45 represented by the primitive 48.i′j′k′.

The renderer 210 can perform this above procedure at each pixel position on the pixel grid 216 in parallel, cycling through the respective fragment of each primitive 48.i′j′k′ covering the pixel position. The final, resulting pixel 28.q at the pixel position corresponds to the respective candidate pixel 28.q.ijk for the primitive 48.i′j′k′ having the smallest respective z-depth value at the pixel position. It is worth mentioning that the renderer 210 can generate the respective fragment of each primitive 48.i′j′k′ at the pixel position and immediately process the fragment to generate the respective candidate pixel 28.q.ijk for the primitive 48.i′j′k′ at the pixel position. In other words, the renderer 210 can process the fragment list at the pixel position as a stream of fragments rather as an accumulated set of fragments, which can significantly speed up the rendering pipeline.

Finally, the renderer 210 returns, as the 2D image 26 depicting the 3D mesh 45 on the pixel grid 216, the respective current pixel 28.q at each pixel position on the pixel grid 216.

FIG. 8B is a schematic diagram depicting an example of the renderer 210 for inverse rasterizing a 2D correspondence 55.p identifying a feature in the 2D image 26 of the 3D mesh 45 to generate a 3D correspondence 65.p identifying the feature in the 3D mesh 45.

The renderer 210 is configured to receive the 2D correspondence 55.p identifying the feature in the 2D image 26 of the 3D mesh 45. The 2D correspondence 55.p includes each pixel 28.q identifying the feature at a respective pixel position on the pixel grid 216.

The renderer 210 is configured to inverse rasterize the 2D correspondence 55.p to generate a screen space representation 55.s of the 2D correspondence 55.p identifying the feature in the screen space representation 45.s of the 3D mesh 45. The screen space representation 55.s includes, for each pixel 28.q in the 2D correspondence 55.p, the respective primitive 48.i′.j′.k′ representing the respective face 48.ijk associated with the pixel 28.q.

To reiterate, the face 48.ijk associated with a pixel 28.q is the face 48.ijk represented by the respective primitive 48.i′.j′.k′ covering the pixel 28.q that has the fragment with the smallest respective z-depth value at the pixel position of the pixel 28.q. If a pixel 28 in the 2D correspondence 55.p is not associated with a face 48 of the 3D mesh 45, e.g., the pixel 28 has a z-depth value equal to one, the renderer 210 removes the pixel 28 from the 2D correspondence 55.p.

To generate the 3D correspondence 65.p in the 3D mesh 45, the renderer 210 assigns each pixel 28.q in the 2D correspondence 55.p to one or more of the vertices 46.i, 46.j, or 46.k of the respective face 48.ijk of the 3D mesh 45 associated with the pixel 28.q. The renderer 210 can use any desired method to assign the pixel 28.q to the vertices 46.i, 46.j, and/or 46.k of the face 48.ijk. A few examples are provided below.

As one example, the renderer 210 can randomly assign the pixel 28.q to one of the vertices 46.i, 46.j, or 46.k of the face 48.ijk.

As another example, the renderer 210 can identify which one of the vertices 46.i, 46.j, or 46.k has the closest respective screen space position to the pixel position of the pixel 28.q. The renderer 210 can determine this by identifying which one of the face 48.ijk's vertices 46.i, 46.j, or 46.k has the largest respective Barycentric weight with the pixel position of the pixel 28.q. The renderer 210 then assigns the pixel 28.q to the respective vertex 46.i, 46.j, or 46.k having the closet respective screen space position to the pixel position of the pixel 28.q.

As another example, the renderer 210 can first unproject the pixel 28.q into the 3D mesh 45 by inverting the discrete pseudo-3D position \tilde{v}_{q}=[\tilde{v}_{q}, 1] of the pixel 28.q. Here, the renderer 210 applies an inverse of the viewport matrix 92.G, to the discrete pseudo-3D position of the pixel 28.q, to generate an NDC space position

$$( {v}_{q}^{ndc} )$$

of the pixel 28.q win the NDC space, given as

$${v}_{q}^{ndc} = {G}^{- 1} {\tilde{v}}_{q} = [ {v}_{q}^{ndc} , 1 ] .$$

The renderer 210 then performs a perspective multiplication transformation on the NDC space position of the pixel 28.q to generate a clip space position

$$( {v}_{q}^{c} )$$

of the pixel 28.q within the clip space. This corresponds to a multiplication of the NDC space position of the pixel 28 with the effective homogenous clip space component

$$( {w}_{q}^{f} )$$

for the fragment that the pixel 28.q is derived from, given as

$${v}_{q}^{c} = {w}_{q}^{f} {v}_{q}^{ndc} = [ {v}_{q}^{c} , {w}_{q}^{f} ] .$$

The renderer 210 then applies an inverse of the model-view-projection 94, to the clip space position of the pixel 28.q, to generate an object space position (Vg) of the pixel 28.q within the object space of the 3D mesh 45, given as

$${v}_{q} = {( PVM )}^{- 1} {v}_{q}^{c} = [ {v}_{q} , 1 ] .$$

The object space position of the pixel 28.q lies within the area of the face 48.ijk. Thus, the renderer 210 can compute a respective Barycentric weight

$$\{ {Λ}_{q}^{i} , {Λ}_{q}^{j} , {Λ}_{q}^{k} \}$$

between the object space position of the pixel 28.q and the respective object space position of each of the face 48.ijk's vertices 46.i, 46.j, and 46.k. The renderer 210 can then assign the pixel 28.q to the vertices 46.i, 46.j, and/or 46.k based on their Barycentric weights within the object space of the 3D mesh 45.

As one example, the renderer 210 can identify which one of the vertices 46.i, 46.j, or 46.k has the closest respective object space position to the object space position of the pixel 28.q. The renderer 210 can determine this by identifying which one of the face 48.ijk's vertices 46.i, 46.j, or 46.k has the largest respective Barycentric weight with the object space position of the pixel 28.q. The renderer 210 then assigns the pixel 28.q to the respective vertex 46.i, 46.j, or 46.k having the closet respective object space position to the object space position of the pixel 28.q.

As another example, the renderer 210 can assign the pixel 28.q to each of the vertices 46.i, 46.j, and 46.k of the face 48.ijk. In this case, the renderer 210 also outputs the respective Barycentric weight of each vertex 46.i, 46.j, and 46.k with the object space position of the pixel 28.q, which provides the soft assignments for the vertex 46 in the 3D correspondence 65.p.

FIG. 8D is a flow diagram of an example process 1202 for rendering a 3D mesh 45 to generate a 2D image 26 depicting the 3D mesh 45. For convenience, the process 1202 will be described as being performed by a system of one or more computers located in one or more locations. For example, a renderer, e.g., the renderer 210 of FIGS. 8A-8C, appropriately programmed in accordance with this specification, can perform the process 1202.

The process 1202 may briefly begin with the renderer 210 initializing a pixel grid 216 within a screen space.

The renderer 210 receives a rendering input including: (i) the 3D mesh 45, and (ii) a set of rendering parameters 90 for the 3D mesh 45 (1212).

The set of rendering parameters 90 includes a set of transformation matrices 91 defining a mapping from an object space of the 3D mesh 45 to the screen space, and a lighting model 95 defining an appearance of the 3D mesh 45 within a world space.

The set of transformation matrices 91 include: (i) a model matrix 92.M defining a mapping from the object space of the 3D mesh 45 to the world space, (ii) a view matrix 92.V defining a mapping from the world space to a camera space, (iii) a projection matrix 92.P defining a mapping from the camera space to a clip space, and (iv) a viewport matrix 92.G defining a mapping from an NDC space to the screen space.

The renderer 210 constructs, from the set of transformation matrices 91, a model-view-projection matrix 94 including a matrix product between: (i) the model matrix 92.M, (ii) the view matrix 92.V, and (iii) the projection matrix 92.P (1222).

The renderer 210 applies the model-view-projection matrix 94, to the 3D mesh 45, to generate a clip space representation 45.c of the 3D mesh 45 within the clip space (1232).

The renderer 210 performs a perspective division transformation on the clip space representation 45.x of the 3D mesh 45 to generate a NDC space representation 45.ndc of the 3D mesh 45 within the NDC space (1242).

The renderer 210 applies the viewport matrix 92.V, to the NDC representation 45.ndc of the 3D mesh 45, to generate a screen space representation 45.s of the 3D mesh 45 within the screen space (1252).

The renderer 210 rasterizes the screen space representation 45.s of the 3D mesh 45 to generate a fragmented representation 45.f of the 3D mesh 45 on the pixel grid 216 (1262).

The renderer 210 processes the fragmented representation 45.f of the 3D mesh 45, in accordance with the lighting model 95, to generate the 2D image 26 depicting the 3D mesh 45 on the pixel grid 216 (1272).

FIG. 8E is a flow diagram of an example process 1204 for inverse rasterizing a 2D correspondence 55.p identifying a feature in the 2D image 26 of the 3D mesh 45 to generate a 3D correspondence 65.p identifying the feature in the 3D mesh 45. For convenience, the process 1204 will be described as being performed by a system of one or more computers located in one or more locations. For example, a renderer, e.g., the renderer 210 of FIGS. 8A-8C, appropriately programmed in accordance with this specification, can perform the process 1204.

The renderer 210 receives the 2D correspondence 55.p identifying the feature in the 2D image 26 of the 3D mesh 45 (1214). The 2D correspondence 55.p includes each pixel 28.q identifying the feature in the 2D image 26 at a respective pixel position on the pixel grid 216.

The renderer 210 inverse rasterizes the 2D correspondence 55.p to generate a screen space representation 55.s of the 2D correspondence 55.p identifying the feature in the screen space representation 45.s of the 3D mesh 45 (1224).

The screen space representation 55.s includes, for each pixel 28.q in the 2D correspondence 55.p, the respective primitive 48.i′j′k′ representing the respective face 48.ijk of the 3D mesh 45 associated with the pixel 28.q. The primitive 48.i′j′k′ includes the respective pseudo-3D position for each vertex 46.i, 46.j, and 46.k of the respective face 48.ijk of the 3D mesh 45 associated with the pixel 28.q, where the pseudo-3D position includes the respective screen space position for the vertex 46 within the screen space, and the respective z-depth value for the vertex 46.

The renderer 210 assigns each pixel 28.q in the 2D correspondence 55.p to one or more vertices 46.i, 46.j, or 46.k of the respective face 48.ijk of the 3D mesh 45 associated with the pixel 28.q, based on the pixel position of the pixel 28.q and the respective screen space position of each vertex 46.i, 46.j, and 46.k, to generate the 3D correspondence 65.p identifying the feature in the 3D mesh 45 (1234).

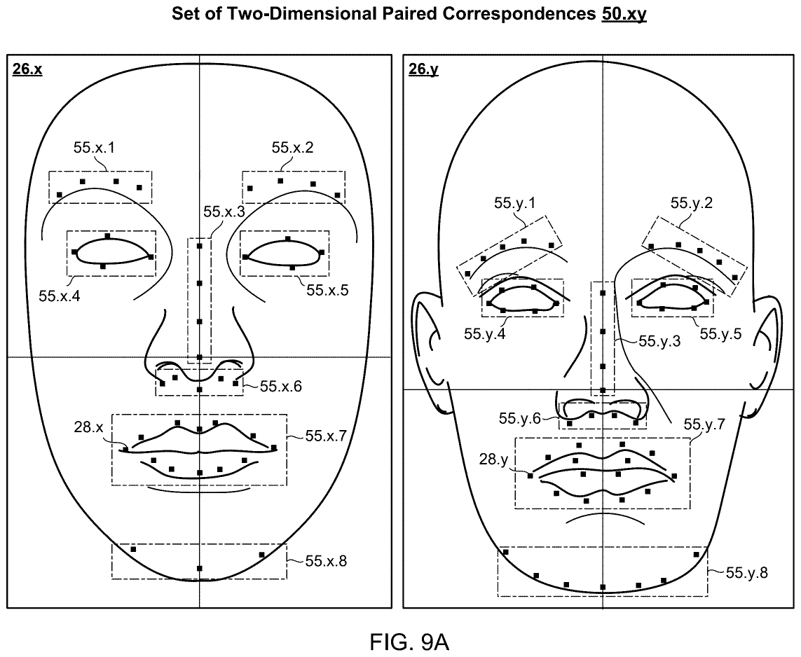

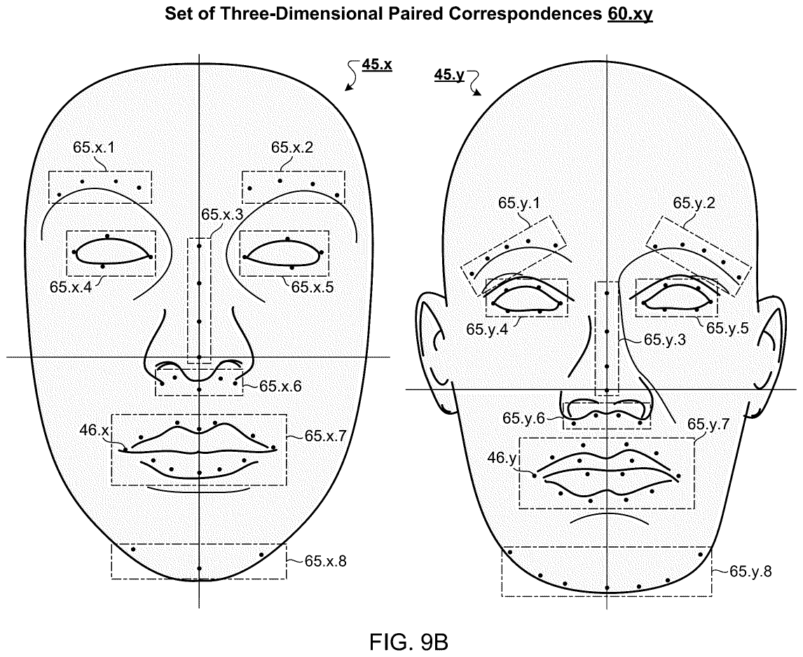

FIGS. 9A and 9B are front views depicting examples of a set 50.xy of 2D paired correspondences 55.xy and a set 60.xy of 3D paired correspondences 65.y for the examples of the 3D source 45.x and target 45.y meshes shown in FIGS. 3A-4D. FIG. 9A shows the set 50.xy of 2D paired correspondences 55.xy between the 2D images 26.x and 26.y of the 3D meshes 45.x and 45.y, and FIG. 9B shows the set 60.xy of 3D paired correspondences 65.xy between the 3D meshes 45.x and 45 themselves. Table 1 below lists the paired features and their corresponding indices in the sets of 2D 50.xy and 3D 60.y paired correspondences. The number of pixels 28 and vertices 46 in each are also tabulated.

TABLE 1
Paired features and indices of the examples of the sets 50.xy and 60.xy
of 2D 55.xy and 3D 65.xy paired correspondences shown in FIGS. 9A and 9B.

| | 2D Paired Correspondence 55.xy | | 3D Paired Correspondence 65.xy | |
|---|---|---|---|---|
| | 2D Source | 2D Target | 3D Source | 3D Target |
| Feature | Corr. 55.x | Corr. 55.y | Corr. 65.x | Corr. 65.y |
| right eyebrow | 55.x.1 [4 px.] | 55.y.1 [5 px.] | 65.x.1 [4 vtx.] | 65.y.1 [5 vtx.] |
| left eyebrow | 55.x.2 [4 px.] | 55.y.2 [5px.] | 65.x.2 [4 vtx.] | 65.y.2 [5 vtx.] |
| nose bridge | 55.x.3 [4 px.] | 55.y.3 [4 px.] | 65.x.3 [4 vtx.] | 65.y.3 [4 vtx.] |
| right eye | 55.x.4 [4 px.] | 55.y.4 [6 px.] | 65.x.4 [4 vtx.] | 65.y.4 [6 vtx.] |
| left eye | 55.x.5 [4 px.] | 55.y.5 [6 px.] | 65.x.5 [4 vtx.] | 65.y.5 [6 vtx.] |
| nostrils | 55.x.6 [5 px.] | 55.y.6 [4 px.] | 65.x.6 [5 vtx.] | 65.y.6 [4 vtx.] |
| mouth | 55.x.7 [12 px.] | 55.y.7 [14 px.] | 65.x.7 [12 vtx.] | 65.y.7 [14 vtx.] |
| chin | 55.x.8 [3 px.] | 55.y.8 [7 px.] | 65.x.8 [3 vtx.] | 65.y.8 [7 vtx.] |

### D. Examples of Deformation Transfer Modules

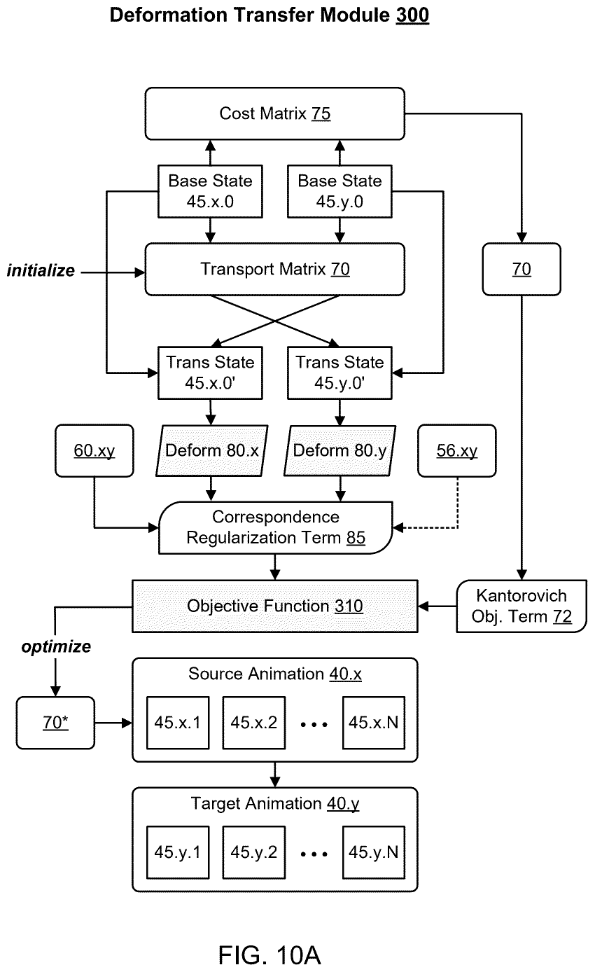

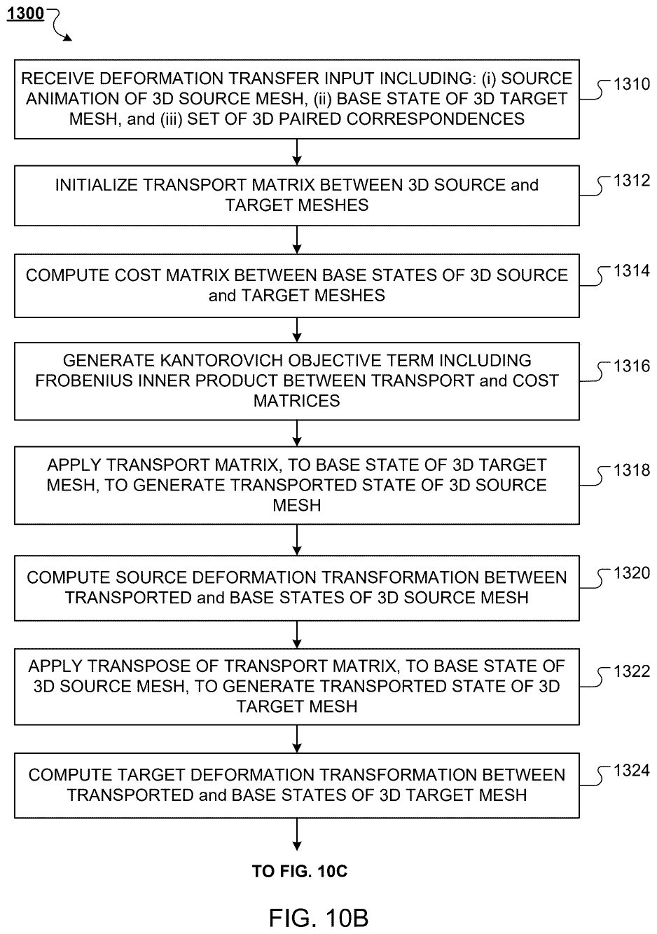

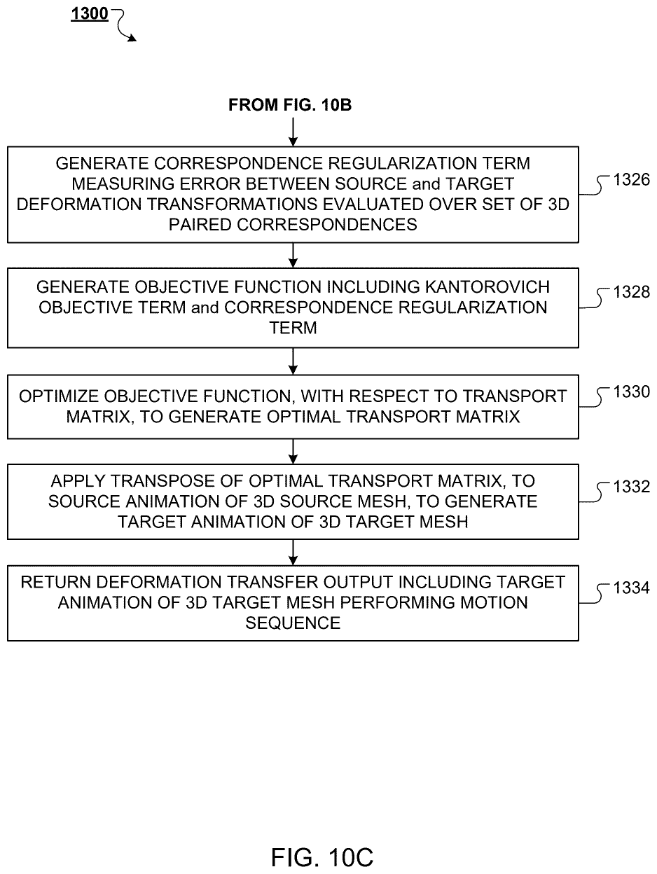

FIG. 10A is a schematic diagram depicting an example of the deformation transfer module 300 for deformation transferring the source animation 40.x of the 3D source mesh 45.x onto the 3D target mesh 45.y. The deformation transfer module 300 is an example of a system implemented as computer programs on one or more computers in one or more locations in which the systems, components, and techniques described below are implemented.

The deformation transfer module 300 is configured to receive the deformation transfer input including: (i) the source animation 40.x of the 3D source mesh 45.x performing the motion sequence, (ii) the base state 45.y.0 of the 3D target mesh 45.y, and (iii) the set 60.xy of 3D paired correspondences 65.xy. The deformation transfer module 300 is configured to process the deformation transfer input to generate the target animation 40.y of the 3D target mesh 45.y performing the motion sequence. The deformation transfer module 300 is configured to return the deformation transfer output including the target animation 40.y of the 3D target mesh 45.y performing the motion sequence.

To do so, the deformation transfer module 300 transfers the deformations exhibited by the 3D source mesh 45.x in the source animation 40.x onto the 3D target mesh 45.y. The deformation transfer module 300 uses the correspondence mappings established by the set 60.xy of 3D paired correspondences 65.xy, e.g., according to probabilistic weights provided by the set 56.xy of confidence matrices 58, to ensure consistency between the 3D meshes 45.x and 45.y while performing the deformation transfer. The deformation transfer is formulated as a regularized optimal transport problem between the 3D meshes 45.x and 45.y, with the set 60.xy of 3D paired correspondences 65.xy providing a (e.g., soft) constraint for regularization. Although the deformation transfer module 300 can implement other types of deformation transfer, this method is particularly fast and efficient while still being highly accurate, e.g., only involving optimization of an objective function 310 once instead of at each timestamp. This enables applications such as high-fidelity streaming and online 2D-to-3D animation conversion that other methods of deformation transfer would be incapable of.

In more detail, the deformation transfer module 300 is configured to initialize a transport matrix (W) 70 between: (i) the 3D source mesh 45.x, and (ii) the 3D target mesh 45.y. Particularly, the transport matrix 70 includes a respective transport weight (wᵢⱼ) between: (i) each source vertex 46.x.i in the 3D source mesh 45.x, and (ii) each target vertex 46.x.j in the 3D target mesh 45.y. For simplicity, it is assumed the transport matrix 70 is normalized such that each row of the transport matrix 70 sums to unity Σⱼwᵢⱼ=1, each column of the transport matrix 70 sums to unity Σᵢwᵢⱼ=1, and each transport weight is greater than or equal to zero wᵢⱼ≥0.

The transport matrix 70 provides a linear deformation map between the 3D source 45.x and target 45.y meshes and is the quantity the deformation transfer module 300 optimizes while constrained by the set 60.xy of 3D paired correspondences 65.xy. Particularly, the deformation transfer module 300 optimizes the transport matrix 70 in a way that deformations at, within, and/or around each 3D paired correspondence 65.xy are matched between the 3D meshes 45.x and 45.y. Here, the deformation transfer module 300 represents a deformation of the 3D meshes 45.x and 45.y as a set of (e.g., local) affine transformations, one for each vertex 46. This representation is convenient because the linear transformation matrix of the affine transformation encodes the change in orientation, scale, and skew induced by the deformation on the vertex 46.

In some implementations, the deformation transfer module 300 first applies the source model matrix 92.M.x to the base state 45.x.0 of the 3D source mesh 45, and the target model matrix 92.M.y to the base state 45.y.0 of the 3D target mesh 45.y. This can translate, rotate, and/or scale the base states 45.x.0 and 45.y.0 within the world space if they are not already aligned with each other in their respective object spaces.

The deformation transfer module 300 is configured to apply the transport matrix 70, to the base state 45.y.0 of the 3D target mesh 45.y, to generate a transported state 45.x.0′ of the 3D source mesh 45.x. The source vertex field

$$( {\hat{V}}_{0}^{x} )$$

of the transported state 45.x.0′, given as

$${\hat{V}}_{0}^{y} = W \cdot {V}_{0}^{y} = \{ {\hat{v}}_{i}^{x} \vert i ∈ {𝒱}^{x} \} ,$$

can be represented as a matrix-vector product between: (i) the transport matrix 70, and (ii) the target vertex field

$$( {V}_{0}^{y} )$$

of the base state 45.y.0. The transported source vertex field includes a respective transported position

$$( {\hat{v}}_{i}^{x} )$$

for each source vertex 46.x.i. The transported positioned, given as

$${\hat{v}}_{i}^{x} = {\sum }_{j} {w}_{ij} {v}_{j}^{y} ,$$

is a weighted linear combination of the respective base positions of each target vertex 46.y.j.

The deformation transfer module 300 is configured to compute a source deformation transformation ( [symbol] ) 80.x between: (i) the transported state 45.x.0′ of the 3D source mesh 45.x, and (ii) the base state 45.x.0 of the 3D source mesh 45.x. The source deformation transformation 80.x includes a respective affine transformation

$$( {T}_{i}^{x} )$$

for each source vertex 46.x.i, which is given as:

$${𝒟}^{x} = \{ {T}_{i}^{x} \vert i ∈ {𝒱}^{x} \} , {T}_{i}^{x} = ( {A}_{i}^{x} , {b}_{i}^{x} ) , \qquad ( 6 a )$$

where the affine transformation includes a respective linear transformation matrix

$$( {A}_{i}^{x} )$$

and a respective translation vector

$$( {b}_{i}^{x} )$$

for the source vertex 40.x.i. For example, using homogenous coordinates for the source vertex 46.x.i, the affine transformation can be represented as a single, affine transformation matrix including the linear transformation matrix and translation vector.

The deformation transfer module 300 computes the affine transformation by considering a local neighborhood

$$( {N}_{i}^{x} )$$

of the source vertex 46.x.i. The local neighborhood includes each other source vertex 46.x.j in the 3D source mesh 45.x that is directly connected to the source vertex 46.x.i by a respective edge 47.x.ij. Thus, the local neighborhood of the source vertex 46.x.i generally includes three or more other source vertices 46.x.j. The deformation transfer module 300 determines the affine transformation for the source vertex 46.x.i as the solution to the following set of equations:

$${\hat{v}}_{i}^{x} = {T}_{i}^{x} ∘ {v}_{i}^{x} = {A}_{i}^{x} {v}_{i}^{x} + {b}_{i}^{x} , \qquad ( 6 b )$$

$$and ,$$

$${\hat{v}}_{i}^{x} = {T}_{i}^{x} ∘ {v}_{i}^{x} = {A}_{i}^{x} {v}_{i}^{x} + {b}_{i}^{x} , j ∈ {N}_{i}^{x} . \qquad ( 6 c )$$

Here, the circle operator (o) represents application of an affine transformation to a base position of a source vertex 46.x, which amounts to a summation of: (i) a matrix-vector product between the linear transformation matrix of the affine transformation and the base position of the source vertex 46.x, and (ii) the translation vector of the affine transformation.

As shown in Eqs. (6b) and (6c), the deformation transfer module 300 specifies the transported position of the source vertex 46.x.i as the application of the affine transformation to its base position, where the affine transformation is defined over the local neighborhood of the source vertex 46.x.i. This means, from the perspective of the source vertex 46.x.i, the source vertex 46.x.i satisfies an affinity with its local neighborhood, that is, the source vertex 46.x.i preserve lines and parallelisms with its local neighborhood, but not necessarily Euclidean distances and angles. The transported source vertex field is then defined in terms of the base source vertex field as

$${V}_{0}^{x} = {𝒟}^{x} {★V}_{0}^{x} = \{ {T}_{i}^{x} ∘ {v}_{i}^{x} \vert i ∈ {𝒱}^{x} \} ,$$

where the star operator (*) represents application of each affine transformation in the source deformation transformation 80.x to the base position of the respective source vertex 46.x.i. Thus, the source deformation transformation 80.x characterizes the relative deformation of the 3D source mesh 45.x under the linear deformation map from the 3D target mesh 45.y.

The deformation transfer module 300 solves for Eqs. (6a)-(6c) by computing two neighborhood matrices: (i) a base neighborhood matrix

$$( {V}_{i}^{x} ) ,$$

and (ii) a transported neighborhood matrix

$$( {\hat{V}}_{i}^{x} ) .$$

Each neighbor matrix is given succinctly as:

$${V}_{i}^{x} = [ … Δ {v}_{ij}^{x} … ] , Δ {v}_{ij}^{x} = {v}_{j}^{x} - {v}_{i}^{x} , j ∈ {N}_{i}^{x} , \qquad ( 6 d )$$

$${V}_{i}^{x} = [ … Δ {v}_{ij}^{x} … ] , Δ {v}_{ij}^{x} = {v}_{j}^{x} - {v}_{i}^{x} , j ∈ {N}_{i}^{x} , \qquad ( 6 d )$$

The base neighborhood matrix includes, for each vertex 46.x.j in the local neighborhood of the source vertex 46.x.i, a respective relative base position

$$( Δ {v}_{ij}^{x} )$$

between: (i) the respective base position of the vertex 46.x.j, and (ii) the base position of the source vertex 46.x.i. Similarly, the transported neighborhood matrix includes, for each vertex 46.x.j in the local neighborhood of the source vertex 46.x.i, a respective relative transported position

$$( Δ {\hat{v}}_{ij}^{x} )$$

between: (i) the respective transported position of the vertex 46.x.j, and (ii) the transported position of the source vertex 46.x.i.

The linear transformation matrix and translation vector of the affine transformation are then output by the deformation transfer module 300 as:

$${A}_{i}^{x} = {{\hat{V}}_{i}^{x} ( {V}_{i}^{x} )}^{T} , {b}_{i}^{x} = {\hat{v}}_{i}^{x} - {A}_{i}^{x} {v}_{i}^{x} , \qquad ( 6 f )$$

which provides the affine transformation in terms of the transported and base positions of the source vertex 46.x.i and its local neighborhood. Particularly, the linear transformation matrix of the affine transformation is a matrix-matrix product between: (i) the transported neighborhood matrix, and (ii) a transpose of the base neighborhood matrix. The translation vector of the affine transformation is a vector difference between: (i) the transported position of the source vertex 46.x.i, and (ii) a matrix-vector product between the linear transformation matrix of the affine transformation and the base position of the source vertex 46.x.i.

The deformation transfer module 300 is configured to apply a transpose of the transport matrix 70, to the base state 45.x.0 of the 3D source mesh 45.x, to generate a transported state 45.y.0′ of the 3D target mesh 45.y. The target vertex field

$$( {\hat{V}}_{0}^{y} )$$

of the transported state 45.y.0′, given as

$${\hat{V}}_{0}^{y} = {W}^{T} \cdot {V}_{0}^{x} = \{ {\hat{v}}_{i}^{y} \vert i ∈ {𝒱}^{y} \} ,$$

can be represented as a matrix-vector product between: (i) the transpose of the transport matrix 70, and (ii) the source vertex field for the base state 45.x.0. The transported target vertex field includes a respective transported position

$$( {\hat{v}}_{i}^{y} )$$

for each target vertex 46.y.i. The transported positioned, given as

$${\hat{v}}_{i}^{y} = {\sum }_{j} {w}_{j i} {v}_{j}^{x} ,$$

is a weighted linear combination of the respective base positions of each source vertex 46.x.j.

The deformation transfer module 300 is configured to compute a target deformation transformation ( [symbol] ) between: (i) the transported state 45.y.0′ of the 3D target mesh 45.y, and (ii) the base state 45.y.0 of the 3D target mesh 45.y. The target deformation transformation 80.y includes a respective affine transformation

$$( {T}_{i}^{x} )$$

of each target vertex 46.y.i, which is given as:

$${𝒟}^{y} = \{ {T}_{i}^{y} \vert i ∈ {𝒱}^{y} \} , {T}_{i}^{y} = ( {A}_{i}^{y} , {b}_{i}^{y} ) , \qquad ( 7 a )$$

where the affine transformation includes a respective linear transformation matrix

$$( {A}_{i}^{y} )$$

and a respective translation vector

$$( {b}_{i}^{y} )$$

for the target vertex 40.y.i. For example, using homogenous coordinates for the target vertex 46.y.i, the affine transformation can be represented as a single, affine transformation matrix including the linear transformation matrix and translation vector.

The deformation transfer module 300 computes the affine transformation by considering a local neighborhood

$$( {N}_{i}^{y} )$$

of the target vertex 46.y.i. The local neighborhood includes each other target vertex 46.y.j in the 3D target mesh 45.y that is directly connected to the target vertex 46.y.i by a respective edge 47.y.ij. Thus, the local neighborhood of the target vertex 46.y.i generally includes three or more other target vertices 46.y.j. The deformation transfer module 300 determines the affine transformation for the target vertex 46.y.i as the solution to the following set of equations:

$${\hat{v}}_{i}^{y} = {T}_{i}^{y} ∘ {v}_{i}^{y} = {A}_{i}^{y} {v}_{i}^{y} + {b}_{i}^{y} , \qquad ( 7 b )$$

$$and ,$$

$${\hat{v}}_{j}^{y} = {T}_{i}^{y} ∘ {v}_{j}^{y} = {A}_{i}^{y} {v}_{j}^{y} + {b}_{i}^{y} , j ∈ {N}_{i}^{y} \qquad ( 7 c )$$

Here, the circle operator (o) represents application of an affine transformation to a base position of a target vertex 46.y, which amounts to a summation of: (i) a matrix-vector product between the linear transformation matrix of the affine transformation and the base position of the target vertex 46.y, and (ii) the translation vector of the affine transformation.

As shown in Eqs. (7b) and (7c), the deformation transfer module 300 specifies the transported position of the target vertex 46.y.i as the application of the affine transformation to its base position, where the affine transformation is defined over the local neighborhood of the target vertex 46.y.i. This means, from the perspective of the target vertex 46.y.i, the target vertex 46.y.i satisfies an affinity with its local neighborhood, that is, the target vertex 46.y.i preserve lines and parallelisms with its local neighborhood, but not necessarily Euclidean distances and angles. The transported target vertex field is then defined in terms of the base target vertex field as

$${\hat{V}}_{0}^{y} = {𝒟}^{y} ★ {V}_{0}^{y} = \{ {T}_{i}^{y} ∘ {v}_{i}^{y} \vert i ∈ {𝒱}^{y} \} ,$$

where the star operator (*) represents application of each affine transformation in the target deformation transformation 80.y to the base position of the respective target vertex 46.y.i. Thus, the target deformation transformation 80.y characterizes the relative deformation of the 3D target mesh 45.y under the linear deformation map from the 3D source mesh 45.x.

The deformation transfer module 300 solves for Eqs. (7a)-(7c) by computing two neighborhood matrices: (i) a base neighborhood matrix

$$( {V}_{i}^{y} ) ,$$

and (ii) a transported neighborhood matrix

$$( {\hat{V}}_{i}^{y} ) .$$

Each neighbor matrix is given succinctly as:

$${V}_{i}^{y} = [ \begin{matrix}… & Δ {v}_{i j}^{y} & …\end{matrix} ] , Δ {v}_{i j}^{y} = {v}_{j}^{y} - {v}_{i}^{y} , j ∈ {N}_{i}^{y} , \qquad ( 7 d )$$

$$and ,$$

$${\hat{V}}_{i}^{x} = [ \begin{matrix}… & Δ {\hat{v}}_{i j}^{y} & …\end{matrix} ] , Δ {\hat{v}}_{i j}^{y} = {\hat{v}}_{j}^{y} - {\hat{v}}_{i}^{y} , j ∈ {N}_{i}^{y} . \qquad ( 7 e )$$

The base neighborhood matrix includes, for each vertex 46.y.j in the local neighborhood of the target vertex 46.y.i, a respective relative base position

$$( Δ {v}_{i j}^{y} )$$

between: (i) the respective base position of the vertex 46.y.j, and (ii) the base position of the target vertex 46.y.i. Similarly, the transported neighborhood matrix includes, for each vertex 46.y.j in the local neighborhood of the target vertex 46.y.i, a respective relative transported position

$$( Δ {\hat{v}}_{i j}^{y} )$$

between: (i) the respective transported position of the vertex 46.y.j, and (ii) the transported position of the target vertex 46.y.i.

The linear transformation matrix and translation vector of the affine transformation are then output by the deformation transfer module 300 as:

$${A}_{i}^{y} = {{\hat{V}}_{i}^{y} ( {V}_{i}^{y} )}^{T} , {b}_{i}^{y} = {\hat{v}}_{i}^{y} - {A}_{i}^{y} {v}_{i}^{y} , \qquad ( 7 f )$$

which provides the affine transformation in terms of the transported and base positions of the target vertex 46.x.i and its local neighborhood. Particularly, the linear transformation matrix of the affine transformation is a matrix-matrix product between: (i) the transported neighborhood matrix, and (ii) a transpose of the base neighborhood matrix. The translation vector of the affine transformation is a vector difference between: (i) the transported position of the target vertex 46.y.i, and (ii) a matrix-vector product between the linear transformation matrix of the affine transformation and the base position of the target vertex 46.y.i.

The deformation transfer module 300 is configured to generate a correspondence regularization term (L) 85 for regularizing the transport matrix 70 over the set 60.xy of 3D paired correspondences 65.xy. In general, the correspondence regularization term 85 is a local regularization term that measures an error between the source 80.x and target 80.y deformation transformations evaluated over the set 60.xy of 3D paired correspondences 65.xy. For example, the deformation transfer module 300 can compute the correspondence regularization term 85 as:

$$L [ W ; {𝒞}^{x y} ] = {\sum }_{p = 1}^{P} {\sum }_{i , j} {s}_{i j}^{p} {‖ {T}_{i}^{x} - {T}_{j}^{y} ‖}^{2} , i ∈ {f}_{p}^{x} , j ∈ {f}_{p}^{y} . \qquad ( 8 a )$$

The norm | . . . | can be any appropriate norm, error, or distance metric, e.g., a Euclidian norm (e.g., a Frobenius norm), a Manhattan norm, or generic LN norm. Here, for each 3D paired correspondences 65.xy, the correspondence regularization term 85 includes a respective error between: (i) the respective affine transformation for each source vertex 46.x.i in the respective 3D source correspondence 65.x.p, and (ii) the respective affine transformation for each target vertex 46.y.j in the respective 3D target correspondence 65.y.p. For further refinement, the deformation transfer module 300 can use the set 56.xy of confidence matrices 58 to generate the correspondence regularization term 85, e.g., to provide respective probabilistic weightings for the errors. Here, each error for the 3D paired correspondence 65.xy.p is multiplied by the respective confidence score

$$( {s}_{i j}^{p} )$$

between: (i) une source vertex 46.x.i in the 3D source correspondence 65.x.p, and (ii) the target vertex 46.y.j in the 3D target correspondence 65.y.p.

Although somewhat hidden, the source 80.x and target 80.y deformation transformations are each functions of the transport matrix 70 through the transported states 45.x.0′ and 45.y.0′ of the 3D meshes 45.x and 45.y. Thus, the correspondence regularization term 85 encourages the transport matrix 70 towards a linear deformation map having high similarity between deformations at the 3D paired correspondences 65.xy.

The deformation transfer module 300 is configured to compute a cost matrix (C) 75 between: (i) the base state 45.x.0 of the 3D source mesh 45.x, and (ii) the base state 45.y.0 of the 3D target mesh 45.y. The cost matrix 75 has the same size as the transport matrix 70. Particularly, the cost matrix 75 includes a respective deformation cost (cᵢⱼ) between: (i) each source vertex 46.x.i in the 3D source mesh 45.x, and (ii) each target vertex 46.x.j in the 3D target mesh 45.y. The deformation cost, given as

$${c}_{i j} = c ( {v}_{i}^{x} , {v}_{j}^{y} ) ,$$

represents the cost (or penalty) of deforming the source vertex 46.x.i into the target vertex 46.y.j, and vice versa. Here, c (.,.) is a cost function that is evaluated on the base positions of the source 46.x.i and target 46.y.j vertices. The cost function can include one or more distance, similarity, or other cost metrics such as a Euclidian distance, a geodesic distance, a Reimann distance, a deformation energy cost, a bending energy cost, or a cosine similarity.

As one example, the deformation cost can be computed by the deformation transfer module 300 as a summation of a first deformation cost term and a second deformation cost term:

$${c}_{i j} = {‖ {v}_{i}^{x} - {v}_{j}^{y} ‖}^{2} + λ {\sum }_{k , l} {( ‖ {v}_{k}^{x} - {v}_{i}^{x} ‖ - ‖ {v}_{l}^{y} - {v}_{j}^{y} ‖ )}^{2} . \qquad ( 8 b )$$

with k ∈

$${N}_{i}^{x}$$

in the local neighborhood of the source vertex 46.x.i, and l ∈

$${N}_{j}^{y}$$

in the local neighborhood of the target vertex 46.y.j. The first deformation cost term in Eq. (8b) includes a distance between: (i) the base position of the source vertex 46.x.i, and (ii) the base position of the target vertex 46.y.j. The first deformation cost term provides global affinities based on absolute distances between the source vertex 46.x.i and the target vertex 46.x.j. The second deformation cost term in Eq. (8b) includes a respective error between: (i) a magnitude of the respective relative base position for each vertex 46.x.k in the local neighborhood of the source vertex 46.x.i, and (ii) a magnitude of the respective relative base position for each vertex 46.x.1 in the local neighborhood of the target vertex 46.x.j. The second deformation cost term provides pairwise affinities based on relative distances between the source vertex 46.x.i and the target vertex 46.x.j within their local neighborhoods. Here, λ≥0 is a penalty parameter that weighs the two deformation cost terms in the deformation cost.

The deformation transfer module 300 is configured to generate a Kantorovich objective term 72 including a Frobenius inner product between: (i) the transport matrix 70, and (ii) the cost matrix 75. The Kantorovich objective term 72 is given as [symbol] W, C [symbol] _{F}=Σᵢⱼwᵢⱼcᵢⱼ, where [symbol] .,. [symbol] _{F} denotes the Frobenius inner product (an elementwise matrix product). Particularly, the Kantorovich objective term 72 includes, for each source 46.x.i and target 46.y.j vertex, a respective product between: (i) the respective transport weight in the transport matrix 70, and (ii) the respective deformation cost in the cost matrix 75. In general, the Kantorovich objective term 72 is the main objective in the optimal transport problem for specifying the linear deformation map between the 3D source 45.x and target 45.y meshes.

The deformation transfer module 300 is configured to generate an objective function (L) 310 including the Kantorovich objective term 72 and the correspondence regularization term 85. The objective function 310 is then given as:

[symbol]

[W]= [symbol] W,C [symbol] _{F}+∧L[W; [symbol] ], (8c)

where ∧>0 is a penalty parameter that weighs the correspondence regularization term 85 against the Kantorovich objective term 72. The deformation transfer module 300 can also add one or more additional regularization terms, e.g., global regularization terms, to the objective function 310. Examples of such regularization terms include as-rigid-as-possible (“ARAP”) regularization terms, sparsity-based regularization terms, volume persevering regularization terms, Laplacian regularization terms, entropy-based (e.g., Sinkhorn) regularization terms, and energy-based (e.g., surface strain or bending) regularization terms.

As a particular example, the objective function 310 can further include an entropy-based (e.g., Sinkhorn) regularization term, given as H[W]=− [symbol] W, log W [symbol] _{F}=−Σᵢⱼwᵢⱼlogwᵢⱼ, which can be interpreted as a Kullback-Leibler (“KL”) divergence of the transport matrix 70. Here, the entropy-based regularization term includes a Frobenius inner product between: (i) the transport matrix 70, and (ii) a negative logarithm of the transport matrix 70. Particularly, the entropy-based regularization term includes, for each source 46.x.i and target 46.y.j vertex, a respective product between: (i) the respective transport weight in the transport matrix 70, and (ii) a negative logarithm of the respective transport weight in the transport matrix 70. The entropy-based regularization term turns the optimal transport problem into a differentiable optimization problem that the deformation transfer module 300 can solve efficiently using iterative updates, e.g., via gradient descent and/or a Sinkhorn-Knopp algorithm. The entropy-based regularization term also encourages denser, less-sparse representations of the transport matrix 70, making the linear deformation map more diffuse.

The deformation transfer module 300 is configured to optimize (e.g., minimize) the objection function 310, with respect to the transport matrix 70,

$${W}^{*} = arg {min}_{W} ℒ [ W ] , \qquad ( 8 d )$$

to generate an optimal transport matrix (W*) 70* between: (i) the 3D source mesh 45.x, and (ii) the 3D target mesh 45.y. Particularly, the optimal transport matrix 70* includes a respective optimal transport weight

$$( {w}_{i j}^{*} )$$

between: (i) each source vertex 46.x.i in the 3D source mesh 45.x, and (ii) each target vertex 46.x.j in the 3D target mesh 45.y. In general, the optimal transport weights provide the optimal assignments between the source 46.x and target 46.y vertices for the (optimal) linear deformation map, with relatively stronger assignments between the source 46.x.p and target 46.y.p features of the 3D paired correspondences 65.xy.p (due to the correspondence regulation term 85 enforcing increased consistency between them).

The deformation transfer module 300 uses an optimization method to optimize the objection function 310. For example, the optimization method can be a gradient descent optimization method, a linear optimization method (e.g., a least squares, weighted least squares, constrained least squares, or convex optimization method), a nonlinear optimization method (e.g., an ARAP, energy-based, or nonlinear least squares optimization method), a Sinkhorn-Knopp algorithm (e.g., entropy-regularized optimal transport), or a spectral optimization method (e.g., a spectral decomposition or functional map optimization method). Examples of gradient descent methods include Implicit updates, Nesterov Accelerated Gradient (“NAG”), Gradient Descent with Momentum, Adam, Root Mean Square Propagation (“RMSProp”), Adaptative Gradient Descent (“AdaGrad”), and AdaDelta.

Note, optimizing the objective function 310 generally refers to the deformation transfer module 300 performing the optimization method over a number of iterations until: (i) the objective function 310 reaches a threshold value, rather than the true optimal (e.g., minimal) value, and/or (ii) a threshold number of iterations have been performed by the deformation transfer module 300. For example, the optimization method performed by the deformation transfer module 300 may be described as an ε-optimality, approximate, or satisficing optimization method. The deformation transfer module 300 can perform any appropriate number of iterations to optimize the objective function 310. For example, the deformation transfer module 300 can perform at least about 100, 1,000, 10,000, 100,000, 1,000,000, or more training iterations, or any range between any two of these values.

The deformation transfer module 300 can also optimize the objection function 310 while subject to one or more (e.g., hard) constraints on the transport matrix 70. For example, to ensure normalization of the optimal transport matrix 70* after and/or during the optimization method, the deformation transfer module 300 can specify a constraint that each row of the transport matrix 70 sums to unity Σⱼwᵢⱼ=1, each column of the transport matrix 70 sums to unity Σᵢwᵢⱼ=1, and each transport weight is greater than or equal to zero wᵢⱼ≥0.

The deformation transfer module 300 is configured to apply a transpose of the optimal transport matrix 70*, to the source animation 40.x of the 3D source mesh 45.x, to generate the target animation 40.y of the 3D target mesh 45.y performing the motion sequence. Particularly, the deformation transfer module 300 applies the transpose of the optimal transport matrix 70* to each state 45.x.n of the 3D source mesh 45.x in the source animation 40.x, to generate the respective state 45.y.n of the 3D target mesh 45.y in the target animation 40.y. This provides the state 45.y.n of the 3D target mesh 45.y as:

$${ℳ}_{n}^{y} = ( {v}^{y} , {ε}^{y} , {ℱ}^{y} , {V}_{n}^{y} ) , \qquad ( 9 a )$$

with,

$${V}_{n}^{y} = {W}^{* ⊤} \cdot {V}_{n}^{x} , {v}_{i , n}^{y} = {\sum }_{j} {w}_{j i}^{*} {v}_{j , n}^{x} , \qquad ( 9 b )$$

such that the target vertex field is deformed from the source vertex field according to the optimal transport matrix 70*. The position of each target vertex 46.y.i is an (optimally) weighted linear combination of the respective positions of each source vertex 46.x.j.

In some implementations, the deformation transfer module 300 first applies the source model matrix 92.M.x to the source animation 40.x of the 3D source mesh 45.x, and subsequently applies the optimal transport matrix 70* to the source animation 40.x to generate the target animation 40.y. The deformation transfer module 300 can then apply an inverse of the target model matrix 92.M.y to the target animation 40.y. This transforms to and from the world space while accounting for translations, rotations, and/or scaling between the 3D meshes 45.x and 45.y that may have occurred to generate the optimal transport matrix 70*.

In some implementations, the deformation transfer module 300 only computes the optimal transport matrix 70* once, such that the objective function 310 is not optimized at each timestamp. Generally, as long as the topologies of the 3D meshes 45.x. and 45.y do not change, the optimal transport matrix 70* does not need to be recomputed by the deformation transfer module 300. Thus, once obtaining the optimal transport matrix 70*, the deformation transfer module 300 can generate each state 45.y.n of the 3D target mesh 45.y in the target animation 40.x either in parallel or sequentially. For the latter case, the deformation transfer module 300 can generate the state 45.y.n of the 3D target mesh 45.y at each timestamp at rates exceeding the framerate of the source video 20.x, enabling applications such as input and output data streaming and online animation conversion, see FIGS. 11-12 for example.

FIGS. 10B-10C are parts of a flow diagram of an example process 1300 for deformation transferring a source animation 40.x of a 3D source mesh 45.x onto a 3D target mesh 45.y. For convenience, the process 1300 will be described as being performed by a module of a system of one or more computers located in one or more locations. For example, a module, e.g., the deformation transfer module 300 of FIG. 10A, appropriately programmed in accordance with this specification, can perform the process 1300.

The module 300 receives a deformation transfer input including: (i) the source animation 40.x including a sequence of states 45.x.1 to 45.x.N of the 3D source mesh 45.x performing a motion sequence, (ii) a base state 45.y.0 of the 3D target mesh 45.y, and (iii) a set 60.xy of 3D paired correspondences 65.xy between the 3D source 45.x and target 45.y meshes (1310). In some implementations of the process 1300, the deformation transfer input further includes a set 56.xy of confidence matrices 58 between the 3D source 45.x and target 45.y meshes.

The module 300 initializes a transport matrix 70 between: (i) the 3D source mesh 45.x, and (ii) the 3D target mesh 45.y (1312).

The module 300 computes a cost matrix 75 between: (i) the base state 45.x.0 of the 3D source mesh 45.x, and (ii) the base state 45.y.0 of the 3D target mesh 45.y (1314).

The module 300 computes a Kantorovich objective term 72 including a Frobenius inner product between: (i) the transport matrix 70, and (ii) the cost matrix 75 (1316).

The module 300 applies the transport matrix 70, to the base state 45.y.0 of the 3D target mesh 45.y, to generate a transported state 45.x.0′ of the 3D source mesh 45.x (1318).

The module 300 computes a source deformation transformation 80.x between: (i) the transported state 45.x.0′ of the 3D source mesh 45.x, and (ii) the base state 45.x.0 of the 3D source mesh 45.x (1320).

The module 300 applies a transpose of the transport matrix 70, to the base state 45.x.0 of the 3D source mesh 45.x, to generate a transported state 45.y.0′ of the 3D target mesh 45.y (1322).

The module 300 computes a target deformation transformation 80.y between: (i) the transported state 45.y.0′ of the 3D target mesh 45.y, and (ii) the base state 45.y.0 of the 3D target mesh 45.y (1324).

The module 300 computes a correspondence regularization term 85 measuring an error between the source 80.x and target 80.y deformation transformations evaluated over the set 60.xy of 3D paired correspondences 65.xy (1326). In some implementations of the process 1300, the source 80.x and target 80.y deformation transformations are evaluated over the set 60.xy of 3D paired correspondences in accordance with the set 56.xy of confidence matrices 58.

The module 300 generates an objective function 310 including the Kantorovich objective term 72 and correspondence regularization term 85 (1328).

The module 300 optimizes the objective function 310, with respect to the transport matrix 70, to generate an optimal transport matrix 70* between: (i) the base state 45.x.0 of the 3D source mesh 45.x, and (ii) the base state 45.y.0 of the 3D target mesh 45.y (1330).

The module 300 applies a transpose of the optimal transport matrix 70*, to the source animation 40.x, to generate a target animation 40.y including a sequence of states 45.x.1 to 45.x.N of the 3D target mesh 45.y performing the motion sequence (1332).

The module 300 returns a deformation transfer output including the target animation 40.y of the 3D target mesh 45.y performing the motion sequence (1334).

### III. Examples of Online Animation Reconstruction Systems

FIG. 11 is a schematic diagram depicting an example implementation of the animation reconstruction system 10 performing high-fidelity online 2D-to-3D animation conversion. Here, the source video 20.x is converted dynamically into the target animation 40.y without requiring offline processing or pre-processing, allowing for input and output data streaming. For example, the source video 20.x can be a source video stream received as input from a motion capture setup, a camera, a mobile phone, or generic client or computing device, and the target animation 40.y can be a target animation stream transmitted as output to a user device.

Here, it is assumed the system 10 has already obtained the optimal transport matrix 70* defining the optimal linear deformation map between the 3D source 45.x and target 45.y meshes. Note, the processes of obtaining the set 60.xy of 3D paired correspondences 65.xy and the optimal transport matrix 70* thereafter may be performed by the system 10 offline. Once obtained, the feature matching module 200 is no longer needed and online animation conversion of the source video 20.x can proceed. For example, the system 10 can bypass the feature matching module 200, place the feature matching module 200 on standby, or deactivate the feature matching module 200 while performing the online animation conversion.

At each timestamp, the system 10 is configured to perform the following operations:

The system 10 is configured to receive the respective frame 25.x.n depicting the respective configuration of the motion sequence.

The system 10 is configured to forward a shape reconstruction input to the shape reconstruction module 100, where the shape reconstruction input includes the respective frame 25.x.n depicting the respective configuration of the motion sequence. The system 10 is configured to process the shape reconstruction input, using the shape reconstruction module 100, to generate a shape reconstruction output including the respective state 45.x.n of the 3D source mesh 45.x in respective configuration of the motion sequence.

The shape reconstruction module 100 is configured to receive the shape reconstruction input including the respective frame 25.x.n depicting the respective configuration of the motion sequence. The shape reconstruction module 100 is configured to process the respective frame 25.x.n, using the shape reconstructor neural network 110, to generate the respective model parameter vector 35.x.n representing the respective configuration of the motion sequence. The shape reconstruction module 100 is configured to parametrize the 3D parametric model 120, with respective model parameter vector 35.x.n, to generate the respective state 45.x.n of the 3D source mesh 45.x in respective configuration of the motion sequence. The shape reconstruction module 100 is configured to return the shape reconstruction output including the respective state 45.x.n of the 3D source mesh 45.x in respective configuration of the motion sequence.

The system 10 is configured to forward a deformation transfer input to the deformation transfer module 300, where the deformation transfer input includes the respective state 45.x.n of the 3D source mesh 45.x in the respective configuration of the motion sequence. The system 10 is configured to process the deformation transfer input, using the deformation transfer module 300, to generate a deformation transfer output including the respective state 45.y.n of the 3D target mesh 45.y in respective configuration of the motion sequence.

The deformation transfer module 300 is configured to receive the deformation transfer input including the respective state 45.x.n of the 3D source mesh 45.x in the respective configuration of the motion sequence. The deformation transfer module 300 is configured to apply the transpose of the optimal transport matrix 70*, to the respective state 45.x.n of the 3D source mesh 45.x, to generate the respective state 45.y.n of the 3D target mesh 45.y in the respective configuration of the motion sequence. The deformation transfer module 300 is configured to return the deformation transfer output including the respective state 45.y.n of the 3D target mesh 45.y in respective configuration of the motion sequence.

In some implementations, the deformation transfer module 300 first applies the source model matrix 92.M.x to the respective state 45.x.n of the 3D source mesh 45.x, and subsequently applies the optimal transport matrix 70* to the state 45.x.n to generate the respective state 45.y.n of the 3D target mesh 45.y. The deformation transfer module 300 can then apply an inverse of the target model matrix 92.M.y to the state 45.y.n. This transforms to and from the world space while accounting for translations, rotations, and/or scaling between the 3D meshes 45.x and 45.y that may have occurred to generate the optimal transport matrix 70*.

The system 10 is configured to transmit the respective state 45.y.n of the 3D target mesh 45.y in the respective configuration of the motion sequence.

The system 10 can perform this process faster than the framerate (f) of the source video 20.x. In these cases, the total number (N) of frames of the source video 20.x may approach N→∞. For example, the source video 20.x can have a total duration of at least about 15 min, 20 min, 25 min, 30 min, 35 min, 40 min, 45 min, 50 min, 55 min, 1 hour (“hr”), 2 hr, 3 hr, 5 hr, 6 hr, 12 hr, 18 hr, 24 hr, or more, or any range between any of these two values.

FIG. 12 is a flow diagram of an example process 1004 for performing high-fidelity online 2D-to-3D animation conversion. For convenience, the process 1004 will be described as being performed by a system of one or more computers located in one or more locations. For example, a system, e.g., the animation reconstruction system 10 of FIG. 11, appropriately programmed in accordance with this specification, can perform the process 1004.

The system 10 receives a source video 20.x including a respective frame 25.x.n of a motion sequence at each of multiple timestamps (1014).

The system 10 obtains an optimal transport matrix 70* between: (i) a 3D source mesh 45.x, and (ii) a 3D target mesh 45.y (1024).

At each timestamp, the system 10 performs operations (1034)-(1084):

The system 10 provides a 3D parametric model 120 (1034).

The system 10 processes the respective frame 25.x.n, using a shape reconstructor neural network 110, to generate a respective model parameter vector 35.x.n representing a respective configuration of the motion sequence (1044).

The system 10 parametrizes the 3D parametric model 120, with the respective model parameter vector 35.x.n, to generate a respective state 45.x.n of the 3D source mesh 45.x in the respective configuration of the motion sequence (1054).

The system 10 applies a transpose of the optimal transport matrix 70*, to the respective state 45.x.n of the 3D source mesh 45.x, to generate a respective state 45.y.n of the 3D target mesh 45.y in the respective configuration of the motion sequence (1064).

The system 10 transmits a target animation 40.y including the respective state 45.x.n of the 3D target mesh 45.y at each of the timestamps (1074).

In some implementations of the process 1004, the source video 20.x is a source video stream, and the target animation 40.y is a target animation stream.

### IV. Examples of Animation Reconstruction Training Systems

This section provides examples of systems and methods for training the shape reconstructor neural network 110 and feature matching neural network 220 to perform their respective shape reconstruction and feature matching tasks.

### A. Examples of Shape Reconstruction Training Systems

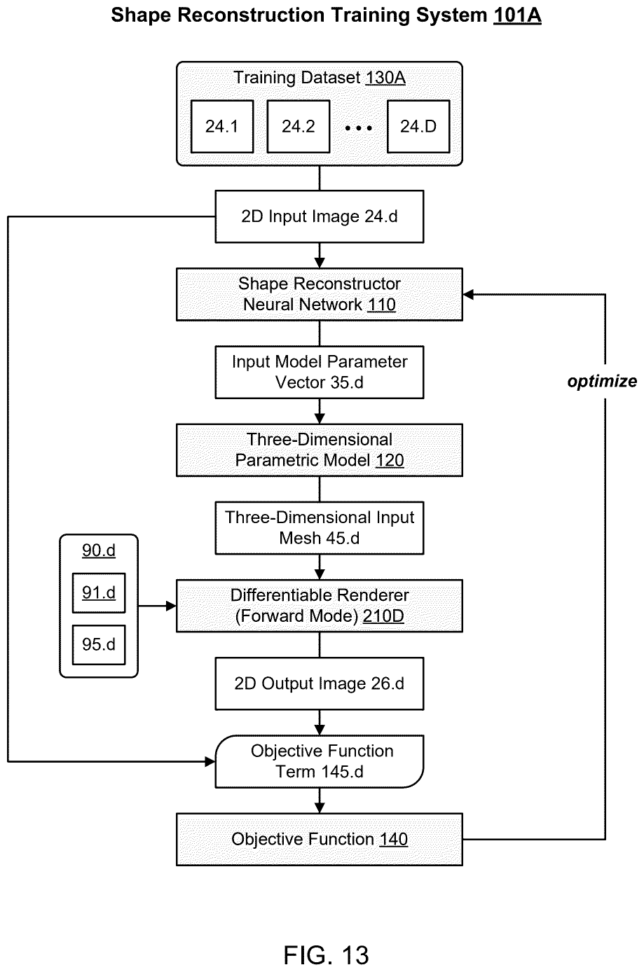

FIG. 13 is a schematic diagram depicting an example of a shape reconstruction training system 101A for training the shape reconstructor neural network 110 to perform the shape reconstruction task. The shape reconstruction training system 101A is an example of a system implemented as computer programs on one or more computers in one or more locations in which the systems, components, and techniques described below are implemented.

The training system 101A includes the 3D parametric model 120 and a differentiable renderer 210D.

The training system 101A is configured receive a training dataset 130A associated with the shape reconstruction task. In this example, the training system 101A is configured to train the shape reconstructor neural network 110 on the training dataset 130A via an unsupervised learning technique. Here, the shape reconstructor neural network 110 can implement element-by-element processing such that it can be efficiently trained on individual (e.g., independent) images 24.

The training system 101A uses the differentiable renderer 210D to facilitate gradient-based training of the shape reconstructor neural network 110. The differentiable renderer 210D executes a rendering pipeline that allows the training system 101A to compute gradients with respect to a desired set of input parameters, such as vertex positions, colors, neural network parameters, and rendering parameters (e.g., transformation parameters, camera parameters, lighting parameters, etc.). Particularly, the differentiable renderer 210B implements a differentiable rasterization method to execute the rendering pipeline. Traditional rasterization is generally non-differentiable as it involves discrete operations (e.g., triangle coverage tests, z-buffering, etc.), making it difficult to compute gradients. The differentiable renderer 210D performs a differentiable rasterization method that approximates these operations in a smooth, differentiable manner. For example, the differentiable renderer 210D can use a soft rasterization (approximate gradients) method, a reparameterization (surrogate gradients) method, or other appropriate differentiable rasterization method.

The training dataset 130A, given as

$${\{ {I}_{d} \}}_{d = 1}^{D} ,$$

includes a set of 2D input images (I_{d}) 24.1 to 24.D each depicting a respective scene. Here, d indexes each 2D input image 24.d in the training dataset 130A, and D is the total number of input images in the training dataset 130A. For example, the training dataset 130A can include at least about 100, 1,000, 10,000, 100,000, 1,000,000, or more 2D input images 24, or any range between any two of these values.

The training dataset 130A is unlabeled as no input image 24.d is paired with a target, e.g., a class label or target image. However, the 2D input images 24 may all depict the same class of object (or scene) to train the shape reconstructor neural network 110 on a specific type of object.

The granularity of the training dataset 130A refers to the level of specificity in the object class, which can be relatively coarse or fine depending on types of objects the shape reconstructor neural network 110 is being trained to reconstruct. For example, for relatively coarse granularity, the 2D input images 24 may all depict one of humans, animals, land vehicles, water vehicles, electronics, furniture, clothing, geological features, water bodies, symbols and signs, or magical artifacts. For relatively fine granularity, the 2D input images 24 may all depict one of Irish men, golden retrievers, sedans, sail boats, digital signal-lens reflex (“DSLR”) cameras, desk chairs, baseball hats, igneous rocks, perennial rivers, currency symbols, or magic wands.

The diversity of the training dataset 130A refers to the level of variation within the object class. For example, to inject diversity into the training dataset 130A, the 2D input images 24 can depict many different variations of the same type of object, as well as multiple views and/or poses of the same object. This can help the shape reconstructor neural network 110 generalize. As a particular example, the 2D input images 24 can depict faces of humans with different face shapes, including eye length, structure of the face (e.g., rounded or long), length of forehead, and nose shape (e.g., hooked, button, or aquiline). The 2D input images 24 can also depict different views and poses of the faces, including front, profile, top-down, and bottom-up view of the faces with different facial expressions, e.g., smiling, frowning, and squinting.

For each 2D input image 24.d in the training dataset 130A, the training system 101A is configured to perform the following functions:

The training system 101A is configured to sample the 2D input image 24.d from the training dataset 130A. For example, the training system 110A can randomly sample the 2D input image 24.d from the training dataset 130A or according to an algorithm.

The training system 101A is configured to process the 2D input image 24.d, using the shape reconstructor neural network 110, to generate a respective input model parameter vector (θ_{d}) 35.d representing the respective scene depicted in the 2D input image 24.d. The operations of the shape reconstructor neural network 110 are represents as θ_{d}(α)=S_{α}[I_{d}], where the input model parameter vector 35.d depends on the current values of the set of network parameters.

The training system 101A is configured to parametrize the 3D parametric model 120, with the input model parameter vector 35.d, to generate a respective 3D input mesh ( [symbol] ) 45.d of the respective scene depicted in the 2D input image 24.d. The 3D parametric model 120 provides a mapping, represented as [symbol] (α)= [symbol] [θ_{d}(α)], from the input model parameter vector 35.d to the 3D input mesh 45.d.

The training system 101A is configured to generate a respective set of input rendering parameters (σ_{d}) 90.d for the 3D input mesh 45.d. The input rendering parameters 90.d, provided as σ_{d}={K_{d}, L_{d}}, include: (i) a respective input set of transformation matrices (K_{d}) 91.d, and (ii) a respective input lighting model (L_{d}) 95.d. The input set of transformation matrices 91.d defines a mapping from a respective object space of the 3D input mesh 45.d to the screen space. The input lighting model 95.d defines an appearance of the 3D input mesh 45.d within the world space.

The input set of transformation matrices 91.d, given as K_{d}={M_{d}, V_{d}, P_{d}, G_{d}}, includes: (i) a respective input model matrix (M_{d}) 92.M.d defining a mapping from the object space of the 3D input mesh 45.d to the world space, (ii) a respective input view matrix (V_{d}) 92.V.d defining a mapping from the object space of the 3D input mesh 45.d to the camera space, (iii) a respective input projection matrix (P_{d}) 92.d defining a mapping from the camera space to the clip space, and (iv) a respective input viewport matrix (G_{d}) 92.d defining a mapping from the NDC space to the screen space.

The training system 101A is configured to differentiabley render the 3D input mesh 45.d, using the differential renderer 210D in accordance with the input set of rendering parameters 90.d, to generate a respective 2D output image (O_{d}) 26.d depicting the 3D input mesh 45.d. The differential renderer 210D renders the 3D input mesh 45.d, O_{d}(α)=R[ [symbol] (α); σ_{d}], in accordance with the input set of rendering parameters 90.d, using the differentiable rasterization method. Note, the 2D output image 26.d is an estimate of the 2D input image 24.d as the training system 101A effectively performs a full 2D-to-3D-to-2D image conversion cycle.

The training system 110A is configured to compute a respective objective function term (L_{d}) 145.d for the 2D input image 24.d based on the 2D output image 26.d. Typically, the objective function term 145.d measures an error between the 2D input image 24.d and the 2D output image 26.d, L_{d}(α)=L[I_{d}, O_{d}(α)], such that the objective function term 145.d encourages the shape reconstructor neural network 110 to generate the input model parameter vector 35.d which minimizes the error between the 2D input 24.d and output 26.d images. For example, the objective function term 145.d can be a mean absolute error, a mean squared error, a Huber Loss, a perpetual loss (e.g., a VGG or ResNet loss), a structural similarity index measure (“SSIM”), or other appropriate pixel-level or perceptual loss.

Upon performing this above procedure, the training system 101A is configured to generate an objective function ( [symbol] ) 140 including the respective objective function term 145.d for each 2D input image 24.d in the training dataset 130A. For example, the objective function 140 can include a summation of the objective function terms 145,

$$ℒ ( α ) = {Σ}_{d = I}^{D} {L}_{d} ( α ) ,$$

such that each 2D input image 24.d is weighted equally. Alternatively, the objective function 140 can be a weighted combination of the objective function terms 145, e.g., a weighted linear combination, such that different input images 24 are emphasized and deemphasized.

The training system 101A is configured to optimize (e.g., minimize) the objection function 140 with respect to the set of network parameters (α) of the shape reconstructor neural network 110:

$${min}_{α} ℒ ( α ) . \qquad ( 10 a )$$

Particularly, the training system 101A is configured to compute a gradient of the objective function 140 with respect to the set of network parameters of the shape reconstructor neural network 110, e.g., using backpropagation, and iteratively update the set of network parameters using the gradient over a number of training iterations. For example, the training system 101A can use a (e.g., stochastic) gradient descent method with a particular learning rate and/or weight decay, such as Implicit updates, Momentum, Adam, RMSProp, AdaGrad, etc., to update the set of network parameters with the values that optimize the objective function 140. The training system 101B can perform any appropriate number of training iterations to optimize the objective function 140. For example, the training system 101B can perform at least about 100, 1,000, 10,000, 100,000, 1,000,000, or more training iterations, or any range between any two of these values.

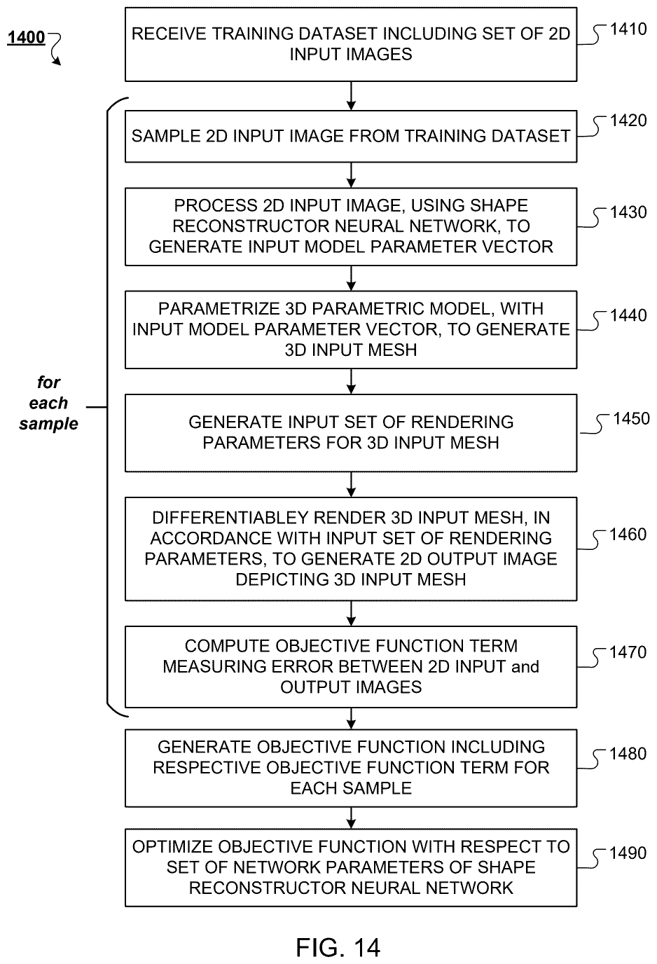

FIG. 14 is a flow diagram of an example process 1400 for training the shape reconstructor neural network 110 to perform the shape reconstruction task. For convenience, the process 1400 will be described as being performed by a system of one or more computers located in one or more locations. For example, a system, e.g., the shape reconstruction training system 101A of FIG. 14, appropriately programmed in accordance with this specification, can perform the process 1400.

The training system 101A receives a training dataset 130A including a set of 2D input images 24.1 to 24.D each depicting a respective scene (1410).

For each input image 24.d in the training dataset 130A, the training system 101A performs operations (1420)-(1460):

The training system 101A samples the 2D input image 24.d from the training dataset 130A (1420).

The training system 101A processes the 2D input image 24.d, using the shape reconstructor neural network 110, to generate a respective input model parameter vector 35.d representing the respective scene depicted in the 2D input image 24.d (1430).

The training system 101A parametrizes the 3D parametric model 120, with the input model parameter vector 35.d, to generate a respective 3D input mesh 45.d of the respective scene depicted in the 2D image 24.d (1440).

The training system 101A generates a respective input set of rendering parameters 90.d for the 3D input mesh 45.d (1450).

The training system 101A differentiabley renders the 3D input mesh 45.d, using the differentiable renderer 210D in accordance with the input set of rendering parameters 90.d, to generate a respective 2D output image 26.d depicting the 3D input mesh 45.d (1460).

The training system 101A computes a respective objective function term 145.d measuring an error between: (i) the 2D input image 24.d, and (ii) the 2D output image 26.d (1470).

The training system 101A generates an objective function 140 including the respective objective function term 145.d for each 2D input image 24.d in the training dataset 130A (1480).

The training system 101A optimizes the objective function 140 with respect to the set of network parameters of the shape reconstructor neural network 110 (1490).

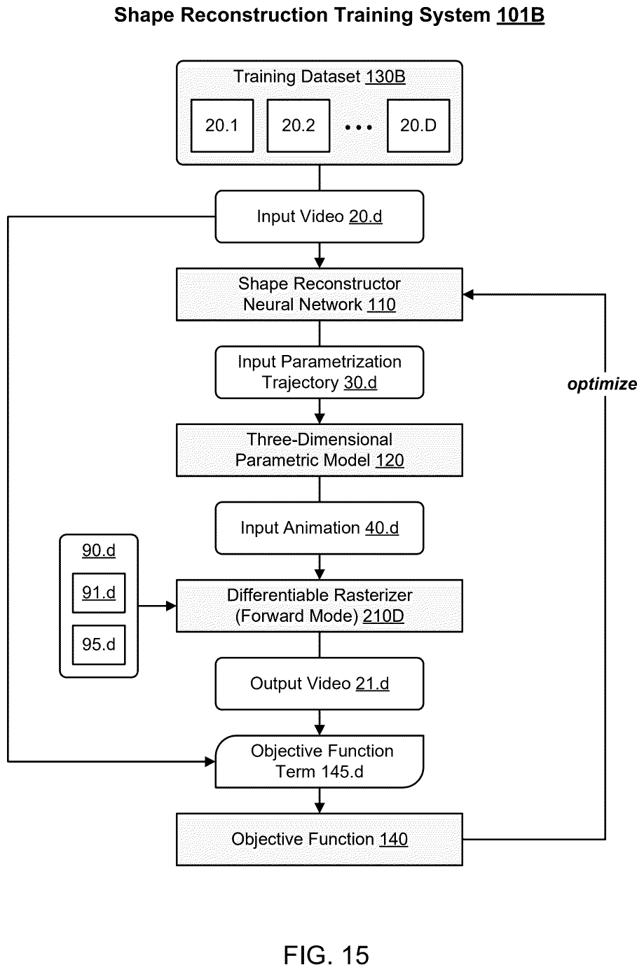

FIG. 15 is a schematic diagram depicting another example of the shape reconstruction training system 101B for training the shape reconstructor neural network 110 to perform the shape reconstruction task. The training system 101B includes the 3D parametric model 120 and the differentiable renderer 210B.

The training system 101B is configured receive a training dataset 130B associated with the shape reconstruction task. In this example, the training system 101B is also configured to train the shape reconstructor neural network 110 on the training dataset 130B via an unsupervised learning technique. However, here the shape reconstructor neural network 110 can implement sequence-by-sequence processing such that it can be trained on entire videos 20.

The training dataset 130B, given as

$${\{ {I}^{d} ( \cdot ) \}}_{d = 1}^{D} ,$$

includes a set of input videos I^{d}(·) 20.1 to 20.D each depicting a respective motion sequence. Here, d indexes each input video 20.d in the training dataset 130B, and D is the total number of input videos in the training dataset 130B. For example, the training dataset 130B can include at least about 100, 1,000, 10,000, 100,000, 1,000,000, or more input videos 20, or any range between any two of these values.

Note, the training dataset 130B is unlabeled as no input video 20.d is paired with a target, e.g., a class label or target video. However, the input videos 20 may all depict motion sequences of the same class of object (or scene) to train the shape reconstructor neural network 110 on motion sequences of a specific type of object.

The granularity of the training dataset 130B refers to the level of specificity in the object class, which can be relatively coarse or fine depending on types of motion sequences and objects the shape reconstructor neural network 110 is being trained to reconstruct. For example, for relatively coarse granularity, the input videos 20 may all depict motion sequences of one of humans, animals, land vehicles, water vehicles, electronics, furniture, clothing, geological features, water bodies, symbols and signs, or magical artifacts. For relatively fine granularity, the input videos 20 may all depict motion sequences of one of Irish men, golden retrievers, sedans, sail boats, DSLR cameras, desk chairs, baseball hats, igneous rocks, perennial rivers, currency symbols, or magic wands.

The diversity of the training dataset 130B refers to the level of variation of motion sequences and objects within the object class. For example, to inject diversity into the training dataset 130B, the input videos 20 can depict many different variations of a motion sequence of the same type of object, as well as multiple views of the motion sequence. This can help the shape reconstructor neural network 110 generalize. As a particular example, the input videos 20 can depict motion sequences of human faces with different face shapes, including eye length, structure of the face (e.g., rounded or long), length of forehead, and nose shape (e.g., hooked, button, or aquiline). The input videos 20 can also depict motion sequences of different views of the faces, including front, profile, top-down, and bottom-up view of the faces with different facial expressions, e.g., smiling, frowning, and squinting.

Each input video 20.d includes a respective sequence of frames 25.d.1 to 25.d.N each depicting a respective configuration of the respective motion sequence. The total number of frames in the input video 20.d may be given as N=fT, where f is the framerate of the input video 20.d, and T is the total duration of the input video 20.d. For example, the input video 20.d can have a framerate of at least about 1, 5, 10, 15, 20, 24, 25, 30, 35, 40, 45, 48, 50, 55, 60, 90, 120, 150, 180, 210, 240, 480, 960 fps, or more, or any range between any of two these values. The input video 20.d can have a total duration of at least about 1 sec, 5 sec, 10 sec, 15 sec, 20 sec, 25 sec, 30 sec, 35 sec, 40 sec, 45 sec, 50 sec, 55 sec, 1 min, 2 min, 3 min, 4 min, 5 min, 6 min, 7 min, 8 min, 9 min, 10 min, 15 min, or more, or any range between any of two these values.

For each input video 20.d in the training dataset 130B, the training system 110B is configured to perform the following functions:

The training system 101B is configured to sample the input video 20.d from the training dataset 130B. For example, the training system 101B can randomly sample the input video 20.d from the training dataset 130B or according to an algorithm.

The training system 101B is configured to process the input video 20.d, using the shape reconstructor neural network 110, to generate a respective input parametrization trajectory θ^{d}(·) 30.d representing the respective motion sequence depicted in the input video 20.d. The operations of the shape reconstructor neural network 110 are represented as

$${θ}_{α}^{d} ( \cdot ) = {S}_{α} [ {I}^{d} ( \cdot ) ] ,$$

where the input parametrization trajectory 30.d depends on the current values of the set of network parameters of the shape reconstructor neural network 110. The input parametrization trajectory 30.d includes a sequence of input model parameter vectors 35.d.1 to 35.d.N each representing the respective configuration of the motion sequence depicted in the respective frame 25.d.n of the input video 20.d.

The training system 101B is configured to parametrize the 3D parametric model 120, with the input parametrization trajectory 30.d, to generate a respective input animation

$${ℳ}_{α}^{d} ( \cdot ) 40 \cdot d$$

of a respective 3D input mesh 45.d preforming the respective motion sequence depicted in the input video 20.d. The 3D parametric model 120 provides a mapping,

$${ℳ}_{α}^{d} ( \cdot ) = ℳ [ {θ}_{α}^{d} ( \cdot ) ] ,$$

from the input parametrization trajectory 30.d to the input animation 40.d. The input animation 40.d includes a sequence of states 45.d.1 to 45.d.N of the 3D input mesh 35.d. Each state 45.d.n of the 3D input mesh 45.d is configured in the respective configuration of the motion sequence, as depicted in the respective frame 25.d.n of the input video 20.d.

The training system 101A is configured to generate a respective set of input rendering parameters (σ_{d}) 90.d for the 3D input mesh 45.d. The input rendering parameters 90.d, provided as σ_{d}={K_{d}, L_{d}}, include: (i) a respective input set of transformation matrices (K_{d}) 91.d, and (ii) a respective input lighting model (L_{d}) 95.d. The input set of transformation matrices 91.d defines a mapping from a respective object space of the 3D input mesh 45.d to the screen space. The input lighting model 95.d defines an appearance of the 3D input mesh 45.d within the world space.

The input set of transformation matrices 91.d, given as K_{d}={M_{d}, V_{d}, P_{d}, G_{d}}, includes: (i) a respective input model matrix (M_{d}) 92.M.d defining a mapping from the object space of the 3D input mesh 45.d to the world space, (ii) a respective input view matrix (V_{d}) 92.V.d defining a mapping from the object space of the 3D input mesh 45.d to the camera space, (iii) a respective input projection matrix (P_{d}) 92.d defining a mapping from the camera space to the clip space, and (iv) a respective input viewport matrix (G_{d}) 92.d defining a mapping from the NDC space to the screen space.

The training system 101B is configured to differentiabley render the input animation 40.d, using the differential render 210D in accordance with the input set of rendering parameters 90.d, to generate a respective output video O^{d}(·) 21.d that is a rendering of the input animation 40.d. The differential renderer 210D renders the input animation 40.d,

$${O}_{α}^{d} ( \cdot ) = R [ {ℳ}_{α}^{d} ( \cdot ) ; {σ}_{d} ]$$

in accordance with the input set of rendering parameters 90.d, using the differentiable rasterization method. Note, the output video 21.d is an estimate of the input video 20.d as the training system 101B effectively performs a full 2D-to-3D-to-2D video conversion cycle. The output video 21.d includes a sequence of frames 25.d.1 to 25.d.n each depicting the respective state of 3D input mesh 45.d in the respective configuration of the motion sequence.

The training system 101B is configured to compute a respective objective function term (L_{d}) 145.d for the input video 20.d based on the output video 21.d. Typically, the objective function term 145.d measures an error between the input 20.d and output 21.d videos,

$${L}_{d} ( α ) = L [ {I}^{d} ( \cdot ) , {O}_{α}^{d} ( \cdot ) ] ,$$

such that the objective function term 145.d encourages the shape reconstructor neural network 110 to generate the input parametrization trajectory 30.d which minimizes the error between the input 20.d and output 21.d videos. For example, the objective function term 145.d can include a mean absolute error, a mean squared error, a Huber Loss, a perpetual loss (e.g., a VGG or ResNet loss), a Learned Perceptual Image Patch Similarity (“LPIPS”), a SSIM, a temporal smoothness loss, an optical flow loss, a warping loss, or other appropriate pixel-level, perceptual, or temporal consistency loss.

Upon performing this above procedure, the training system 101B is configured to generate an objective function ( [symbol] ) 140 including the respective objective function term 145.d for each input video 20.d in the training dataset 130B. For example, the objective function 140 can include a summation of the objective function terms 145,

$$ℒ ( α ) = {\sum }_{d = 1}^{D} {L}_{d} ( α ) ,$$

such that each input video 20.d is weighted equally. Alternatively, the objective function 140 can be a weighted combination of the objective function terms 145, e.g., a weighted linear combination, such that different input videos 20 are emphasized and deemphasized.

The training system 101B is configured to optimize (e.g., minimize) the objection function 140 with respect to the set of network parameters (a) of the shape reconstructor neural network 110:

$${min}_{α} ℒ ( α ) \qquad ( 10 b )$$

Particularly, the training system 101B is configured to compute a gradient of the objective function 140 with respect to the set of network parameters of the shape reconstructor neural network 110, e.g., using backpropagation, and iteratively update the set of network parameters using the gradient over a number of training iterations. For example, the training system 101B can use a (e.g., stochastic) gradient descent method with a particular learning rate and/or weight decay, such as Implicit updates, Momentum, Adam, RMSProp, AdaGrad, etc., to update the set of network parameters with the values that optimize the objective function 140. The training system 101B can perform any appropriate number of training iterations to optimize the objective function 140. For example, the training system 101B can perform at least about 100, 1,000, 10,000, 100,000, 1,000,000, or more training iterations, or any range between any two of these values.

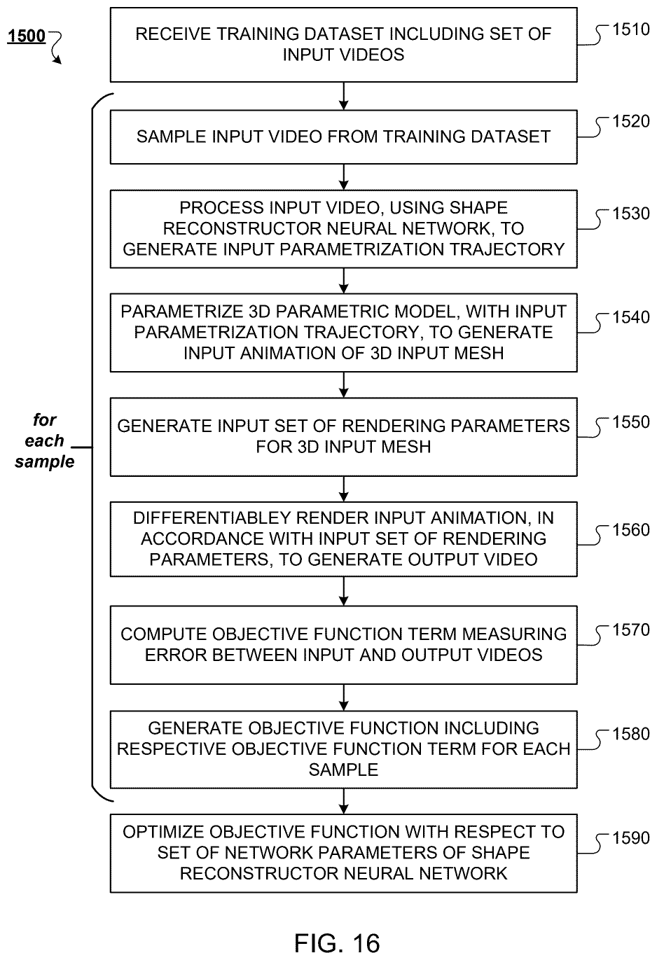

FIG. 16 is a flow diagram of another example process 1500 for training the shape reconstructor neural network 110 to perform the shape reconstruction task. For convenience, the process 1500 will be described as being performed by a system of one or more computers located in one or more locations. For example, a system, e.g., the shape reconstruction training system 101B of FIG. 15, appropriately programmed in accordance with this specification, can perform the process 1500.

The training system 101B receives a training dataset 130B including a set of input videos 20.1 to 20.D each depicting a respective motion sequence (1510).

For each input video 20.d in the training dataset 130B, the training system 101B performs operations (1520)-(1560):

The training system 101B samples the input video 20.d from the training dataset 130B (1520).

The training system 101B processes the input video 20.d, using the shape reconstructor neural network 110, to generate a respective input parametrization trajectory 30.d representing the respective motion sequence depicted in the input video 20.d (1530).

The training system 101B parametrizes the 3D parametric model 120, with the input parametrization trajectory 30.d, to generate a respective input animation 40.d of a respective 3D input mesh 45.d preforming the respective motion sequence depicted in the input video 20.d (1540).

The training system 101B generates a respective input set of rendering parameters 90.d for the 3D input mesh 45.d 20.d (1550).

The training system 101B differentiabley renders the input animation 40.d, using the differentiable renderer 210D in accordance with the input set of rendering parameters 90.d, to generate a respective output video 21.d that is a rendering of the input animation 40.d (1560).

The training system 101B computes a respective objective function term 145.d measuring an error between: (i) the input video 20.d, and (ii) the output video 21.d (1570).

The training system 101B generates an objective function 140 including the respective objective function term 145.d for each input video 20.d in the training dataset 130B (1580).

The training system 101B optimizes the objective function 140 with respect to the set of network parameters of the shape reconstructor neural network 110 (1590).

### B. Examples of Feature Matching Training Systems

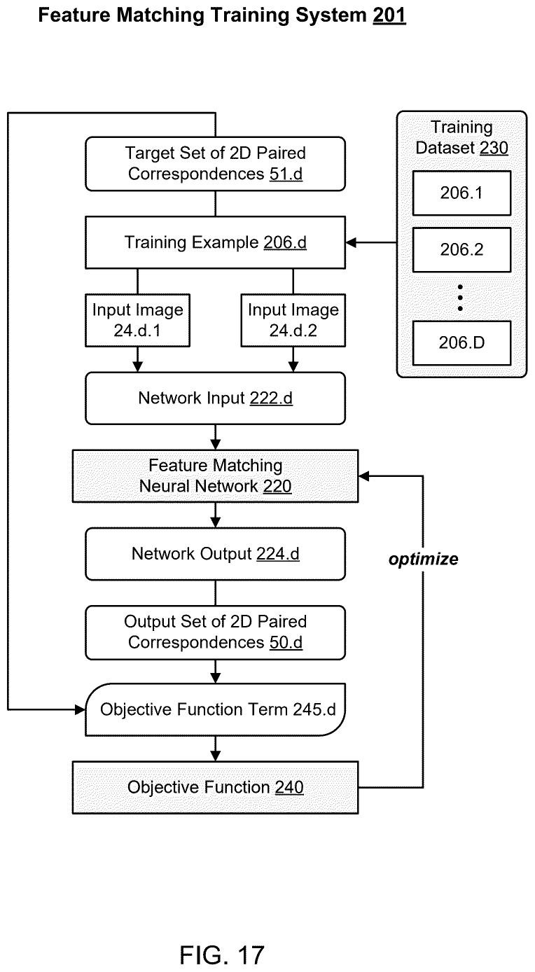

FIG. 17 is a schematic diagram depicting an example of a feature matching training system 201 for training the feature matching neural network 220 to perform the feature matching task. The feature matching training system 201 is an example of a system implemented as computer programs on one or more computers in one or more locations in which the systems, components, and techniques described below are implemented.

The training system 201 is configured receive a training dataset 230 associated with the feature matching task. In this example, the training system 201 is configured to train the feature matching neural network 220 on the training dataset 230 via a supervised learning technique.

The training dataset 230, given as

$${\{ {E}_{d} \}}_{d = 1}^{D} ,$$

includes a set of training examples (E_{d}) 206.1 to 206.D. Here, d indexes each training example 206.d in the training dataset 230, and D is the total number of training examples 206 in the training dataset 230. For example, the training dataset 230 can include at least about 100, 1,000, 10,000, 100,000, 1,000,000, or more training examples 206, or any range between any two of these values.

Each training example 206.d, given as

$${E}_{d} = \{ {I}_{d}^{1} , {I}_{d}^{2} , {B}_{d}^{12} \} ,$$

includes: (i) a respective first 2D input image

$$( {I}_{d}^{1} )$$

24.u.1 depicting a respective first scene, (ii) a respective second 2D input image

$$( {I}_{d}^{2} )$$

24.d.2 depicting a respective sound scene, and (iii) a respective target set 51.d of 2D paired correspondences 55.d between the first 24.d.1 and second 24.d.2 input images. The target set 51.d of 2D paired correspondences 55.d provides the annotations for one or more common features in the respective scenes depicted in the 2D input images 24.d.1 and 24.d.2. For example, the target set 51.d of 2D paired correspondences 55.d can be generated by human labeling of the first 24.d.1 and second 24.d.2 input images.

Note, the training dataset 230 is labelled as the respective first 24.d.1 and second 24.d.2 input images of each training examples 206.d are paired with the target set 51.d of 2D paired correspondences 55.d. In some cases, the training examples 206 may all depict the same class of object (or scene) to train the feature matching neural network 220 on a specific type of object.

The granularity of the training dataset 230 refers to the level of specificity in the object class, which can be relatively coarse or fine depending on types of objects the feature matching neural network 220 is being trained to match features between. For example, for relatively coarse granularity, the training examples 206 may all depict one of humans, animals, land vehicles, water vehicles, electronics, furniture, clothing, geological features, water bodies, symbols and signs, or magical artifacts. For relatively fine granularity, the training examples 206 may all depict one of Irish men, golden retrievers, sedans, sail boats, DSLR cameras, desk chairs, baseball hats, igneous rocks, perennial rivers, currency symbols, or magic wands.

The diversity of the training dataset 230 refers to the level of variation within the object class. For example, to inject diversity into the training dataset 230, the training examples 206 can depict many different variations of the same type of object, as well as multiple views and/or poses of the same object. This can help the feature matching neural network 220 generalize. As a particular example, the training examples 206 can depict faces of humans with different face shapes, including eye length, structure of the face (e.g., rounded or long), length of forehead, and nose shape (e.g., hooked, button, or aquiline). The training examples 206 can also depict different views and poses of the faces, including front, profile, top-down, and bottom-up view of the faces with different facial expressions, e.g., smiling, frowning, and squinting.

For each training example 206.d in the training dataset 230, the training system 201 is configured to perform the following functions:

The training system 201 is configured to sample the training example 206.d from the training dataset 230. For example, the training system 201 can randomly sample training example 206.d from the training dataset 230 or according to an algorithm.

The training system 201 is configured to forward a respective network input 222.d to the feature matching neural network 220, where the network input 222.d includes: (i) the respective first 2D input image 24.d.1 of the training example 206.d, and (ii) the respective second 2D input image 24.d.2 of the training example 206.d.

The training system 201 is configured to process the network input 222.d, using the feature matching neural network 220, to generate a respective network output 224.d including a respective output set

$$( {\hat{B}}_{d}^{12} )$$

50.d of 2D paired correspondences 55.d between: (i) the first 2D input image 24.d.1, and (ii) the second 2D input image 24.d.2. The output set 50.d of 2D paired correspondences 55.d, given as

$${\hat{B}}_{d}^{12} ( β ) = {F}_{β} [ {I}_{d}^{I} , {I}_{d}^{2} ] \approx {B}_{d}^{12} ,$$

is an estimate of the respective target set 51.d of 2D paired correspondences 55.d of the training example 206.d that the feature matching neural network 220 is being trained towards.

The training system 201 is configured to compute a respective objective function term (La) 245.d for the training example 206.d based on the output set 50.d of 2D paired correspondence 55.d. Typically, the objective function term 245.d measures an error between the target 51.d and output 50.d sets of 2D paired correspondences 55.d,

$${L}_{d} ( β ) = L [ {B}_{d}^{12} , {\hat{B}}_{d}^{12} ( β ) ] ,$$

such that the objective function term 245.d encourages the feature matching neural network 220 to generate the output set 50.d of 2D paired correspondences 55.d which minimizes the error between the target 51.d and output 50.d sets of 2D paired correspondences 55.d. For example, the objective function term 245.d can be a Euclidean distance loss, a Manhattan distance loss, a Chamfer distance, a Harsdorf distance, or other distance, similarity, or error metric.

Upon performing this above procedure, the training system 102 is configured to generate an objective function ( [symbol] ) 240 including the respective objective function term 245.d for each training example 206.d in the training dataset 230. For example, the objective function 240 can include a summation of the objective function terms 245,

$$ℒ ( β ) = {\sum }_{d = 1}^{D} {L}_{d} ( β ) ,$$

such that each training example 206.d is weighted equally. Alternatively, the objective function 240 can be a weighted combination of the objective function terms 245, e.g., a weighted linear combination, such that different training examples 206 are emphasized and deemphasized.

The training system 201 is configured to optimize (e.g., minimize) the objection function 240 with respect to the set of network parameters (β) of the feature matching neural network 220:

$${min}_{β} ℒ ( β ) . \qquad ( 11 )$$

Particularly, the training system 201 is configured to compute a gradient of the objective function 240 with respect to the set of network parameters of the feature matching neural network 220, e.g., using backpropagation, and iteratively update the set of network parameters using the gradient over a number of training iterations. For example, the training system 201 can use a (e.g., stochastic) gradient descent method with a particular learning rate and/or weight decay, such as Implicit updates, Momentum, Adam, RMSProp, AdaGrad, etc., to update the set of network parameters with the values that optimize the objective function 240. The training system 201 can perform any appropriate number of training iterations to optimize the objective function 240. For example, the training system 201 can perform at least about 100, 1,000, 10,000, 100,000, 1,000,000, or more training iterations, or any range between any two of these values.

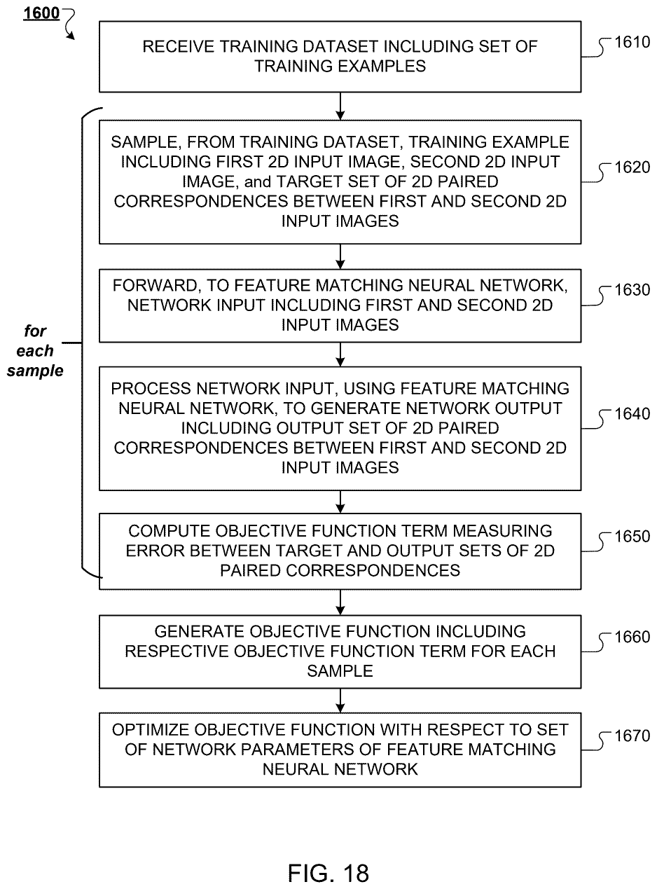

FIG. 18 is a flow diagram of an example process 1600 for training the feature matching neural network 220 to perform the feature matching task. For convenience, the process 1600 will be described as being performed by a system of one or more computers located in one or more locations. For example, a system, e.g., the feature matching training system 201 of FIG. 17, appropriately programmed in accordance with this specification, can perform the process 1600.

The training system 201 receives a training dataset 230 including a set of training examples 206.1 to 206.D (1610). Each training example 206.d includes: (i) a respective first 2D input image 24.d.1 depicting a respective first scene, (ii) a respective second 2D input image 24.d.2 depicting a respective second scene, and (iii) a respective target set 51.d of 2D paired correspondences 55.d between the first 24.d.1 and second 24.d.2 input images.

For each training example 206.d in the training dataset 230, the training system 201 performs operations (1620)-(1650):

The training system 201 forwards, to the feature matching neural network 220, a respective network input 222.d including: (i) the respective first 2D input image 24.d.1, and (ii) the respective second 2D input image 24.d.2 (1620).

The training system 201 processes the network input 222.d, using the feature matching neural network 220, to generate a respective network output 224.d including: a respective output set 50.d of 2D paired correspondences 55.d between: (i) the first 2D input image 24.d.1, and (ii) the second 2D input image 24.d.2. The output set 50.d of 2D paired correspondences 55.d estimates the respective target set 51.d of 2D paired correspondences 55.d (1630).

The training system 201 computes a respective objective function term 245.d measuring an error between: (i) the respective target set 51.d of 2D paired correspondences 55.d, and (ii) the respective output set 50.d of 2D paired correspondences 55.d (1640).

The training system 201 generates an objective function 240 including the respective objective term 245.d for each training example 206.d in the training dataset 230 (1650).

The training system 201 optimizes the objective function objective function 240 with respect to the set of network parameters of the feature matching neural network 220 (1660).

### V. Examples of Computing Devices

FIG. 19 is a schematic diagram depicting an example of a computing device 1900 and associated accessories that can be employed to execute implementations of the present disclosure. For example, some, or all, of the animation reconstructions system 10 described above with respect to FIGS. 1 and 2 can be implemented on a computing device such as the computing device 1900 described herein.

The computing device 1900 can be a gaming console 1920, such as PS5®, PS4®, PS3®, PS2® etc., or as one or more servers 1924 or as a rack within a server. In some implementations, the computing device 1900 may be implemented as a personal computer such as a laptop computer 1922. In some implementations, the computing device 1900 can be implemented as a mobile device such as the connected handheld gaming device 1956. In some implementations, a computing device can include one or more of the computing device 1900, and an entire system may be made up of multiple computing devices communicating with each other. For example, a gaming system can include one or more of a gaming console 1920, one or more accessories, and a remote platform such as a cloud-based platform implemented on one or more servers 1924. The computing device can also include a desktop computer, a workstation, a personal digital assistant, a server, a blade server, a mainframe, or other appropriate type of computer. The components shown here, their connections and relationships, and their functions, are examples only, and are not limiting.

In various implementations, the computing device 1900 includes some combination of one or more processors or central processing units (“CPUs”) 1902, one or more graphic processing units (“GPUs”) 1903, memory 1904, one or more storage devices 1906, a high-speed interface 1908, and/or a low-speed interface 1912. In some implementations, the high-speed interface 1908 connects to the memory 1904 and multiple high-speed expansion ports 1910. In certain implementations, the low-speed interface 1912 connects to a low-speed expansion port 1914 and the storage device(s) 1906. In some implementations, the high-speed interface 1908 connects to the storage device(s) 1906. Each of the processor 1902, the GPU 1903, the memory 1904, the storage device 1906, the high-speed interface 1908, the high-speed expansion ports 1910, and the low-speed interface 1912, are interconnected using various buses, and may be mounted on a common motherboard or in other manners as appropriate. The processor 1902 can process instructions for execution within the computing device 1900, including instructions stored in the memory 1904 and/or on the storage device 1906 to display graphical information for a graphical user interface (“GUI”) on an external input/output device, such as a display 1916 coupled to the high-speed interface 1908. In other implementations, multiple processors and/or multiple buses may be used, as appropriate, along with multiple memories and types of memory. In addition, multiple computing devices may be connected, with each device providing portions of the necessary operations (e.g., as a server bank, a group of blade servers, or a multi-processor system).

The memory 1904 stores information within the computing device 1900. In some implementations, the memory 1904 includes a volatile memory unit or units. Alternatively, or in addition, the memory 1904 can include a non-volatile memory unit or units. The memory 1904 may also include another form of a computer-readable medium, such as a magnetic or optical disk. In some implementations, the memory 1904 includes Graphics Double Data Rate (“GDDR”) memory such as GDDR6 memory configured to provide a unified memory architecture with a high bandwidth. In some implementations, the memory can include high speed memory such as GDDR2, GDDR3, GDDR4, GDDR5, GDDR5X, GDDR6X, GDDR6W or GDDR7. Such high-speed memory can facilitate rapid data access and seamless multitasking, supporting gaming and multimedia applications.

The storage device 1906 provides mass storage for the computing device 1900. In some implementations, the storage device 1906 may be or include a computer-readable medium, such as a hard disk device, an optical disk device, a flash memory, or other similar solid-state memory device, or an array of devices, including devices in a storage area network or other configurations. In some implementations, the storage device 1906 can include a high-capacity solid-state drive (SSD) configured to support a high throughput (e.g., 5.5 GB/s or more). Such an SSD can facilitate fast load times, enabling near-instantaneous game booting, level transitions, and asset streaming. In some implementations, the storage device 1906 can be configured to support expandable storage via compatible non-volatile memory express (“NVMe”) SSDs. Instructions can be stored in an information carrier, and when executed by one or more processing devices, such as processor 1902, perform one or more methods, such as those described above. The instructions can also be stored by one or more storage devices, such as non-transitory computer-readable or machine-readable mediums, such as the memory 1904, the storage device 1906, or memory on the processor 1902. The instructions can constitute software for providing interactive game play on a user interface such as a graphical user interface (“GUI”) presented on the display 1916.

The high-speed interface 1908 generally manages bandwidth-intensive operations for the computing device 1900, while the low-speed interface 1912 generally manages lower bandwidth-intensive operations. Such allocation of functions is an example only. In some implementations, the high-speed interface 1908 is coupled to the memory 1904, the display 1916 (e.g., through a graphics processor or accelerator), and to the high-speed expansion ports 1910, which accepts various expansion cards. In the implementation, the low-speed interface 1912 is coupled to the storage device 1906 and the low-speed expansion port 1914. The low-speed expansion port 1914, which may include various communication ports (e.g., Universal Serial Bus (“USB”) Type-A and Type-C ports, High-Definition Multimedia Interface (“HDMI”) ports, Bluetooth, Ethernet, wireless Ethernet) may be coupled to one or more input/output and/or accessory devices. Such input/output and accessory devices can include a controller 1950 such as a DualSense®, DualShock®, or Access™ controllers for PlayStation® devices, a virtual reality (“VR”) or augmented reality (“AR”) headset 1952 such as the PS VR2 headset, accessory controllers 1954 such as PS VR2 Sense™, a handheld gaming device 1956 such as PlayStation Portal®, a camera 1958, and/or an earphone/headphone set 1960 such as the PULSE Elite™ headset or the Pulse Explore™ earbuds. In some implementations, the computing device 1900 includes one or more acoustic transducers, and/or is connected to one or more external acoustic transducers such as one or more speakers associated with the display 1916.

The processor 1902 can be implemented as a chipset of chips that include separate and multiple analog and digital processors. For example, the processor 1902 can be a multi-core processor that supports high-speed processing and enables complex computational tasks, real-time physics simulations, and advanced artificial intelligence (“AI”) capabilities. In one example, the processor 1902 includes at least 8 cores, at least 16 threads, and operates at variable frequencies around 3.5 GHz or more. In some implementations, the processor 1902 may be a Complex Instruction Set Computers (“CISC”) processor, a Reduced Instruction Set Computer (“RISC”) processor, or a Minimal Instruction Set Computer (“MISC”) processor.

In some implementations, the GPU 1903 includes a custom GPU that supports an advanced architecture such as the RDNA 2 architecture developed by AMD. In certain examples, the GPU 1903 includes at least 36 compute units running at speeds of 2 GHz or more, and delivers performance of at least 10 teraflops. The GPU 1903 can be configured to support high quality graphics rendering. For example, the GPU 1903 can be configured to support hardware-accelerated ray tracing for enhanced realism in lighting and reflections, thereby providing a highly immersive gaming experience.

The computing device 1900 can be configured to interact with one or more connected input/output or accessory device in providing the gaming experience. In some implementations, the computing device communicates with a handheld controller 1950—e.g., a DualSense®, DualShock®, or Access™ controller for PlayStation® devices—to provide the gaming experience. The controller 1950 can feature a high-fidelity haptic feedback system with one or more actuators that simulate a wide range of tactile sensations. In some implementations, the controller 1950 includes one or more adaptive triggers that adjust resistance based on in-game actions to provide for a realistic feel.

The ergonomic design of the controller 1950 can allow for comfortable use even in long gaming sessions. For example, the controller 1950 can include textured grips and an optimized button layout. In some implementations, the controller 1950 includes one or more of: integrated motion sensors, a high-resolution touchpad, and a built-in microphone array. The controller 1950 includes an array of buttons, joysticks, and other controls that allow a user to interact with the computing device 1900 to participate in interactive gameplay presented, for example, on a display device such as the display 1916. The controller 1950 can be powered by one or more regular or rechargeable batteries and supports both wireless and wired connectivity with the computing device 1900, for example, via Bluetooth, WiFi, USB-C etc., or via a proprietary connection such as PlayStation Link™. In some implementations, the controller 1950 includes a light bar and player indicators for visual feedback and customization.

In some implementations, the input/output or accessory device includes a VR/AR headset 1952. One example of such a headset is the PlayStation VR2 (“PS VR2”) headset that is configured to provide an immersive and interactive gaming experience. In some implementations, the headset 1952 features dual displays, e.g., organic light-emitting diode (“OLED”) displays or micro-LED displays, with a combined resolution of 4000, 19 2080 pixels or higher-thus providing sharp visuals and a wide field-of-view.

In some implementations, the VR/AR headset 1952 includes eye-tracking technology that enables foveated rendering, by focusing on where the user is looking. In some implementations, the headset 1952 includes integrated cameras that facilitate tracking head movements without external sensors. In some implementations, the headset includes haptic feedback for tactile sensations and/or one or more acoustic transducers configured to provide a spatial sound effect the user. The headset 1952 can include an adjustable headband and cushioned padding, and can be configured to connect to the computing device 1900 either over a wireless network (e.g., over a WiFi® or Bluetooth® connection, or a proprietary connection such as PlayStation Link™) or over a wire such as a USB-C cable.

In some implementations, the headset 1952 can be configured to work in conjunction with one or more accessory controllers 1954 such as the PlayStation VR2 Sense™ controllers. The accessory controllers 1954 can enhance the immersive gaming experience through various features such as advanced haptic feedback for detailed in-game sensations, adaptive triggers with dynamic resistance to simulate real-world actions, and finger touch detection for natural interactions. The ergonomics of the accessory controllers 1954 can provide a comfortable experience even during extended gameplay. In some implementations, the accessory controllers include one or more integrated sensors (accelerometer, gyroscope, etc.) and/or cameras to provide motion tracking. The accessory controllers 1954 can be configured to connect to the computing device 1900 and/or the headset 1952 over a wireless connection such as WiFi® or Bluetooth®.

In some implementations, the computing device 1900 is connected to a handheld gaming device 1956 such as the PlayStation Portal®. The handheld gaming device 1956 can be configured to stream games and media from the computing device 1900 via a wireless connection such as WiFi® or Bluetooth®. The handheld gaming device 1956 includes a high-resolution screen that allows users to play games and/or stream media remotely without using the display 1916 connected to the computing device 1900. This allows the display to be used for other purposes while the computing device 1900 facilitates gameplay on the handheld gaming device 1956. In some implementations, the handheld gaming device 1956 is configured to act as a streaming receiver without running games natively on the device 1956 itself. This makes the handheld gaming device 1956 a convenient option for playing games run on the computing device 1900, while leaving a TV connected to the computing device 1900 free to be used for viewing other media. The handheld gaming device 1956 can includes buttons and features similar to (or even same as) the controller 1950, thus providing for a similar gaming experience as that with the controller 1950.

In some implementations, the input/output or accessory devices includes a camera 1958 and/or an earphone/headphone set 1960 such as the PULSE Elite™ headset or the Pulse Explore™ earbuds. The camera 1958 can be used to track user-movements, which in turn can be used as an input to an interactive game being executed on the computing device 1900. The earphone/headphone set 1960 can be used to provide audio feedback/output to a user from the computing device 1900. In some implementations, the earphone/headphone set 1960 can include a microphone to receive spoken inputs/instructions that in turn can be used to control an interactive game being executed on the computing device 1900.

### OTHER EMBODIMENTS

In addition to the embodiments of the attached claims and the embodiments described above, the following numbered embodiments are also innovative.
1. A method performed by one or more computers, the method comprising: receiving a source video comprising a sequence of frames depicting a motion sequence; processing the source video to generate a source animation comprising a sequence of states of a three-dimensional source mesh performing the motion sequence; obtaining a set of three-dimensional paired correspondences between: (i) the three-dimensional source mesh, and (ii) a three-dimensional target mesh, wherein the three-dimensional target mesh has higher resolution than the three-dimensional source mesh; and processing the source animation, in accordance with the set of three-dimensional paired correspondences, to generate a target animation comprising a sequence of states of the three-dimensional target mesh performing the motion sequence.
2. The method of embodiment 1, wherein processing the source video to generate the source animation comprising the sequence of states of the three-dimensional source mesh performing the motion sequence comprises: providing a three-dimensional parametric model; processing the source video, using a shape reconstructor neural network, to generate a source parametrization trajectory comprising a sequence of model parameter vectors representing the motion sequence; and parametrizing the three-dimensional parametric model, with the source parametrization trajectory, to generate the source animation comprising the sequence of states of the three-dimensional source mesh performing the motion sequence.
3. The method of embodiment 2, wherein the three-dimensional parametric model is a basis function parametric model, a morphable parametric model, a polynomial parametric model, an explicit parametric surface model, an implicit parametric surface model, a spline-based parametric model, a subdivision surfaces parametric model, an implicit function parametric model, or a skeletal parametric model.
4. The method of any one of embodiments 2-3, wherein the shape reconstructor neural network is a convolutional neural network, a recurrent neural network, an attention neural network, a graph neural network, or a Transformer-based neural network.
5. The method of any one of embodiments 2-4, wherein the shape reconstructor neural network is configured to process each frame in the source video individually to generate a respective model parameter vector in the source parametrization trajectory.
6. The method of any one of embodiments 2-4, wherein the shape reconstructor neural network is configured to process the sequence of frames in the source video in parallel to generate the sequence of model parameter vectors in the source parametrization trajectory.
7. The method of any one of embodiments 2-6, wherein each model parameter vector in the source parametrization trajectory comprises: a respective set of geometry parameters representing a respective shape and structure of each object depicted in the respective frame of the source video; and a respective set of pose parameters representing a respective position, orientation, and scale of each object depicted in the respective frame of the source video.
8. The method of embodiment 7, wherein each model parameter vector in the source parametrization trajectory further comprises: a respective set of expression parameters representing a respective expression of each face depicted in the respective frame of the source video.
9. The method of any one of embodiments 1-8, wherein obtaining the set of three-dimensional paired correspondences between: (i) the three-dimensional source mesh, and (ii) the three-dimensional target mesh comprises: receiving a base state of the three-dimensional target mesh; sampling, from the source animation, a base state of the three-dimensional source mesh; rendering the base state of the three-dimensional source mesh to generate a two-dimensional source image depicting the three-dimensional source mesh; rendering the base state of the three-dimensional target mesh to generate a two-dimensional target image depicting the three-dimensional target mesh; forwarding, to a featuring matching neural network, a network input comprising: (i) the two-dimensional source image, and (ii) the two-dimensional target image; processing the network input, using the featuring matching neural network, to generate a network output comprising a set of two-dimensional paired correspondences between: (i) the two-dimensional source image, and (ii) the two-dimensional target image; and inverse rasterizing the set of two-dimensional paired correspondences to generate the set of three-dimensional paired correspondences between: (i) the three-dimensional source mesh, and (ii) the three-dimensional target mesh.
10. The method of embodiment 9, wherein the feature matching neural network is a convolutional neural network, a recurrent neural network, an attention neural network, a graph neural network, or a Transformer-based neural network.
11. The method of any one of embodiments 9-10, wherein processing the source animation, in accordance with the set of three-dimensional paired correspondences, to generate the target animation comprising the sequence of states of the three-dimensional target mesh performing the motion sequence comprises: performing an optimal transport method between: (i) the base state of the three-dimensional source mesh, and (ii) the base state of the three-dimensional target mesh, while regularizing over the set of three-dimensional paired correspondences, to generate an optimal transport matrix between: (i) the three-dimensional source mesh, and (ii) the three-dimensional target mesh; and applying a transpose of the optimal transport matrix, to the source animation, to generate the target animation comprising the sequence of states of the three-dimensional target mesh performing the motion sequence.
12. The method of embodiment 11, wherein performing the optimal transport method between: (i) the base state of the three-dimensional source mesh, and (ii) the base state of the three-dimensional target mesh, while regularizing over the set of three-dimensional paired correspondences, to generate the optimal transport matrix between: (i) the three-dimensional source mesh, and (ii) the three-dimensional target mesh comprises: initializing a transport matrix between: (i) the three-dimensional source mesh, and (ii) the three-dimensional target mesh; computing a cost matrix between: (i) the base state of the three-dimensional source mesh, and (ii) the base state of the three-dimensional target mesh; generating a Kantorovich objective term comprising a Frobenius inner product between: (i) the transport matrix, and (ii) the cost matrix; generating a correspondence regularization term regularizing the transport matrix over the set of three-dimensional paired correspondences; generating an objective function comprising the Kantorovich objective term and the correspondence regularization term; and optimizing the objective function, with respect to the transport matrix, to generate the optimal transport matrix between: (i) the three-dimensional source mesh, and (ii) the three-dimensional target mesh.
13. The method of embodiment 12, wherein generating the correspondence regularization term regularizing the transport matrix over the set of three-dimensional paired correspondences comprises: applying the transport matrix, to the base state of the three-dimensional target mesh, to generate a transported state of the three-dimensional source mesh; computing a source deformation transformation between: (i) the transported state of the three-dimensional source mesh, and (ii) the base state of the three-dimensional source mesh; applying a transpose of the transport matrix, to the base state of the three-dimensional source mesh, to generate a transported state of the three-dimensional target mesh; computing a target deformation transformation between: (i) the transported state of the three-dimensional target mesh, and (ii) the base state of the three-dimensional target mesh; and returning, as the correspondence regularization term, a regularization term measuring an error between the source and target deformation transformations evaluated over the set of three-dimensional paired correspondences.
14. The method of any one of embodiments 1-13, wherein the three-dimensional target mesh has a higher mesh resolution than the three-dimensional source mesh.
15. The method of embodiment 14, wherein the three-dimensional target mesh has a higher vertex count than the three-dimensional source mesh, a higher edge count than the three-dimensional source mesh, and a higher face count than the three-dimensional source mesh.
16. The method of any one of embodiments 14-15, wherein the three-dimensional target mesh has a higher spatial resolution than the three-dimensional source mesh.
17. The method of embodiment 16, wherein the three-dimensional target mesh has a higher vertex density than the three-dimensional source mesh, a higher edge density than the three-dimensional source mesh, a higher face density than the three-dimensional source mesh, a smaller average edge length than the three-dimensional source mesh, and a smaller average face area than the three-dimensional source mesh.
18. The method of any one of embodiments 1-17, wherein each state of the three-dimensional source and target meshes is a face-vertex representation of the three-dimensional mesh, a winged-edge representation of the three-dimensional mesh, a half-edge representation of the three-dimensional mesh, a quad-edge representation of the three-dimensional mesh, a corner-table representation of the three-dimensional mesh, or a vertex-vertex representation of the three-dimensional mesh.
19. A system comprising one or more computers and one or more storage devices storing instructions that, when executed by the one or more computers, cause the one or more computers to perform the method of any one of embodiments 1-18.
20. One or more computer non-transitory storage media storing instructions that, when executed by one or more computers, cause the one or more computers to perform the method of any one of embodiments 1-18.
21. A method performed by one or more computers, the method comprising: receiving a feature matching input comprising: (i) a three-dimensional source mesh, and (ii) a three-dimensional target mesh; rendering the three-dimensional source mesh to generate a two-dimensional source image depicting the three-dimensional source mesh; rendering the three-dimensional target mesh to generate a two-dimensional target image depicting the three-dimensional target mesh; forwarding, to a featuring matching neural network, a network input comprising: (i) the two-dimensional source image, and (ii) the two-dimensional target image; processing the network input, using the featuring matching neural network, to generate a network output comprising a set of two-dimensional paired correspondences between: (i) the two-dimensional source image, and (ii) the two-dimensional target image; and inverse rasterizing the set of two-dimensional paired correspondences to generate a set of three-dimensional paired correspondences between: (i) the three-dimensional source mesh, and (ii) the three-dimensional target mesh.
22. The method of embodiment 21, wherein the feature matching neural network is a convolutional neural network, a recurrent neural network, an attention neural network, a graph neural network, or a Transformer-based neural network.
23. The method of any one of embodiments 21-22, further comprising, prior to inverse rasterizing the set of two-dimensional paired correspondence correspondences: performing a correspondence refinement method on the set of two-dimensional paired correspondences.
24. The method of embodiment 23, wherein the correspondence refinement method comprises one or more of: a random sample consensus method, a mutual nearest neighbor check method, a thin-plane spline warping method, or an affine transformation optimization.
25. The method of any one of embodiments 21-24, wherein rendering each three-dimensional mesh to generate the respective two-dimensional image depicting the three-dimensional mesh comprises: initializing a pixel grid within a screen space; generating a set of rendering parameters for the three-dimensional mesh, the set of rendering parameters comprising: a set of transformation matrices mapping from an object space of the three-dimensional mesh to the screen space; and a lighting model defining an appearance of the three-dimensional mesh within a world space; and rendering the three-dimensional mesh, in accordance with the set of rendering parameters, to generate the two-dimensional image depicting the three-dimensional mesh on the pixel grid.
26. The method of embodiment 25, wherein the network input further comprises: (i) the set of rendering parameters for the three-dimensional source mesh, and/or (ii) the set of rendering parameters for the three-dimensional target mesh.
27. The method of any one of embodiments 25-26, wherein the set of transformation matrices for each three-dimensional mesh comprises: a model matrix mapping from the object space of the three-dimensional mesh to the world space; a view matrix mapping from the world space to a camera space; a projection matrix mapping from the camera space to a clip space; and a viewport matrix mapping from a normalized device coordinate space to the screen space.
28. The method of embodiment 27, wherein rendering the three-dimensional mesh, in accordance with the set of rendering parameters, to generate the two-dimensional image depicting the three-dimensional mesh on the pixel grid comprises: constructing, from the set of transformation matrices, a model-view-projection matrix comprising a matrix product between: (i) the model matrix, (ii) the view matrix, and (iii) the projection matrix; applying the model-view-projection matrix, to the three-dimensional mesh, to generate a clip space representation of the three-dimensional mesh within the clip space; performing a perspective division transformation on the clip space representation of the three-dimensional mesh to generate a normalized device coordinate space representation of the three-dimensional mesh within the normalized device coordinate space; applying the viewport matrix, to the normalized device coordinate space representation of the three-dimensional mesh, to generate a screen space representation of the three-dimensional mesh within the screen space; rasterizing the screen space representation of the three-dimensional mesh to generate a fragmented representation of the three-dimensional mesh on the pixel grid; and processing the fragmented representation of the three-dimensional mesh, in accordance with the lighting model, to generate the two-dimensional image depicting the three-dimensional mesh on the pixel grid.
29. The method of embodiment 28, wherein rasterizing the screen space representation of the three-dimensional mesh to generate the fragmented representation of the three-dimensional mesh on the pixel grid comprises: for each face of the three-dimensional mesh: assembling, from the screen space representation of the three-dimensional mesh, a respective primitive representing the face within the screen space; and at each pixel position on the pixel grid: determining whether the primitive covers the pixel position; and if so: generating a respective fragment of the primitive at the pixel position; returning, for each pixel position on the pixel grid, a respective fragment list comprising the respective fragment of each primitive covering the pixel position; and returning, as the fragmented representation of the three-dimensional mesh on the pixel grid, the respective fragment list at each pixel position on the pixel grid.
30. The method of embodiment 29, wherein processing the fragmented representation of the three-dimensional mesh, in accordance with the lighting model, to generate the two-dimensional image depicting the three-dimensional mesh on the pixel grid comprises: initializing a respective pixel at each pixel position on the pixel grid; at each pixel position on the pixel grid: receiving the respective fragment list comprising the respective fragment of each primitive covering the pixel position; and for each primitive covering the pixel position: processing the respective fragment of the primitive at the pixel position, in accordance with the lighting model, to generate a respective candidate pixel for the primitive at the pixel position; determining whether the respective candidate pixel for the primitive at the pixel position has a smaller z-depth value than the current pixel at the pixel position; and if so: updating the current pixel at the pixel position with the respective candidate pixel for the primitive at the pixel position; and associating the current pixel at the pixel position with the respective face of the three-dimensional mesh represented by the primitive; and returning, as the two-dimensional image depicting the three-dimensional mesh on the pixel grid, the respective current pixel at each pixel position on the pixel grid.
31. The method of embodiment 30, wherein inverse rasterizing the set of two-dimensional paired correspondences to generate the set of three-dimensional paired correspondences comprises: for each two-dimensional paired correspondence between the two-dimensional images: identifying, from the two-dimensional paired correspondence, a pairing of a respective two-dimensional correspondence in each two-dimensional image depicting the respective three-dimensional mesh; generating a respective three-dimensional correspondence in each three-dimensional mesh by assigning each pixel in the respective two-dimensional correspondence to one or more vertices of the respective face of the three-dimensional mesh associated with the pixel; and returning, as a respective three-dimensional paired correspondence between the three-dimensional meshes, a pairing of the respective three-dimensional correspondence in each three-dimensional mesh; and returning, as the set of three-dimensional paired correspondences, the respective three-dimensional paired correspondence between the three-dimensional meshes generated for each two-dimensional paired correspondence between the two-dimensional images.
32. The method of any one of embodiments 21-31, wherein: the set of two-dimensional paired correspondences comprises, for each of a plurality of common features, a respective two-dimensional paired correspondence identifying the common feature in the two-dimensional images; the set of three-dimensional paired correspondences comprises, for each of the plurality of common features, a respective three-dimensional paired correspondence identifying the common feature in the three-dimensional meshes; and inverse rasterizing the set of two-dimensional paired correspondences to generate the set of three-dimensional paired correspondences comprises, for each of the plurality of common features: inverse rasterizing the respective two-dimensional paired correspondence identifying the common feature in the two-dimensional images to generate the respective three-dimensional paired correspondence identifying the common feature in the three-dimensional meshes.
33. The method of embodiment 32, wherein for each of the plurality of common features: the respective two-dimensional paired correspondence comprises: (i) a respective two-dimensional source correspondence identifying the common feature in the two-dimensional source image, and (ii) a respective two-dimensional target correspondence identifying the common feature in the two-dimensional target image; the respective three-dimensional paired correspondence comprises: (i) a respective three-dimensional source correspondence identifying the common feature in the three-dimensional source mesh, and (ii) a respective three-dimensional target correspondence identifying the common feature in the three-dimensional target mesh; and inverse rasterizing the respective two-dimensional paired correspondence identifying the common feature in the two-dimensional images to generate the respective three-dimensional paired correspondence identifying the common feature in the three-dimensional meshes comprises: inverse rasterizing the respective two-dimensional source correspondence identifying the common feature in the two-dimensional source image to generate the respective three-dimensional source correspondence identifying the common feature in the three-dimensional source mesh; and inverse rasterizing the respective two-dimensional target correspondence identifying the common feature in the two-dimensional target image to generate the respective three-dimensional target correspondence identifying the common feature in the three-dimensional target mesh.
34. The method of embodiment 33, wherein the network output further comprises, for each of the plurality of common features, a respective confidence matrix between: (i) the respective two-dimensional source correspondence identifying the common feature in the two-dimensional source image, and (ii) the respective two-dimensional target correspondence identifying the common feature in the two-dimensional target image.
35. The method of any one of embodiments 21-34, wherein the three-dimensional target mesh has higher resolution than the three-dimensional source mesh.
36. The method of embodiment 35, wherein the three-dimensional target mesh has a higher mesh resolution than the three-dimensional source mesh.
37. The method of embodiment 36, wherein the three-dimensional target mesh has a higher spatial resolution than the three-dimensional source mesh.
38. The method of any one of embodiments 21-37, wherein each three-dimensional mesh is a face-vertex mesh representation, a winged-edge mesh representation, a half-edge mesh representation, a quad-edge mesh representation, a corner-table mesh representation, or a vertex-vertex mesh representation.
39. A system comprising one or more computers and one or more storage devices storing instructions that, when executed by the one or more computers, cause the one or more computers to perform the method of any one of embodiments 21-38.
40. One or more non-transitory computer storage media storing instructions that, when executed by one or more computers, cause the one or more computers to perform the method of any one of embodiments 21-38.

While this specification contains many specific implementation details, these should not be construed as limitations on the scope of what is being claimed, which is defined by the claims themselves, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
receiving a source video comprising a sequence of frames depicting a motion sequence;
processing the source video to generate a source animation comprising a sequence of states of a three-dimensional source mesh performing the motion sequence;
obtaining a set of three-dimensional paired correspondences between: (i) the three-dimensional source mesh, and (ii) a three-dimensional target mesh,
wherein the three-dimensional target mesh has higher resolution than the three-dimensional source mesh; and
processing the source animation, in accordance with the set of three-dimensional paired correspondences, to generate a target animation comprising a sequence of states of the three-dimensional target mesh performing the motion sequence.

2. The method of claim 1, wherein processing the source video to generate the source animation comprising the sequence of states of the three-dimensional source mesh performing the motion sequence comprises:
providing a three-dimensional parametric model;
processing the source video, using a shape reconstructor neural network, to generate a source parametrization trajectory comprising a sequence of model parameter vectors representing the motion sequence; and
parametrizing the three-dimensional parametric model, with the source parametrization trajectory, to generate the source animation comprising the sequence of states of the three-dimensional source mesh performing the motion sequence.

3. The method of claim 2, wherein the three-dimensional parametric model is a basis function parametric model, a morphable parametric model, a polynomial parametric model, an explicit parametric surface model, an implicit parametric surface model, a spline-based parametric model, a subdivision surfaces parametric model, an implicit function parametric model, or a skeletal parametric model.

4. The method of claim 2, wherein the shape reconstructor neural network is a convolutional neural network, a recurrent neural network, an attention neural network, a graph neural network, or a Transformer-based neural network.

5. The method of claim 2, wherein the shape reconstructor neural network is configured to process each frame in the source video individually to generate a respective model parameter vector in the source parametrization trajectory.

6. The method of claim 2, wherein the shape reconstructor neural network is configured to process the sequence of frames in the source video in parallel to generate the sequence of model parameter vectors in the source parametrization trajectory.

7. The method of claim 2, wherein each model parameter vector in the source parametrization trajectory comprises:
a respective set of geometry parameters representing a respective shape and structure of each object depicted in the respective frame of the source video; and
a respective set of pose parameters representing a respective position, orientation, and scale of each object depicted in the respective frame of the source video.

8. The method of claim 7, wherein each model parameter vector in the source parametrization trajectory further comprises:
a respective set of expression parameters representing a respective expression of each face depicted in the respective frame of the source video.

9. The method of claim 1, wherein obtaining the set of three-dimensional paired correspondences between: (i) the three-dimensional source mesh, and (ii) the three-dimensional target mesh comprises:
receiving a base state of the three-dimensional target mesh;
sampling, from the source animation, a base state of the three-dimensional source mesh;
rendering the base state of three-dimensional source mesh to generate a two-dimensional source image depicting the three-dimensional source mesh;
rendering the base state of the three-dimensional target mesh to generate a two-dimensional target image depicting the three-dimensional target mesh;
forwarding, to a featuring matching neural network, a network input comprising: (i) the two-dimensional source image, and (ii) the two-dimensional target image;
processing the network input, using the featuring matching neural network, to generate a network output comprising a set of two-dimensional paired correspondences between: (i) the two-dimensional source image, and (ii) the two-dimensional target image; and
inverse rasterizing the set of two-dimensional paired correspondences to generate the set of three-dimensional paired correspondences between: (i) the three-dimensional source mesh, and (ii) the three-dimensional target mesh.

10. The method of claim 9, wherein the feature matching neural network is a convolutional neural network, a recurrent neural network, an attention neural network, a graph neural network, or a Transformer-based neural network.

11. The method of claim 9, wherein processing the source animation, in accordance with the set of three-dimensional paired correspondences, to generate the target animation comprising the sequence of states of the three-dimensional target mesh performing the motion sequence comprises:
performing an optimal transport method between: (i) the base state of the three-dimensional source mesh, and (ii) the base state of the three-dimensional target mesh, while regularizing over the set of three-dimensional paired correspondences, to generate an optimal transport matrix between: (i) the three-dimensional source mesh, and (ii) the three-dimensional target mesh; and
applying a transpose of the optimal transport matrix, to the source animation, to generate the target animation comprising the sequence of states of the three-dimensional target mesh performing the motion sequence.

12. The method of claim 11, wherein performing the optimal transport method between: (i) the base state of the three-dimensional source mesh, and (ii) the base state of the three-dimensional target mesh, while regularizing over the set of three-dimensional paired correspondences, to generate the optimal transport matrix between: (i) the three-dimensional source mesh, and (ii) the three-dimensional target mesh comprises:
initializing a transport matrix between: (i) the three-dimensional source mesh, and (ii) the three-dimensional target mesh;
computing a cost matrix between: (i) the base state of the three-dimensional source mesh, and (ii) the base state of the three-dimensional target mesh;
generating a Kantorovich objective term comprising a Frobenius inner product between: (i) the transport matrix, and (ii) the cost matrix;
generating a correspondence regularization term regularizing the transport matrix over the set of three-dimensional paired correspondences;
generating an objective function comprising the Kantorovich objective term and the correspondence regularization term; and
optimizing the objective function, with respect to the transport matrix, to generate the optimal transport matrix between: (i) the three-dimensional source mesh, and (ii) the three-dimensional target mesh.

13. The method of claim 12, wherein generating the correspondence regularization term regularizing the transport matrix over the set of three-dimensional paired correspondences comprises:
applying the transport matrix, to the base state of the three-dimensional target mesh, to generate a transported state of the three-dimensional source mesh;
computing a source deformation transformation between: (i) the transported state of the three-dimensional source mesh, and (ii) the base state of the three-dimensional source mesh;
applying a transpose of the transport matrix, to the base state of the three-dimensional source mesh, to generate a transported state of the three-dimensional target mesh;
computing a target deformation transformation between: (i) the transported state of the three-dimensional target mesh, and (ii) the base state of the three-dimensional target mesh; and
returning, as the correspondence regularization term, a regularization term measuring an error between the source and target deformation transformations evaluated over the set of three-dimensional paired correspondences.

14. The method of claim 1, wherein the three-dimensional target mesh has a higher mesh resolution than the three-dimensional source mesh.

15. The method of claim 14, wherein the three-dimensional target mesh has a higher vertex count than the three-dimensional source mesh, a higher edge count than the three-dimensional source mesh, and a higher face count than the three-dimensional source mesh.

16. The method of claim 14, wherein the three-dimensional target mesh has a higher spatial resolution than the three-dimensional source mesh.

17. The method of claim 16, wherein the three-dimensional target mesh has a higher vertex density than the three-dimensional source mesh, a higher edge density than the three-dimensional source mesh, a higher face density than the three-dimensional source mesh, a smaller average edge length than the three-dimensional source mesh, and a smaller average face area than the three-dimensional source mesh.

18. The method of claim 1, wherein each state of the three-dimensional source and target meshes is a face-vertex representation of the three-dimensional mesh, a winged-edge representation of the three-dimensional mesh, a half-edge representation of the three-dimensional mesh, a quad-edge representation of the three-dimensional mesh, a corner-table representation of the three-dimensional mesh, or a vertex-vertex representation of the three-dimensional mesh.

19. A system comprising one or more computers and one or more storage devices storing instructions that, when executed by the one or more computers, cause the one or more computers to perform operations comprising:
receiving a source video comprising a sequence of frames depicting a motion sequence;
processing the source video to generate a source animation comprising a sequence of states of a three-dimensional source mesh performing the motion sequence;
obtaining a set of three-dimensional paired correspondences between: (i) the three-dimensional source mesh, and (ii) a three-dimensional target mesh,
wherein the three-dimensional target mesh has higher resolution than the three-dimensional source mesh; and
processing the source animation, in accordance with the set of three-dimensional paired correspondences, to generate a target animation comprising a sequence of states of the three-dimensional target mesh performing the motion sequence.

20. One or more computer storage media storing instructions that, when executed by one or more computers, cause the one or more computers to perform operations comprising:
receiving a source video comprising a sequence of frames depicting a motion sequence;
processing the source video to generate a source animation comprising a sequence of states of a three-dimensional source mesh performing the motion sequence;
obtaining a set of three-dimensional paired correspondences between: (i) the three-dimensional source mesh, and (ii) a three-dimensional target mesh,
wherein the three-dimensional target mesh has higher resolution than the three-dimensional source mesh; and
processing the source animation, in accordance with the set of three-dimensional paired correspondences, to generate a target animation comprising a sequence of states of the three-dimensional target mesh performing the motion sequence.
